(19) United States
(12) Patent Application Publication
(10) Pub. No.: US 2019/0159455 A1
(43) Pub. Date: May 30, 2019

(54) Pesticidally Active Mixtures of Tioxazafen

(71) Applicant: BASF SE, Ludwigshafen am Rhein (DE)

(72) Inventors: Eric BAS, Research Triangle Park, NC (US); Todd EDGINGTON, Holly Springs, NC (US); Ronald WILHELM, Limburgerhof (DE); Steffen SCHLEHUBER, Ruppertsberg (DE); Florent MAZUIR, Limburgerhof (DE)

(21) Appl. No.: 16/092,526

(22) PCT Filed: Mar. 31, 2017
(86) PCT No.: PCT/IB2017/051845

§ 371 Date: Oct. 10, 2018

Related U.S. Application Data
(60) Provisional application No. 62/320,639, filed on Apr. 11, 2016.

(30) Foreign Application Priority Data
Apr. 18, 2016 (EP) 16165807.5

(51) Int. Cl. A01N 43/82; A01N 43/56; A01N 43/54; A01N 47/40; A01N 43/713; A01N 43/78; A01N 43/80; A01N 43/40; A01N 47/24; A01N 47/02; A01N 37/50

(52) U.S. Cl. CPC A01N 43/82; A01N 43/56; A01N 43/54; A01N 47/40; A01N 43/713; A01N 37/50; A01N 43/80; A01N 43/40; A01N 47/24; A01N 47/02; A01N 43/78

(57) ABSTRACT

The present invention relates to the use of a pesticidal mixtures comprising as active components tioxazafen for protecting plants, the plant propagation material thereof, or soil or water, in which the plants are growing, against the attack or infestation by invertebrate pests and/or phytopathogenic harmful fungi. Furthermore, the present invention relates to a seed treatment composition comprising at least one of the pesticidal mixtures and to seeds comprising at least one of the pesticidal mixtures or the seed treatment composition thereof. Moreover, the present invention relates to a method for controlling invertebrate pests and/or phytopathogenic harmful fungi on plants comprising contacting the plant or the plant propagation material; the pest or its food supply, habitat or breeding ground; and/or the fungi or their habitat, with an effective amount of the pesticidal mixtures or the seed treatment compositions thereof.

The present invention relates to mixtures of active ingredients having synergistically enhanced action and to methods comprising applying said mixtures.

One typical problem arising in the field of pest control lies in the need to reduce the dosage rates of the active ingredient in order to reduce or avoid unfavorable environmental or toxicological effects whilst still allowing effective pest control.

Another problem encountered concerns the need to have available pest control agents which are effective against a broad spectrum of pests.

There also exists the need for pest control agents that combine knock-down activity with prolonged control, that is, fast action with long lasting action.

Another difficulty in relation to the use of pesticides is that the repeated and exclusive application of an individual pesticidal compound leads in many cases to a rapid selection of pests which have developed natural or adapted resistance against the active compound in question. Therefore there is a need for pest control agents that help prevent or overcome resistance induced by pesticides.

Furthermore, there is a desire for pesticide compounds or combination of compounds, which when applied improve plants, which may result in “plant health”, “vitality of plant propagation material” or “increased plant yield”.

It is therefore an object of the present invention to provide agricultural combinations which solves one or more than one of the discussed problems as reducing the dosage rate, enhancing the spectrum of activity, combining knock-down activity with prolonged control, improving resistance management, improved plant health, improved vitality of plant propagation material, also termed seed vitality, and increased plant yield. It has been found that this object is in part or in whole achieved by the combination of active compounds defined below.

The present invention relates to pesticidal mixtures comprising tioxazafen as component (I) and at least one component (II) selected from the group of: fipronil, acetamiprid, tetraniliprole, oxythiapiprolin, ethaboxam, fluopyram, 2-{3-[2-(1-{[3,5-bis(di-fluoromethyl-1H-pyrazol-1-yl]acetyl}piperidin-4-yl)-1,3-thiazol-4-yl]-4,5-dihydro-1,2-oxazol-5-yl}phenyl methanesulfonate and 2-{3-[2-(1-{[3,5-bis(di-fluoro-methyl)-1H-pyrazol-1-yl]acetyl}piperidin-4-yl) 1,3-thiazol-4-yl]-4,5-dihydro-1,2-oxazol-5-yl}-3-chlorophenyl methanesulfonate, fluxapyroxad, sedaxane, penflufen, pyraclostrobin, trifloxystrobin, picoxystrobin, azoxystrobin.

The present invention relates to pesticidal mixtures A, B, C, D, E, F, G, H, I and J, wherein
the pesticidal mixture A comprises as active components
   A1) tioxazafen; and A2) fipronil;
the pesticidal mixture B comprises as active components
   B1) tioxazafen; and B2) acetamiprid;
the pesticidal mixture C comprises as active components
   C1) tioxazafen; and C2) tetraniliprole;
the pesticidal mixture D comprises as active components
   D1) tioxazafen; and D2) oxathiapiprolin;
the pesticidal mixture E comprises as active components
   E1) tioxazafen; and E2) ethaboxam;
the pesticidal mixture F comprises as active components
   F1) tioxazafen; and F2) fluopyram;
the pesticidal mixture G comprises as active components
   G1) tioxazafen; and G2) 2-{3-[2-(1-{[3,5-bis(di-fluoromethyl-1H-pyrazol-1-yl]acetyl}piperidin-4-yl)-1,3-thiazol-4-yl]-4,5-dihydro-1,2-oxazol-5-yl}phenyl methanesulfonate;
the pesticidal mixture H comprises as active components
   H1) tioxazafen; and H2) 2-{3-[2-(1-{[3,5-bis(di-fluoro-methyl)-1H-pyrazol-1-yl]acetyl}piperidin-4-yl) 1,3-thiazol-4-yl]-4,5-dihydro-1,2-oxazol-5-yl}-3-chlorophenyl methanesulfonate;
the pesticidal mixture I comprises as active components
   I1) tioxazafen and I2) fluxapyroxad or sedaxane or penflufen;
the pesticidal mixture J comprises as active components
   J1) tioxazafen and J2) pyraclostrobin or trifloxystrobin or picoxystrobin or azoxystrobin.

The term component (I) refers to tioxazafen, being the component A1, B1, C1, D1, E1, F1, G1, H1, I1 and J1 of pesticidal mixture A, B, C, D, E, F, G, H, I and J, respectively.

The term component (II) refers to the respective component A2, B2, C2, D2, E2, F2, G2, H2, I2 and J2 of pesticidal mixture A, B, C, D, E, F, G, H, I and J.

Further embodiments of pesticidal mixture I are:
the pesticidal mixture I.1 comprises as active components
   I.1-1) tioxazafen and I.1-2) fluxapyroxad;
the pesticidal mixture I.2 comprises as active components
   I.2-1) tioxazafen and I.2-2) sedaxane;
the pesticidal mixture I.3 comprises as active components
   I.3-1) tioxazafen and I.3-2) penflufen.

The term component (I) refers to tioxazafen, being the component I.1-1, I.2-1 and I.3-1, pesticidal mixture I.1, I.2 and I.3, respectively.

The term component (II) refers to the respective component I.1-2, I.2-2, and I.3-2 of pesticidal mixture I.1, I.2 and I.3.

Further embodiments of pesticidal mixture J are:
the pesticidal mixture J.1 comprises as active components
   J.1-1) tioxazafen and J.1-2) pyraclostrobin;
the pesticidal mixture J.2 comprises as active components
   J.2-1) tioxazafen and J.2-2) trifloxystrobin;
the pesticidal mixture J.3 comprises as active components
   J.3-1) tioxazafen and J.3-2) picoxystrobin;
the pesticidal mixture J.4 comprises as active components
   J.4-1) tioxazafen and J.4-2) azoxystrobin.

The term component (I) refers to tioxazafen, being the component J.1-1, J.2-1, J.3-1 and J.4-1, pesticidal mixture J.1, J.2, J.3 and J.4, respectively.

The term component (II) refers to the respective component J.1-2, J.2-2, J.3-2 and J.4-2 of pesticidal mixture J.1, J.2, J.3 and J.4.

It has been found that simultaneous, that is joint or separate, application of component (I) and component (II) or successive application (that is immediately one after another and thereby creating the mixture “in-situ” on the desired location, as e.g. the plant) of component (I) and component (II) allows enhanced control of pests compared to the control rates that are possible with the individual components (I) and components (II). Therefore, the term “mixture” as used herein is intended to include also combinations.

Preferably pesticidal mixture A comprises components A1 and A2 in synergistic effective amounts. More preferred, pesticidal mixture A comprises components A1 and A2 in synergistic effective amounts to achieve a synergistic nematicidal or synergistic insecticidal or a synergistic nematicidal and synergistic insecticidal effect.

Preferably pesticidal mixture B comprises components B1 and B2 in synergistic effective amounts. More preferred, pesticidal mixture B comprises components B1 and B2 in synergistic effective amounts to achieve a synergistic nematicidal or synergistic insecticidal or a synergistic nematicidal and synergistic insecticidal effect.

Preferably pesticidal mixture C comprises components C1 and C2 in synergistic effective amounts. More preferred, pesticidal mixture C comprises components C1 and C2 in synergistic effective amounts to achieve a synergistic nematicidal or synergistic insecticidal or a synergistic nematicidal and synergistic insecticidal effect.

Preferably pesticidal mixture D comprises components D1 and D2 in synergistic effective amounts. More preferred, pesticidal mixture D comprises components D1 and D2 in synergistic effective amounts to achieve a synergistic nematicidal or synergistic fungicidal or a synergistic nematicidal and synergistic fungicidal effect.

Preferably pesticidal mixture E comprises component E1 and E2 in synergistic effective amounts. More preferred, pesticidal mixture E comprises components E1 and E2 in synergistic effective amounts to achieve a synergistic nematicidal or synergistic fungicidal or a synergistic nematicidal and synergistic fungicidal effect.

Preferably pesticidal mixture F comprises component F1 and F2 in synergistic effective amounts. More preferred, pesticidal mixture F comprises components F1 and F2 in synergistic effective amounts to achieve a synergistic nematicidal or synergistic fungicidal or a synergistic nematicidal and synergistic fungicidal effect.

Preferably pesticidal mixture G comprises component G1 and G2 in synergistic effective amounts. More preferred, pesticidal mixture G comprises components G1 and G2 in synergistic effective amounts to achieve a synergistic nematicidal or synergistic fungicidal or a synergistic nematicidal and synergistic fungicidal effect.

Preferably pesticidal mixture H comprises component H1 and H2 in synergistic effective amounts. More preferred, pesticidal mixture H comprises components H1 and H2 in synergistic effective amounts to achieve a synergistic nematicidal or synergistic fungicidal or a synergistic nematicidal and synergistic fungicidal effect.

Preferably pesticidal mixture I comprises component I1 and one of compounds I2 in synergistic effective amounts. More preferred, pesticidal mixture I comprises components I1 and one of compounds I2 in synergistic effective amounts to achieve a synergistic fungicidal or synergistic plant growth or a synergistic fungicidal and synergistic plant growth effect.

Preferably pesticidal mixture I.1, I.2 and I.3 comprise component I.1-1, I.2-1 and I.3-1 and one of compounds I.1-2, I.2-2, and I.3-2, respectively, in synergistic effective amounts. More preferred, pesticidal mixture I comprises components I.1, I.2 and I.3 comprise component I.1-1, I.2-1 and I.3-1 and one of compounds I.1-2, I.2-2, and I.3-2, respectively, in synergistic effective amounts to achieve a synergistic fungicidal or synergistic plant growth or a synergistic fungicidal and synergistic plant growth effect.

Preferably pesticidal mixture J comprises component J1 and one of compounds J2 in synergistic effective amounts. More preferred, pesticidal mixture J comprises components J1 and one of compounds J2 in synergistic effective amounts to achieve a synergistic fungicidal or synergistic plant growth or a synergistic fungicidal and synergistic plant growth effect.

Preferably pesticidal mixture J.1, J.2, J.3 and J.4 comprise component J.1-1, J.2-1, J.3-1 and J.4-1 and one of compounds J.1-2, J.2-2, J.3-2 and J.4-2, respectively, in synergistic effective amounts. More preferred, pesticidal mixture J.1, J.2, J.3 and J.4 comprise component J.1-1, J.2-1, J.3-1 and J.4-1 and one of compounds J.1-2, J.2-2, J.3-2 and J.4-2, respectively, in synergistic effective amounts to achieve a synergistic fungicidal or synergistic plant growth or a synergistic fungicidal and synergistic plant growth effect.

The term “synergistic effect” is understood to refer in particular to that defined by Colby's formula (Colby, S. R., “Calculating synergistic and antagonistic responses of herbicide combinations”, Weeds, 15, pp. 20-22, 1967).

The present invention also provides methods for the control of insects, acarids or nematodes comprising contacting the insect, acarid or nematode or their food supply, habitat, breeding grounds or their locus with a pesticidally effective amount of mixtures of active component (I) with active component (II) of pesticidal mixture A, or with a pesticidally effective amount of mixtures of active component (I) with active component (II) of pesticidal mixture B, or with a pesticidally effective amount of mixtures of active component (I) with active component (II) of pesticidal mixture C.

The present invention also provides methods for the control of fungi comprising contacting the fungi, their host plant or propagation material of their host plant

with a pesticidally effective amount of mixtures of active component (I) with active component (II) of pesticidal mixture D, or with a pesticidally effective amount of mixtures of active component (I) with active component (II) of pesticidal mixture E, or with a pesticidally effective amount of mixtures of active component (I) with active component (II) of pesticidal mixture F, or with a pesticidally effective amount of mixtures of active component (I) with active component (II) of pesticidal mixture G, or with a pesticidally effective amount of mixtures of active component (I) with active component (II) of pesticidal mixture H, or with a pesticidally effective amount of mixtures of active component (I) with at least one active component (II) of pesticidal mixture I, or with a pesticidally effective amount of mixtures of active component (I) with at least one active component (II) of one of pesticidal mixtures I.1, I.2 and I.3, or with a pesticidally effective amount of mixtures of active component (I) with at least one active component (II) of pesticidal mixture J, or with a pesticidally effective amount of mixtures of active component (I) with at least one active component (II) of one of pesticidal mixtures J.1, J.2, J.3 and J.4.

Moreover, the present invention also relates to a method of protecting plants from attack or infestation by insects or nematodes comprising contacting the plant, or the soil or water in which the plant is growing with a pesticidally effective amount of mixtures of active component (I) with active component (II) of pesticidal mixture A, or with a pesticidally effective amount of mixtures of active component (I) with active component (II) of pesticidal mixture B, or with a pesticidally effective amount of mixtures of active component (I) with active component (II) of pesticidal mixture C.

Moreover, the present invention also relates to a method of protecting plants from attack or infestation by fungi comprising contacting the plant, or the soil or water in which the plant is growing with a pesticidally effective amount of mixtures of active component (I) with active component (II) of pesticidal mixture D, or with a pesticidally effective amount of mixtures of active component (I) with active component (II) of pesticidal mixture E, or with a pesticidally effective amount of mixtures of active component (I) with active component (II) of pesticidal mixture F, or with a pesticidally effective amount of mixtures of active component (I) with active component (II) of pesticidal mixture G, or with a pesticidally effective amount of mixtures of active component (I) with active component (II) of pesticidal mixture H, or with a pesticidally effective amount of mixtures of active component (I) with at least one active component (II) of pesticidal mixture I, or with a pesticidally effective amount of mixtures of active component (I) with at least one active component (II) of one of pesticidal mixtures I.1, I.2 and I.3, or with a pesticidally effective amount of mixtures of active component (I) with at least one active component (II) of pesticidal mixture J, or with a pesticidally effective amount of mixtures of active component (I) with at least one active component (II) of one of pesticidal mixtures J.1, J.2, J.3 and J.4.

Further, the present invention also relates to a method of improving plant health comprising contacting the plant, or the soil or water in which the plant is growing, with a pesticidally effective amount of mixtures of active component (I) with at least one active component (II) of pesticidal mixture I, or with a pesticidally effective amount of mixtures of active component (I) with at least one active component (II) of one of pesticidal mixtures I.1, I.2 and I.3, or with a pesticidally effective amount of mixtures of active component (I) with at least one active component (II) of pesticidal mixture J, or with a pesticidally effective amount of mixtures of active component (I) with at least one active component (II) of one of pesticidal mixtures J.1, J.2, J.3 and J.4.

The invention also provides a method for the protection of plant propagation material, preferably seeds or ratoon, from soil insects and of the seedlings' roots and shoots from soil and/or foliar insects which comprises contacting the plant propagation material as e.g. the seeds before sowing and/or after pregermination with a pesticidally effective amount of mixtures of active component (I) with active component (II) of pesticidal mixture A, or with a pesticidally effective amount of mixtures of active component (I) with active component (II) of pesticidal mixture B, or with a pesticidally effective amount of mixtures of active component (I) with active component (II) of pesticidal mixture C.

The invention also provides a method for the protection of plant propagation material, preferably seeds or ratoon, from nematodes and of the seedlings' roots and shoots from nematodes which comprises contacting the plant propagation material as e.g. the seeds before sowing and/or after pregermination with a pesticidally effective amount of mixtures of active component (I) with active component (II) of pesticidal mixture A, or with a pesticidally effective amount of mixtures of active component (I) with active component (II) of pesticidal mixture B, or with a pesticidally effective amount of mixtures of active component (I) with active component (II) of pesticidal mixture C, or with a pesticidally effective amount of mixtures of active component (I) with active component (II) of pesticidal mixture D, or with a pesticidally effective amount of mixtures of active component (I) with active component (II) of pesticidal mixture E, or with a pesticidally effective amount of mixtures of active component (I) with active component (II) of pesticidal mixture F, or with a pesticidally effective amount of mixtures of active component (I) with active component (II) of pesticidal mixture G, or with a pesticidally effective amount of mixtures of active component (I) with active component (II) of pesticidal mixture H.

The invention also provides a method for improving the plant health of plants, plant propagation material, preferably seeds or ratoon, and improving the plant health of the seedlings' roots and shoots which comprises contacting the plant propagation material as e.g. the seeds before sowing and/or after pregermination, with a pesticidally effective amount of mixtures of active component (I) with at least one active component (II) of pesticidal mixture I, or with a pesticidally effective amount of mixtures of active component (I) with at least one active component (II) of one of pesticidal mixtures I.1, I.2 and I.3, or with a pesticidally effective amount of mixtures of active component (I) with at least one active component (II) of pesticidal mixture J, or with a pesticidally effective amount of mixtures of active component (I) with at least one active component (II) of one of pesticidal mixtures J.1, J.2, J.3 and J.4.

The invention also provides plant propagation material, preferably seeds or ratoon, comprising a pesticidally effective amount of mixtures of active component (I) with active component (II) of pesticidal mixture A, or a pesticidally effective amount of mixtures of active component (I) with active component (II) of pesticidal mixture B, or a pesticidally effective amount of mixtures of active component (I) with active component (II) of pesticidal mixture C, or a pesticidally effective amount of mixtures of active component (I) with active component (II) of pesticidal mixture D, or a pesticidally effective amount of mixtures of active component (I) with active component (II) of pesticidal mixture E, or a pesticidally effective amount of mixtures of active component (I) with active component (II) of pesticidal mixture F, or a pesticidally effective amount of mixtures of active component (I) with active component (II) of pesticidal mixture G, or a pesticidally effective amount of mixtures of active component (I) with active component (II) of pesticidal mixture H, or with a pesticidally effective amount of mixtures of active component (I) with at least one active component (II) of pesticidal mixture I, or with a pesticidally effective amount of mixtures of active component (I) with at least one active component (II) of one of pesticidal mixtures I.1, I.2 and I.3, or with a pesticidally effective amount of mixtures of active component (I) with at least one active component (II) of pesticidal mixture J, or with a pesticidally effective amount of mixtures of active component (I) with at least one active component (II) of one of pesticidal mixtures J.1, J.2, J.3 and J.4.

The invention also provides pesticidal compositions, preferably a seed or ratoon treatment composition, comprising at least one auxiliary,

with a pesticidally effective amount of mixtures of active component (I) with active component (II) of pesticidal mixture A, or with a pesticidally effective amount of mixtures of active component (I) with active component (II) of pesticidal mixture B, or with a pesticidally effective amount of mixtures of active component (I) with active component (II) of pesticidal mixture C, or with a pesticidally effective amount of mixtures of active component (I) with active component (II) of pesticidal mixture D, or with a pesticidally effective amount of mixtures of active component (I) with active component (II) of pesticidal mixture E, or with a pesticidally effective amount of mixtures of active component (I) with active component (II) of pesticidal mixture F, or with a pesticidally effective amount of mixtures of active component (I) with active component (II) of pesticidal mixture G, or with a pesticidally effective amount of mixtures of active component (I) with active component (II) of pesticidal mixture H, or with a pesticidally effective amount of mixtures of active component (I) with at least one active component (II) of pesticidal mixture I, or with a pesticidally effective amount of mixtures of active component (I) with at least one active component (II) of one of pesticidal mixtures I.1, I.2 and I.3, or with a pesticidally effective amount of mixtures of active component (I) with at least one active component (II) of pesticidal mixture J, or with a pesticidally effective amount of mixtures of active component (I) with at least one active component (II) of one of pesticidal mixtures J.1, J.2, J.3 and J.4.

The invention also relates to the use of a mixture of at least one active component (I) with at least one active component (II) of pesticidal mixture A, or a mixture of at least one active component (I) with at least one active component (II) of pesticidal mixture B, or a mixture of at least one active component (I) with at least one active component (II) of pesticidal mixture C, for combating insects, arachnids or nematodes, preferably for combating insects and/or nematodes.

The invention also relates to the use of a mixture of at least one active component (I) with at least one active component (II) of pesticidal mixture D, or a mixture of at least one active component (I) with at least one active component (II) of pesticidal mixture E, or a mixture of at least one active component (I) with at least one active component (II) of pesticidal mixture F, or a mixture of at least one active component (I) with at least one active component (II) of pesticidal mixture G, or a mixture of at least one active component (I) with at least one active component (II) of pesticidal mixture H, or with a pesticidally effective amount of mixtures of active component (I) with at least one active component (II) of pesticidal mixture I, or with a pesticidally effective amount of mixtures of active component (I) with at least one active component (II) of one of pesticidal mixtures I.1, I.2 and I.3, or with a pesticidally effective amount of mixtures of active component (I) with at least one active component (II) of pesticidal mixture J, or with a pesticidally effective amount of mixtures of active component (I) with at least one active component (II) of one of pesticidal mixtures J.1, J.2, J.3 and J.4, for combating plant pathogenic fungi.

The mixture(s) A, B, C, D, E, F, G, H, I, including mixtures I.1, I.2, I.3, and J, including mixtures J.1, J.2, J.3 and J.4, of at least one active component (I) with at least one active component (II) are herein referred to as “mixture(s) according to the invention”. In a specific embodiment, the mixture according to the invention is a mixture of one active component (I) with one active component (II) (binary mixture). In another embodiment, the mixture according to the invention is a mixture of one active component (I) with one active component (II) and at least one further compound, preferably a further fungicide or insecticide in an active amount.

Component (I) and its use as pesticide is described in WO09023721 (Tioxazafen) WO2014/089219, WO15038503, WO15055752, WO15055755, WO15055757, WO15144683, WO15200175, WO16014664, WO16015979, WO16018875 describe pesticidal mixtures of component (I) with other pesticides. However, they do not disclose mixtures of component (I) with component(s) (II) according to the present invention, which show unexpected and synergistic effects in combination with each other. CN104488900, CN104521989, CN104488896 describe mixtures of methanesulfonyl oxadiazoles with neonicotinoid insecticides and fungicides, respectively. Again, none of these disclosures describe mixtures of component (I) with component(s) (II) according to the present invention.

Component (I) and component(s) (II) can be prepared according to standard methods of organic chemistry. Methods for their preparation and their action against harmful nematodes, insects and fungi, respectively are known (cf.: http://www.alanwood.net/pesticides/) and they are generally commercially available. Commercially available active compounds can be found, for example, in The Pesticide Manual, 14th Edition, British Crop Protection Council (2006) and other publications. Components (II) of pesticidal mixtures G and H are disclosed in WO2011076699, WO2012104273, WO2012168188, WO2013127704, WO2013113829 and WO2015036379. The preparation of component (I) and component(s) (II) may lead to them being obtained as isomer mixtures. If desired, these can be resolved by the methods customary for this purpose, such as crystallization or chromatography, also on optically active adsorbate, to give the pure isomers. Agronomically acceptable salts of the compounds I can be formed in a customary manner, e.g. by reaction with an acid of the anion in question.

The component (I) and component(s) (II) are usually applied in a weight ratio of from 5000:1 to 1:5000, preferably from 1000:1 to 1:1000, preferably from 625:1 to 1:625, preferably 500:1 to 1:500, 500:1 to 1:100, preferably from 100:1 to 1:100, preferably from 20:1 to 1:50, preferably from 20:1 to 1:20, preferably from 10:1 to 1:10, in particular from 5:1 to 1:20, in particular from 5:1 to 1:10, in particular from 5:1 to 1:5. Preferred weight ratios of component (I) and component (II) of pesticidal mixtures A, B, C, F, G, H, I, and J are: 20:1 to 1:20, 15:1 to 1 to 15, 10:1 to 1:10, 5:1 to 1:5. Preferred weight ratios of component (I) and component (II) of pesticidal mixture D and E are: 200:1 to 1:10, 100:1 to 1:5. 50:1 to 1:2. Depending on the desired effect, the application rates of the pesticidal mixtures according to the invention are from 5 g/ha to 2000 g/ha, preferably from 0.5 g/ha to 1000 g/ha, preferably from 1 to 750 g/ha, in particular from 5 to 500 g/ha. Preferred application rates of pesticidal mixture A1, A1.1, A1.2 and A2 are: 1 g to 200 g/ha, preferably 5 g to 100 g/ha, more preferred 1 g to 100 g/ha. Preferred application rates of pesticidal mixture B, C, D, E, F, G, H, I and J are: 1 g to 200 g/ha, 1 g to 100 g/ha, 1 g to 50 g/ha.

### Component (III)

In one embodiment of the invention, the mixtures of the present invention may be combined and applied in agriculture in mixture with other active ingredients [further pesticidally active component (III)], for example with other pesticides, insecticides, herbicides, fertilizers such as ammonium nitrate, urea, potash, and superphosphate, phytotoxicants and plant growth regulators, safeners and nematicides. These additional ingredients may be used sequentially or in combination with the above-described component (I) and component (II), if appropriate also added only immediately prior to use (tank mix). For example, the plant(s) may be sprayed with a composition of this invention either before or after being treated with other active ingredients. In one embodiment, the mixture according to the invention is a mixture of one active component (I) and one active component (II) and a further active component (III), e.g. selected from group M or F, as described herein (ternary mixture). In another embodiment, the mixture according to the invention is a mixture of one active component (I) and one active component (II) and a two further active components (III), e.g. selected from group M or F, preferably a mixture, wherein at least one component III is selected from group F (4-way mixture). In another embodiment, the mixture according to the invention is a mixture of one active component (I) and one active component (II) and three further active components (III) e.g. selected from group M or F, preferably a mixture, wherein at least one component III is selected from group F (5-way mixture). In a particular embodiment of the invention, in the mixtures, methods and uses according to the invention, the active component (I) and one active component (II) are combined with one or more other pesticidally active component(s) (III) selected from insecticides or fungicides. Preferably the further pesticidal active compound (III) is active against said soil-living fungal or arthropod pest. A skilled person is familiar with such compounds and knows which compounds are active against a specific target organism. The compound (III) pesticides, together with which the mixtures of the present invention may be used according to the purpose of the present invention, and with which potential synergistic effects with regard to the method of uses might be produced, are selected from group M and group F. Group M is, wherever possible, grouped according to the Mode of Action Classification from the Insecticide Resistance Action Committee (IRAC) and consists of the following group of compounds:

M.1 Acetylcholine esterase (AChE) inhibitors from the class of

M.1A carbamates, for example aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and triazamate; or from the class of

M.1B organophosphates, for example acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon and vamidothion;

M.2. GABA-gated chloride channel antagonists such as:

M.2A cyclodiene organochlorine compounds, as for example endosulfan or chlordane; or

M.2B fiproles (phenylpyrazoles), as for example ethiprole, fipronil, flufiprole, pyrafluprole and pyriprole;

M.3 Sodium channel modulators from the class of

M.3A pyrethroids, for example acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, meperfluthrin, metofluthrin, momfluorothrin, permethrin, phenothrin, prallethrin, profluthrin, pyrethrin (pyrethrum), resmethrin, silafluofen, tefluthrin, tetramethylfluthrin, tetramethrin, tralomethrin and transfluthrin; or

M.3B sodium channel modulators such as DDT or methoxychlor;

M.4 Nicotinic acetylcholine receptor agonists (nAChR) from the class of

M.4A neonicotinoids, for example acteamiprid, chlothianidin, cycloxaprid, dinotefuran, imidacloprid, nitenpyram, thiacloprid and thiamethoxam; or the compounds

M.4A.1: 1-[(6-chloro-3-pyridinyl)methyl]-2,3,5,6,7,8-hexahydro-9-nitro-(5S,8R)-5,8-epoxy-1H-imidazo[1,2-a]azepine; or

M.4A.2: 1-[(6-chloro-3-pyridyl)methyl]-2-nitro-1-[(E)-pentylideneamino]guanidine; or

M.4A.3: 1-[(6-chloro-3-pyridyl)methyl]-7-methyl-8-nitro-5-propoxy-3,5,6,7-tetrahydro-2H-imidazo[1,2-a]pyridine; or

M.4B nicotine.

M.5 Nicotinic acetylcholine receptor allosteric activators from the class of spinosyns, for example spinosad or spinetoram;

M.6 Chloride channel activators from the class of avermectins and milbemycins, for example abamectin, emamectin benzoate, ivermectin, lepimectin or milbemectin;

M.7 Juvenile hormone mimics, such as

M.7A juvenile hormone analogues as hydroprene, kinoprene and methoprene; or others as

M.7B fenoxycarb, or

M.7C pyriproxyfen;

M.8 miscellaneous non-specific (multi-site) inhibitors, for example

M.8A alkyl halides as methyl bromide and other alkyl halides, or

M.8B chloropicrin, or

M.8C sulfuryl fluoride, or

M.8D borax, or

M.8E tartar emetic;

M.9 Selective homopteran feeding blockers, for example

M.9B pymetrozine, or

M.9C flonicamid;

M.10 Mite growth inhibitors, for example

M.10A clofentezine, hexythiazox and diflovidazin, or

M.10B etoxazole;

M.11 Microbial disruptors of insect midgut membranes, for example bacillus thuringiensis or bacillus sphaericus and the insecticdal proteins they produce such as bacillus thuringiensis subsp. israelensis, bacillus sphaericus, bacillus thuringiensis subsp. aizawai, bacillus thuringiensis subsp. kurstaki and bacillus thuringiensis subsp. tenebrionis, or the Bt crop proteins: Cry1Ab, Cry1Ac, Cry1Fa, Cry2Ab, mCry3A, Cry3Ab, Cry3Bb and Cry34/35Ab1;

M.12 Inhibitors of mitochondrial ATP synthase, for example

M.12A diafenthiuron, or

M.12B organotin miticides such as azocyclotin, cyhexatin or fenbutatin oxide, or M.12C propargite, or

M.12D tetradifon;

M.13 Uncouplers of oxidative phosphorylation via disruption of the proton gradient, for example chlorfenapyr, DNOC or sulfluramid;

M.14 Nicotinic acetylcholine receptor (nAChR) channel blockers, for example nereistoxin analogues as bensultap, cartap hydrochloride, thiocyclam or thiosultap sodium;

M.15 Inhibitors of the chitin biosynthesis type 0, such as benzoylureas as for example bistrifluron, chlorfluazuron, diflubenzuron, flucycloxuron, flufenoxuron, hexaflumuron, lufenuron, novaluron, noviflumuron, teflubenzuron or triflumuron;

M.16 Inhibitors of the chitin biosynthesis type 1, as for example buprofezin;

M.17 Moulting disruptors, Dipteran, as for example cyromazine;

M.18 Ecdyson receptor agonists such as diacylhydrazines, for example methoxyfenozide, tebufenozide, halofenozide, fufenozide or chromafenozide;

M.19 Octopamin receptor agonists, as for example amitraz;

M.20 Mitochondrial complex III electron transport inhibitors, for example

M.20A hydramethylnon, or

M.20B acequinocyl, or

M.20C fluacrypyrim;

M.21 Mitochondrial complex I electron transport inhibitors, for example

M.21A METI acaricides and insecticides such as fenazaquin, fenpyroximate, pyrimidifen, pyridaben, tebufenpyrad or tolfenpyrad, or

M.21B rotenone;

M.22 Voltage-dependent sodium channel blockers, for example

M.22A indoxacarb, or

M.22B metaflumizone; or

M.22C 1-[(E)-[2-(4-cyanophenyl)-1-[3-(trifluoromethyl)phenyl]ethylidene]amino]-3-[4-(difluoromethoxy)phenyl]urea; or N-(3-Chloro-2-methylphenyl)-2-[(4-chlorophenyl)[4-[methyl(methylsulfonyl)amino]phenyl]methylene]-hydrazinecarboxamide;

M.23 Inhibitors of the of acetyl CoA carboxylase, such as Tetronic and Tetramic acid derivatives, for example spirodiclofen, spiromesifen or spirotetramat;

M.24 Mitochondrial complex IV electron transport inhibitors, for example

M.24A phosphine such as aluminium phosphide, calcium phosphide, phosphine or zinc phosphide, or

M.24B cyanide.

M.25 Mitochondrial complex II electron transport inhibitors, such as beta-ketonitrile derivatives, for example cyenopyrafen or cyflumetofen;

M.26 Ryanodine receptor-modulators from the class of diamides, as

for example flubendiamide, chlorantraniliprole (Rynaxypyr®), cyantraniliprole (Cyazypyr®),

cyclaniliprole, tetraniliprole, or

the phthalamide compounds

M.26.1: (R)-3-Chlor-N1-{2-methyl-4-[1,2,2,2-tetrafluor-1-(trifluormethyl)ethyl]phenyl}-N2-(1-methyl-2-methylsulfonylethyl)phthalamide and

M.26.2: (S)-3-Chlor-N1-{2-methyl-4-[1,2,2,2-tetrafluor-1-(trifluormethyl)ethyl]phenyl}-N2-(1-methyl-2-methylsulfonylethyl)phthalamide, or the compound

M.26.4: methyl-2-[3,5-dibromo-2-({[3-bromo-1-(3-chloropyridin-2-yl)-1H-pyrazol-5-yl]carbonyl}amino)benzoyl]-1,2-dimethylhydrazinecarboxylate; or a compound selected from M.26.5a) to M.26.5d):

M.26.5a: N-[2-(5-Amino-1,3,4-thiadiazol-2-yl)-4-chloro-6-methylphenyl]-3-bromo-1-(3-chloro-2-pyridinyl)-1H-pyrazole-5-carboxamide;

M.26.5b: 3-Chloro-1-(3-chloro-2-pyridinyl)-N-[2,4-dichloro-6-[[(1-cyano-1-methylethyl)amino]carbonyl]phenyl]-1H-pyrazole-5-carboxamide;

M.26.5c: 3-Bromo-N-[2,4-dichloro-6-(methylcarbamoyl)phenyl]-1-(3,5-dichloro-2-pyridyl)-1H-pyrazole-5-carboxamide (SYP-9080);

M.26.5d: N-[4-Chloro-2-[[(1,1-dimethylethyl)amino]carbonyl]-6-methylphenyl]-1-(3-chloro-2-pyridinyl)-3-(fluoromethoxy)-1H-pyrazole-5-carboxamide; or

M.26.6: N-(2-cyanopropan-2-yl)-N-(2,4-dimethylphenyl)-3-iodobenzene-1,2-dicarboxamide; or

M.26.7: 3-Chloro-N-(2-cyanopropan-2-yl)-N-(2,4-dimethylphenyl)-benzene-1,2-dicarboxamide; or

M.26.8a) 1-(3-Chloro-2-pyridinyl)-N-[4-cyano-2-methyl-6-[(methylamino)carbonyl]phenyl]-3-[[5-(trifluoromethyl)-2H-tetrazol-2-yl]methyl]-1H-pyrazole-5-carboxamide; or

M.26.8b) 1-(3-Chloro-2-pyridinyl)-N-[4-cyano-2-methyl-6-[(methylamino)carbonyl]phenyl]-3-[[5-(trifluoromethyl)-1H-tetrazol-1-yl]methyl]-1H-pyrazole-5-carboxamide, or

M.X insecticidal active compounds of unknown or uncertain mode of action, as for example afidopyropen, azadirachtin, amidoflumet, benzoximate, bifenazate, bromopropylate, chinomethionat, cryolite, dicofol, flufenerim, flometoquin, fluensulfone, fluopyram, flupyradifurone, fluralaner, metoxadiazone, piperonyl butoxide, pyflubumide, pyridalyl, pyrifluquinazon, sulfoxaflor, tioxazafen, triflumezopyrim, or the compounds

M.X.1: 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide, or the compound

M.X.2: cyclopropaneacetic acid, 1,1′-[(3S,4R,4aR,6S,6aS,12R,12aS,12bS)-4-[[(2-cyclopropylacetyl)oxy]methyl]-1,3,4,4a,5,6,6a,12,12a,12b-decahydro-12-hydroxy-4,6a,12b-trimethyl-11-oxo-9-(3-pyridinyl)-2H,11H-naphtho[2,1-b]pyrano[3,4-e]pyran-3,6-diyl] ester, or the compound

M.X.3: 11-(4-chloro-2,6-dimethylphenyl)-12-hydroxy-1,4-dioxa-9-azadispiro[4.2.4.2]-tetradec-11-en-10-one, or the compound

M.X.4: 3-(4′-fluoro-2,4-dimethylbiphenyl-3-yl)-4-hydroxy-8-oxa-1-azaspiro[4.5]dec-3-en-2-one, or the compound

M.X.5: 1-[2-fluoro-4-methyl-5-[(2,2,2-trifluoroethyl)sulfinyl]phenyl]-3-(trifluoromethyl)-1H-1,2,4-triazole-5-amine, or actives on basis of bacillus firmus (Votivo, 1-1582), or

M.X.6: a compound selected from the group of

M.X.6a: (E/Z)—N-[1-[(6-chloro-3-pyridyl)methyl]-2-pyridylidene]-2,2,2-trifluoro-acetamide;

M.X.6b: (E/Z)—N-[1-[(6-chloro-5-fluoro-3-pyridyl)methyl]-2-pyridylidene]-2,2,2-trifluoro-acetamide;

M.X.6c: (E/Z)-2,2,2-trifluoro-N-[1-[(6-fluoro-3-pyridyl)methyl]-2-pyridylidene]acetamide;

M.X.6d: (E/Z)—N-[1-[(6-bromo-3-pyridyl)methyl]-2-pyridylidene]-2,2,2-trifluoro-acetamide;

M.X.6e: (E/Z)—N-[1-[1-(6-chloro-3-pyridyl)ethyl]-2-pyridylidene]-2,2,2-trifluoro-acetamide;

M.X.6f: (E/Z)—N-[1-[(6-chloro-3-pyridyl)methyl]-2-pyridylidene]-2,2-difluoro-acetamide;

M.X.6 g: (E/Z)-2-chloro-N-[1-[(6-chloro-3-pyridyl)methyl]-2-pyridylidene]-2,2-difluoro-acetamide;

M.X.6h: (E/Z)—N-[1-[(2-chloropyrimidin-5-yl)methyl]-2-pyridylidene]-2,2,2-trifluoro-acetamide and

M.X.6i: (E/Z)—N-[1-[(6-chloro-3-pyridyl)methyl]-2-pyridylidene]-2,2,3,3,3-pentafluoro-propanamide); or

M.X.7: triflumezopyrim; or

M.X.8: 4-[5-[3-chloro-5-(trifluoromethyl)phenyl]-5-(trifluoromethyl)-4H-isoxazol-3-yl]-N-[2-oxo-2-(2,2,2-trifluoroethylamino)ethyl]naphthalene-1-carboxamide, or

M.X.9: 3-[3-chloro-5-(trifluoromethyl)phenyl]-4-oxo-1-(pyrimidin-5-ylmethyl)pyrido[1,2-a]pyrimidin-1-ium-2-olate; or

M.X.10: 8-chloro-N-[2-chloro-5-methoxyphenyl)sulfonyl]-6-trifluoromethyl)-imidazo[1,2-a]pyridine-2-carboxamide; or

M.X.11: 4-[5-(3,5-dichlorophenyl)-5-(trifluoromethyl)-4H-isoxazol-3-yl]-2-methyl-N-(1-oxothietan-3-yl)benzamide; or

M.X.12: 5-[3-[2,6-dichloro-4-(3,3-dichloroallyloxy)phenoxy]propoxy]-1H-pyrazole.

The commercially available components (III) of the group M listed above may be found in The Pesticide Manual, 15th Edition, C. D. S. Tomlin, British Crop Protection Council (2011) among other publications. The quinoline derivative flometoquin is shown in WO2006/013896. The aminofuranone corn-pounds flupyradifurone is known from WO 2007/115644. The sulfoximine compound sulfoxaflor is known from WO2007/149134. The pyrethroid momfluorothrin is known from U.S. Pat. No. 6,908,945. The pyrazole acaricide pyflubumide is known from WO2007/020986. The isoxazoline compound M.X.1 has been described in WO2005/085216, M.X.8 in WO2009/002809 and in WO2011/149749 and the isoxazoline M.X.11 in WO2013/050317. The pyripyropene derivative M.X.2 has been described in WO 2006/129714. The spiroketal-substituted cyclic ketoenol derivative M.X.3 is known from WO2006/089633 and the biphenyl-substituted spirocyclic ke-toenol derivative M.X.4 from WO2008/067911. Triazoylphenylsulfide like M.X.5 have been described in WO2006/043635 and biological control agents on basis of bacillus firmus in WO2009/124707. The neonicotionids M4A.1 is known from WO20120/069266 and WO2011/06946, the M.4A.2 from WO2013/003977, the M4A.3. from WO2010/069266. The metaflumizone analogue M.22C is described in CN 10171577.

Cyantraniliprole (Cyazypyr) is known from e.g. WO 2004/067528. The phthalamides M.26.1 and M.26.2 are both known from WO 2007/101540. Cyclaniliprole has been described in WO 2005/077934. Tetraniliprole has been described in WO2007144100 and WO2010/069502. SYP-9080 has been described in WO2010003350. The hydrazide compound M.26.4 has been described in WO 2007/043677. The anthranilamide M.26.5a) is described in WO2011/085575, the M.26.5b) in WO2008/134969, the M.26.5c) in US2011/046186 and the M.26.5d in WO2012/034403. The diamide compounds M.26.6 and M.26.7 can be found in CN102613183. The compounds M.X.6a) to M.X.6i) listed in M.X.6 have been described in WO2012/029672. The mesoionic antagonist compound M.X.9 was described in WO2012/092115, the nemati-cide M.X.10 in WO2013/055584 and the Pyridalyl-type analogue M.X.12 in WO2010/060379.

As mentioned, the mixtures of the present invention may also be applied with fungicides as compound III, preferably in a synergistic manner. The following list F of active substances, in conjunction with which the compounds according to the invention can be used, is intended to illustrate the possible combinations but does not limit them:

F.1) Respiration Inhibitors

F.I-1) Inhibitors of complex III at Qo site:

strobilurins: azoxystrobin, coumethoxystrobin, coumoxystrobin, dimoxystrobin, enestroburin, fluoxastrobin, kresoxim-methyl, mandestrobin, metominostrobin, orysastrobin, picoxystrobin, pyraclostrobin, pyrametostrobin, pyraoxystrobin, pyribencarb, triclopyricarb/chlorodincarb, trifloxystrobin, 2-[2-(2,5-dimethyl-phenoxymethyl)-phenyl]-3-methoxy-acrylic acid methyl ester and 2 (2-(3-(2,6-dichlorophenyl)-1-methyl-allylideneaminooxymethyl)-phenyl)-2-methoxyimino-N methyl-acetamide; oxazolidinediones and imidazolinones: famoxadone, fenamidone;

F.I-2) Inhibitors of complex II (e.g. carboxamides): carboxanilides: benodanil, benzovindiflupyr, bixafen, boscalid, carboxin, fenfuram, fenhexamid, fluopyram, flutolanil, furametpyr, isofetamid, isopyrazam, isotianil, mepronil, oxycarboxin, penflufen, penthiopyrad, sedaxane, tecloftalam, thifluzamide, tiadinil, 2-amino-4 methyl-thiazole-5-carboxanilide, N-(3′,4′,5′ trifluorobiphenyl-2 yl)-3-difluoromethyl-1-methyl-1H-pyrazole-4 carboxamide (fluxapyroxad), N-(4′-trifluoromethylthiobiphenyl-2-yl)-3 difluoromethyl-1-methyl-1H pyrazole-4-carboxamide, N-(2-(1,3,3-trimethyl-butyl)phenyl)-1,3-dimethyl-5 fluoro-1H-pyrazole-4 carboxamide, 3-(difluoromethyl)-1-methyl-N-(1,1,3-trimethylindan-4-yl)pyrazole-4-carboxamide, 3-(trifluoromethyl)-1-methyl-N-(1,1,3-trimethylindan-4-yl)pyrazole-4-carboxamide, 1,3-dimethyl-N-(1,1,3-trimethylindan-4-yl)pyrazole-4-carboxamide, 3-(trifluoromethyl)-1,5-dimethyl-N-(1,1,3-trimethylindan-4-yl)pyrazole-4-carboxamide, 3-(difluoromethyl)-1,5-dimethyl-N-(1,1,3-trimethylindan-4-yl)pyrazole-4-carboxamide, 1,3,5-trimethyl-N-(1,1,3-trimethylindan-4-yl)pyrazole-4-carboxamide, 3-(difluoromethyl)-1-methyl-N-(1,1,3-trimethylindan-4-yl)pyrazole-4-carboxamide, 3-(trifluoromethyl)-1-methyl-N-(1,1,3-trimethylindan-4-yl)pyrazole-4-carboxamide, 1,3-dimethyl-N-(1,1,3-trimethylindan-4-yl)pyrazole-4-carboxamide, 3-(trifluoromethyl)-1,5-dimethyl-N-(1,1,3-trimethylindan-4-yl)pyrazole-4-carboxamide, 3-(difluoromethyl)-1,5-dimethyl-N-(1,1,3-trimethylindan-4-yl)pyrazole-4-carboxamide, 3-(trifluorometh¬yl)-1,5-dimethyl-N-(1,1,3-trimethylindan-4-yl)¬pyrazole-4-carboxamide, 1,3,5-trimethyl-N-(1,1,3-trimethylindan-4-yl)pyrazole-4-carboxamide, N-(7-fluoro-1,1,3-trimethyl-indan-4-yl)-1,3-dimethyl-pyrazole-4-carbox¬amide, N-[2-(2,4-dichlorophenyl)-2-methoxy-1-methyl-ethyl]-3-(difluoromethyl)-1-methyl-pyrazole-4-carboxamide;

F.I-3) Inhibitors of complex III at Qi site: cyazofamid, amisulbrom, [(3S,6S,7R,8R)-8-benzyl-3-[(3-acetoxy-4-methoxy-pyridine-2-carbonyl)amino]-6-methyl-4,9-dioxo-1,5-dioxonan-7-yl] 2-methylpropanoate, [(3S,6S,7R,8R)-8-benzyl-3-[[3-(acetoxymethoxy)-4-methoxy-pyridine-2-carbonyl]amino]-6-methyl-4,9-dioxo-1,5-dioxonan-7-yl] 2-methylpropanoate, [(3S,6S,7R,8R)-8-benzyl-3-[(3-isobutoxycarbonyloxy-4-methoxy-pyridine-2-carbonyl)amino]-6-methyl-4,9-dioxo-1,5-dioxonan-7-yl] 2-methylpropanoate, [(3S,6S,7R,8R)-8-benzyl-3-[[3-(1,3-benzodioxol-5-ylmethoxy)-4-methoxy-pyridine-2-carbonyl]amino]-6-methyl-4,9-dioxo-1,5-dioxonan-7-yl] 2-methylpropanoate, 3S,6S,7R,8R)-3-[[(3-hydroxy-4-methoxy-2-pyridinyl)carbonyl]amino]-6-methyl-4,9-dioxo-8-(phenylmethyl)-1,5-dioxonan-7-yl 2-methylpropanoate;

F.I-4) Other respiration inhibitors (complex I, uncouplers) diflumetorim; (5,8-difluoroquinazolin-4-yl)-{2-[2-fluoro-4-(4-trifluoromethylpyridin-2-yloxy)-phenyl]-ethyl}-amine; tecnazen; ametoctradin; silthiofam; nitrophenyl derivates: binapacryl, dinobuton, dinocap, fluazinam, ferimzone, nitrthal-isopropyl, and including organometal compounds: fentin salts, such as fentin-acetate, fentin chloride or fentin hydroxide;

F.II) Sterol biosynthesis inhibitors (SBI fungicides)

F.II-1) C14 demethylase inhibitors (DMI fungicides, e.g. triazoles, imidazoles) triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, paclobutrazole, penconazole, propiconazole, prothioconazole, simeconazole, tebuconazole, tetraconazole, triadimefon, triadimenol, triticonazole, uniconazole, 1-[rel-(2S,3R)-3-(2-chloro-phenyl)-2-(2,4-difluorophenyl)-oxiranylmethyl]-5-thiocyanato-1H-[1,2,4]triazole, 2-[rel-(2S;3R)-3-(2-chlorophenyl)-2-(2,4-difluorophenyl)-oxiranylmethyl]-2H-[1,2,4]triazole-3-thiol, 2-[2-chloro-4-(4-chlorophenoxy)phenyl]-1-(1,2,4-triazol-1-yl)pentan-2-ol, 1-[4-(4-chlorophenoxy)-2-(trifluoromethyl)phenyl]-1-cyclopropyl-2-(1,2,4-triazol-1-yl)ethanol, 2-[4-(4-chlorophenoxy)-2-(trifluoromethyl)phenyl]-1-(1,2,4-triazol-1-yl)butan-2-ol, 2-[2-chloro-4-(4-chlorophenoxy)phenyl]-1-(1,2,4-triazol-1-yl)butan-2-ol, 2-[4-(4-chlorophenoxy)-2-(trifluoromethyl)phenyl]-3-methyl-1-(1,2,4-triazol-1-yl)butan-2-ol, 2-[4-(4-chlorophenoxy)-2-(trifluoromethyl)phenyl]-1-(1,2,4-triazol-1-yl)propan-2-ol, 2-[2-chloro-4-(4-chlorophenoxy)phenyl]-3-methyl-1-(1,2,4-triazol-1-yl)butan-2-ol, 2-[4-(4-chlorophenoxy)-2-(trifluoromethyl)phenyl]-1-(1,2,4-triazol-1-yl)pentan-2-ol, 2-[4-(4-fluorophenoxy)-2-(trifluoromethyl)phenyl]-1-(1,2,4-triazol-1-yl)propan-2-ol; imidazoles: imazalil, pefurazoate, oxpoconazole, prochloraz, triflumizole; pyrimidines, pyridines and piperazines: fenarimol, nuarimol, pyrifenox, triforine,[3-(4-chloro-2-fluoro-phenyl)-5-(2,4 difluorophenyl)isoxazol-4-yl]-(3-pyridyl)methanol;

F.II-2) Delta14-reductase inhibitors (Amines, e.g. morpholines, piperidines) morpholines:

aldimorph, dodemorph, dodemorph-acetate, fenpropimorph, tridemorph; piperidines: fenpropidin, piperalin; spiroketalamines: spiroxamine;

F.II-3) Inhibitors of 3-keto reductase: hydroxyanilides: fenhexamid;

F.III) Nucleic acid synthesis inhibitors

F.III-1) RNA, DNA synthesis

phenylamides or acyl amino acid fungicides: benalaxyl, benalaxyl-M, kiralaxyl, metalaxyl, metalaxyl-M (mefenoxam), ofurace, oxadixyl;

isoxazoles and iosothiazolones: hymexazole, octhilinone;

F.III-2) DNA topoisomerase inhibitors: oxolinic acid;

F.III-3) Nucleotide metabolism (e.g. adenosin-deaminase), hydroxy (2-amino)-pyrimidines: bupirimate;

F.IV) Inhibitors of cell division and or cytoskeleton

F.IV-1) Tubulin inhibitors: benzimidazoles and thiophanates: benomyl, carbendazim, fuberidazole, thiabendazole, thiophanate-methyl;

triazolopyrimidines: 5-chloro-7 (4-methylpiperidin-1-yl)-6-(2,4,6-trifluorophenyl)-[1,2,4]triazolo[1,5 a]pyrimidine;

F.IV-2) Other cell division inhibitors

benzamides and phenyl acetamides: diethofencarb, ethaboxam, pencycuron, fluopicolide, zoxamide;

F.IV-3) Actin inhibitors: benzophenones: metrafenone; pyriofenone;

F.V) Inhibitors of amino acid and protein synthesis

F.V-1) Methionine synthesis inhibitors (anilino-pyrimidines) anilino-pyrimidines: cyprodinil, mepanipyrim, nitrapyrin, pyrimethanil;

F.V-2) Protein synthesis inhibitors (anilino-pyrimidines)

antibiotics: blasticidin-S, kasugamycin, kasugamycin hydrochloride-hydrate, mildiomycin, streptomycin, oxytetracyclin, polyoxine, validamycin A;

F.VI) Signal transduction inhibitors

F.VI-1) MAP/Histidine kinase inhibitors (e.g. anilino-pyrimidines)

dicarboximides: fluoroimid, iprodione, procymidone, vinclozolin;

phenylpyrroles: fenpiclonil, fludioxonil;

F.VI-2) G protein inhibitors: quinolines: quinoxyfen;

F.VII) Lipid and membrane synthesis inhibitors

F.VII-1) Phospholipid biosynthesis inhibitors

organophosphorus compounds: edifenphos, iprobenfos, pyrazophos;

dithiolanes: isoprothiolane;

F.VII-2) Lipid peroxidation: aromatic hydrocarbons: dicloran, quintozene, tecnazene, tolclofos-methyl, biphenyl, chloroneb, etridiazole;

F.VII-3) Carboxyl acid amides (CAA fungicides)

cinnamic or mandelic acid amides: dimethomorph, flumorph, mandiproamid, pyrimorph;

valinamide carbamates: benthiavalicarb, iprovalicarb, pyribencarb, valifenalate and N-(1-(1-(4-cyano-phenyl)ethanesulfonyl)-but-2-yl) carbamic acid-(4-fluorophenyl) ester;

F.VII-4) Compounds affecting cell membrane permeability and fatty acids: 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone, carbamates: propamocarb, propamocarb-hydrochlorid,

F.VII-5) fatty acid amide hydrolase inhibitors: 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone;

F.VIII) Inhibitors with Multi Site Action

F.VIII-1) Inorganic active substances: Bordeaux mixture, copper acetate, copper hydroxide, copper oxychloride, basic copper sulfate, sulfur;

F.VIII-2) Thio- and dithiocarbamates: ferbam, mancozeb, maneb, metam, methasulphocarb, metiram, propineb, thiram, zineb, ziram;

F.VIII-3) Organochlorine compounds (e.g. phthalimides, sulfamides, chloronitriles):

anilazine, chlorothalonil, captafol, captan, folpet, dichlofluanid, dichlorophen, flusulfamide, hexachlorobenzene, pentachlorphenole and its salts, phthalide, tolylfluanid, N-(4-chloro-2-nitro-phenyl)-N-ethyl-4-methyl-benzenesulfonamide;

F.VIII-4) Guanidines and other: guanidine, dodine, dodine free base, guazatine, guazatine-acetate, iminoctadine, iminoctadine-triacetate, iminoctadine-tris(albesilate), dithianon, 2,6-dimethyl-1H,5H-[1,4]dithiino[2,3-c:5,6-c′]dipyrrole-1,3,5,7(2H,6H)-tetraone;

F.VIII-5) Ahtraquinones: dithianon;

F.IX) Cell wall synthesis inhibitors

F.IX-1) Inhibitors of glucan synthesis: validamycin, polyoxin B;

F.IX-2) Melanin synthesis inhibitors: pyroquilon, tricyclazole, carpropamide, dicyclomet, fenoxanil;

F.X) Plant defence inducers

F.X-1) Salicylic acid pathway: acibenzolar-S-methyl;

F.X-2) Others: probenazole, isotianil, tiadinil, prohexadione-calcium;

phosphonates: fosetyl, fosetyl-aluminum, phosphorous acid and its salts;

F.XI) Unknown mode of action: bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxathiapiprolin, oxin-copper, proquinazid, tebufloquin, tecloftalam, triazoxide, 2-butoxy-6-iodo-3-propylchromen-4-one, N-(cyclopropylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N methyl formamidine, N′ (4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2 methyl-4-(3-trimethylsilanyl-propoxy)-phenyl)-N-ethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, methoxy-acetic acid 6-tert-butyl-8-fluoro-2,3-dimethyl-quinolin-4-yl ester and N-Methyl-2-{1-[(5-methyl-3-trifluoromethyl-1H-pyrazol-1-yl)-acetyl]piperidin-4-yl}-N-[(1R)-1,2,3,4-tetrahydronaphthalen-1-yl]-4-thiazolecarboxamide, 3-[5-(4-chloro-phenyl)-2,3-dimethyl-isoxazolidin-3 yl]-pyridine, pyrisoxazole, 5-amino-2-isopropyl-3-oxo-4-ortho-tolyl-2,3-dihydro-pyrazole-1 carbothioic acid S-allyl ester, N-(6-methoxy-pyridin-3-yl) cyclopropanecarboxylic acid amide, 5-chloro-1 (4,6-dimethoxy-pyrimidin-2-yl)-2-methyl-1H-benzoimidazole, 2-(4-chloro-phenyl)-N-[4-(3,4-dimethoxy-phenyl)-isoxazol-5-yl]-2-prop-2-ynyloxy-acetamide, ethyl (Z) 3 amino-2-cyano-3-phenyl-prop-2-enoate, tert-butyl N-[6-[[(Z)-[(1-methyltetrazol-5-yl)-phenyl-methylene]amino]oxymethyl]-2-pyridyl]carbamate, pentyl N-[6-[[(Z)-[(1-methyltetrazol-5-yl)-phenyl-methylene]amino]oxymethyl]-2-pyridyl]carbamate, 2-[2-[(7,8-difluoro-2-methyl-3-quinolyl)oxy]-6-fluoro-phenyl]propan-2-ol, 2-[2-fluoro-6-[(8-fluoro-2-methyl-3-quinolyl)oxy]phenyl]propan-2-ol, 3-(5-fluoro-3,3,4,4-tetramethyl-3,4-dihydroiso¬quinolin-1-yl)quinoline, 3-(4,4-difluoro-3,3-dimethyl-3,4-dihydroisoquinolin-1-yl)¬quinoline, 3-(4,4,5-trifluoro-3,3-dimethyl-3,4-dihydroisoquinolin-1-yl)quinoline;

F.XII) Growth regulators: abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N 6-benzyladenine, paclobutrazol, prohexadione (prohexadione-calcium), prohydrojasmon, thidiazuron, triapenthenol, tributyl phosphorotrithioate, 2,3,5 tri iodobenzoic acid, trinexapac-ethyl and uniconazole;

The commercially available components (III) of the group F listed above may be found in The Pesticide Manual, 15th Edition, C. D. S. Tomlin, British Crop Protection Council (2011) among other publications. Their preparation and their activity against harmful fungi is known (cf.: http://www.alanwood.net/pesticides/); these substances are commercially available. The compounds described by IUPAC nomenclature, their preparation and their fungicidal activity are also known (cf. Can. J. Plant Sci. 48(6), 587-94, 1968; EPA 141 317; EP-A 152 031; EP-A 226 917; EP A 243 970; EP A 256 503; EP-A 428 941; EP-A 532 022; EP-A 1 028 125; EP-A 1 035 122; EPA 1 201 648; EPA 1 122 244, JP 2002316902; DE 19650197; DE 10021412; DE 102005009458; U.S. Pat. Nos. 3,296,272; 3,325,503; WO 98/46608; WO 99/14187; WO 99/24413; WO 99/27783; WO 00/29404; WO 00/46148; WO 00/65913; WO 01/54501; WO 01/56358; WO 02/22583; WO 02/40431; WO 03/10149; WO 03/11853; WO 03/14103; WO 03/16286; WO 03/53145; WO 03/61388; WO 03/66609; WO 03/74491; WO 04/49804; WO 04/83193; WO 05/120234; WO 05/123689; WO 05/123690; WO 05/63721; WO 05/87772; WO 05/87773; WO 06/15866; WO 06/87325; WO 06/87343; WO 07/82098; WO 07/90624, WO 11/028657).

Preferred are mixtures of the present invention with a further component (III) selected from GABA-gated chloride channel antagonists as defined above, preferred group M.2B (fiproles), especially preferred is ethiprole.

Preferred are mixtures of the present invention with a further component (III) selected from group M.3 (Sodium channel modulators) as defined above, preferred group M.3A (pyrethroids), especially preferred alpha-cypermethrin and cyhalothrin.

Preferred are mixtures of the present invention, with a further component (III) selected from group M.4A (Neonicotinoids), especially preferred in particular clothianidin, dinotefuran, imidacloprid, thiacloprid, or thiamethoxam.

Preferred are mixtures of the present invention with a further component (III) selected from group M.5 (Nicotinic acetylcholine receptor allosteric activators), especially preferred spinosad or spinetoram.

Preferred are mixtures of the present invention with a further component (III) selected from group M.13 (Uncouplers of oxidative phosphorylation via disruption of the proton gradient), preferably chlorfenapyr.

Preferred are mixtures of the present invention with a further component (III) selected from group M.22 (Voltage-dependent sodium channel blockers), preferably metaflumizone.

Weight ratios of component (I) and component (II) and a component (III) in ternary mixtures depend on the properties of the components. The weight ratio of component (I) to component (II), is preferably in the range of from 1:100 to 100:1, in the range of from 1:50 to 50:1, in the range of from 1:20 to 20:1, in the range of from 1:10 to 10:1 and in particular in the range of from 1:4 to 4:1,

The weight ratio of component (I) to component (III) is preferably in the range from 1:100 to 100:1, in the range from 1:50 to 50:1 in the range from 1:20 to 20:1, in the range from 1:10 to 10:1 and in particular in the range of from 1:4 to 4:1.

A particular preferred embodiment of the invention (pesticidal mixture A1) is a 3-way mixture comprising component (I), component (II) of pesticidal mixture A and comprising pyraclostrobine or thiophanate-methyl as component (III).

Another preferred embodiment of the invention (pesticidal mixture A1.1) is a 3-way mixture comprising component (I), component (II) of pesticidal mixture A and comprising pyraclostrobine as component (III).

A particular preferred embodiment of the invention (pesticidal mixture A1.2) is a 3-way mixture comprising component (I), component (II) of pesticidal mixture A and comprising thiophanate-methyl as component (III).

A further preferred embodiment of the invention (pesticidal mixture A2) are 4-way mixtures comprising component (I), component (II) of pesticidal mixture A and comprising pyraclostrobine as component (III) and thiophanate-methyl as component (IV).

The present invention also provides methods for the control of insects or nematodes comprising contacting the insect or nematode or their food supply, habitat, breeding grounds or their locus with a pesticidally effective amount of active component (I) and a pesticidally effective amount of component (II) and an amount of component (III) of pesticidal mixture A1, or

with a pesticidally effective amount of active component (I) and a pesticidally effective amount of component (II) and an amount of component (III) of pesticidal mixture A1.1, or

with a pesticidally effective amount of active component (I) and a pesticidally effective amount of component (II) and an amount of component (III) of pesticidal mixture A1.2, or

with a pesticidally effective amount of active component (I) and a pesticidally effective amount of component (II), an amount of component (III) and an amount of component (IV) of pesticidal mixture A2.

The present invention also provides methods for the control of fungi comprising contacting the fungi, their host plant or propagation material of their host plant

with a pesticidally effective amount of active component (I) and a pesticidally effective amount of component (II) and an amount of component (III) of pesticidal mixture A1, or

with a pesticidally effective amount of active component (I) and a pesticidally effective amount of component (II) and an amount of component (III) of pesticidal mixture A1.1, or

with a pesticidally effective amount of active component (I) and a pesticidally effective amount of component (II) and an amount of component (III) of pesticidal mixture A1.2, or

with an amount of component (I), an amount of component (II) and a pesticidally effective amount of active component (III) and a pesticidally effective amount of component (IV) of pesticidal mixture A2.

Moreover, the present invention also relates to a method of protecting plants from attack or infestation by insects or nematodes comprising contacting the plant, or the soil or water in which the plant is growing,

with a pesticidally effective amount of active component (I) and a pesticidally effective amount of component (II) and an amount of component (III) of pesticidal mixture A1, or

with a pesticidally effective amount of active component (I) and a pesticidally effective amount of component (II) and an amount of component (III) of pesticidal mixture A1.1, or

with a pesticidally effective amount of active component (I) and a pesticidally effective amount of component (II) and an amount of component (III) of pesticidal mixture A1.2, or

with a pesticidally effective amount of active component (I) and a pesticidally effective amount of component (II), an amount of component (III) and an amount of component (IV) of pesticidal mixture A2.

Preferred weight ratios of component (I) and component (II) of pesticidal mixture(s) A1, A1.1, and A1.2 are in the range from 1:100 to 100:1, in the range from 1:50 to 50:1, preferably in the range from 1:20 to 20:1, more preferably in the range from 1:10 to 10:1 and in particular in the range of from 1:4 to 4:1, and the weight ratio of component (I) and component (III) is preferably in the range from 1:100 to 100:1, regularly in the range from 1:50 to 50:1, preferably in the range from 1:20 to 20:1. The weight ratio of component (I) and component (II) of pesticidal mixture A2 is in the range from 1:100 to 100:1, in the range from 1:50 to 50:1, preferably in the range from 1:20 to 20:1, more preferred in the range from 1:10 to 10:1 and most preferred in the range of from 1:4 to 4:1. The weight ratio of component (I) and component (III) of pesticidal mixture A2 is in the range from 1:100 to 100:1, in the range from 1:50 to 50:1, preferably in the range from 1:20 to 20:1. The weight ratio of component (I) and component (IV) of pesticidal mixture A2 is in the range from 1:100 to 100:1, in the range from 1:50 to 50:1, preferably in the range from 1:20 to 20:1 and more preferably in the range from 1:10 to 10:1.

Moreover, the present invention also relates to a method of protecting plants from attack or infestation by fungi comprising contacting the plant, or the soil or water in which the plant is growing,

with an amount of component (I), an amount of component (II) and a pesticidally effective amount of active component (III) of pesticidal mixture A1, or

with an amount of component (I), an amount of component (II) and a pesticidally effective amount of active component (III) of pesticidal mixture A1.1, or

with an amount of component (I), an amount of component (II) and a pesticidally effective amount of active component (III) of pesticidal mixture A1.2, or

with an amount of component (I), an amount of component (II) and a pesticidally effective amount of active component (III) and a pesticidally effective amount of component (IV) of pesticidal mixture A2.

Further, the present invention also relates to a method of improving plant health comprising contacting the plant, or the soil or water in which the plant is growing,

with an effective amount of mixtures of component (I), component (II) and component (III) of pesticidal mixture A1, or

with an effective amount of mixtures of component (I), component (II) and component (III) of pesticidal mixture A1.1, or

with an effective amount of mixtures of component (I), component (II) and component (III) of pesticidal mixture A1.2, or

with an effective amount of mixtures of component (I), component (II), component (III) and component (IV) of pesticidal mixture A2.

Preferably the effective amounts of mixtures of component (I), component (II) and component (III) of pesticidal mixture A1, A1.1, A1.2 or A2 are effective amounts to provide for a synergistic plant health effect.

The invention also provides a method for the protection of plant propagation material, preferably seeds or ratoon, from soil insects and of the seedlings' roots and shoots from soil and/or foliar insects which comprises contacting the plant propagation material as e.g. the seeds before sowing and/or after pregermination

with a pesticidally effective amount of active component (I) and a pesticidally effective amount of component (II) and an amount of component (III) of pesticidal mixture A1, or

with a pesticidally effective amount of active component (I) and a pesticidally effective amount of component (II) and an amount of component (III) of pesticidal mixture A1.1, or

with a pesticidally effective amount of active component (I) and a pesticidally effective amount of component (II) and an amount of component (III) of pesticidal mixture A1.2, or

with a pesticidally effective amount of active component (I) and a pesticidally effective amount of component (II), an amount of component (III) and an amount of component (IV) of pesticidal mixture A2.

The invention also provides a method for the protection of plant propagation material, preferably seeds or ratoon, from nematodes and of the seedlings' roots and shoots from nematodes which comprises contacting the plant propagation material as e.g. the seeds before sowing and/or after pregermination

with a pesticidally effective amount of active component (I) and a pesticidally effective amount of component (II) and an amount of component (III) of pesticidal mixture A1, or

with a pesticidally effective amount of active component (I) and a pesticidally effective amount of component (II) and an amount of component (III) of pesticidal mixture A1.1, or

with a pesticidally effective amount of active component (I) and a pesticidally effective amount of component (II) and an amount of component (III) of pesticidal mixture A1.2, or

with a pesticidally effective amount of active component (I) and a pesticidally effective amount of component (II), an amount of component (III) and an amount of component (IV) of pesticidal mixture A2.

The invention also provides a method for improving the plant health of plant propagation material, preferably seeds or ratoon, and improving the plant health of the seedlings' roots and shoots which comprises contacting the plant propagation material as e.g. the seeds before sowing and/or after pregermination,

with an effective amount of mixtures of component (I), component (II) and component (III) of pesticidal mixture A1, or

with an effective amount of mixtures of component (I), component (II) and component (III) of pesticidal mixture A1.1, or

with an effective amount of mixtures of component (I), component (II) and component (III) of pesticidal mixture A1.2, or

with an effective amount of mixtures of component (I), component (II), component (III) and component (IV) of pesticidal mixture A2.

Preferably the effective amounts of mixtures of component (I), component (II) and component (III) of pesticidal mixture A1, A1.1, A1.2 or A2 are effective amounts to provide for a synergistic plant health effect.

The invention also provides plants propagation material, preferably seeds or ratoon, comprising

a) a pesticidally effective amount of mixtures of component (I), component (II) and component (III) of pesticidal mixture A1, or

b) a pesticidally effective amount of mixtures of component (I), component (II) and component (III) of pesticidal mixture A1.1, or

c) a pesticidally effective amount of mixtures of component (I), component (II) and component (III) of pesticidal mixture A1.2, or

d) a pesticidally effective amount of mixtures of component (I), component (II), component (III) and component (IV) of pesticidal mixture A2.

The invention also provides pesticidal compositions, preferably a seed or ratoon treatment composition, comprising at least one auxiliary, and

a) a pesticidally effective amount of mixtures of active component (I), with active component (II) and with active component (III) of pesticidal mixture A1, or

b) a pesticidally effective amount of mixtures of active component (I), with active component (II) and with active component (III) of pesticidal mixture A1.1, or

c) a pesticidally effective amount of mixtures of active component (I), with active component (II) and with active component (III) of pesticidal mixture A1.2, or

d) a pesticidally effective amount of mixtures of active component (I), with active component (II), with active component (III) and with active component (IV) of pesticidal mixture A2.

The invention also relates to the use of

a) a pesticidally effective amount of mixtures of active component (I), active component (II) and active component (III) of pesticidal mixture A1, or

b) a pesticidally effective amount of mixtures of active component (I), active component (II) and active component (III) of pesticidal mixture A1.1, or

c) a pesticidally effective amount of mixtures of active component (I), active component (II) and active component (III) of pesticidal mixture A1.2, or

d) a pesticidally effective amount of mixtures of active component (I), active component (II), active component (III) and active component (IV) of pesticidal mixture A2.

for preparing a seed treatment composition.

The invention also relates to the use of

a) a pesticidally effective amount of mixtures of active component (I), active component (II) and active component (III) of pesticidal mixture A1, or

b) a pesticidally effective amount of mixtures of active component (I), active component (II) and active component (III) of pesticidal mixture A1.1, or

c) a pesticidally effective amount of mixtures of active component (I), active component (II) and active component (III) of pesticidal mixture A1.2, or

d) a pesticidally effective amount of mixtures of active component (I), active component (II), active component (III) and active component (IV) of pesticidal mixture A2.

for preparing plant propagation material.

According to a further aspect, the present invention relates to pesticidal mixtures T comprising,

1) as component (I): tioxazafen;

2) as component (II) a compound selected from the group consisting of the compounds compound K.1-2
2-[4-(4-chlorophenoxy)-2-(trifluoromethyl)phenyl]-1-(1,2,4-triazol-1-yl)propan-2-ol; compound K.2-2
1-[4-(4-chlorophenoxy)-2-(trifluoromethyl)phenyl]-1-cyclopropyl-2-(1,2,4-triazol-1-yl)ethanol; and compound K.3-2
2-[4-(4-chlorophenoxy)-2-(trifluoromethyl)phenyl]-3-methyl-1-(1,2,4-triazol-1-yl)butan-2-ol; or the N-oxides or the agriculturally acceptable salts of each of the compounds; and

3) as component (III) a compound selected from the group consisting of the compounds Azoxystrobin (F-1), Trifloxystrobin (F-2), Picoxystrobin (F-3), Pyraclostrobin (F-4), Sedaxane (F-5), Penthiopyrad (F-6), Penflufen (F-7), Fluopyram (F-8), Fluxapyroxad (F-9), Boscalid (F-10), Oxathiapiprolin (F-11), Metalaxyl (F-12), Metalaxyl-M (F-13), Ethaboxam (F-14), dimethomorph (F-15), Valifenalate (F-16), Cyproconazole (F-17), Difenoconazole (F-18), Prothioconazole (F-19), Flutriafol (F-20), Thiabendazole (F-21), Ipconazole (F-22), Tebuconazole (F-23), Triadimenol (F-24), Prochloraz (F-25), Fluquinconazole (F-26), Triticonazole (F-27), Fludioxinil (F-28), Carboxin (F-29), Silthiofarm (F-30), Ziram (F-31), Thiram (F-32), Carbendazim (F-33), Thiophanate-methyl (F-34), Fluazinam (F-35), Fenamidon (F-36), Fipronil (In-1), 3-[(methyl)amino]-N-[2-bromo-4-[1,2,2,2-tetrafluoro-1-(trifluoromethyl)ethyl]-6-(trifluoromethyl)phenyl]-2-fluoro-benzamide (In-2), 3-(benzoylmethylamino)-N-[2-bromo-4-[1,2,2,3,3,3-hexafluoro-1-(trifluoromethyl)propyl]-6-(trifluoromethyl)phenyl]-2-fluoro-benzamide (In-3), 3-(benzoylmethylamino)-2-fluoro-N-[2-iodo-4-[1,2,2,2-tetrafluoro-1-(trifluoromethyl)ethyl]-6-(trifluoromethyl)phenyl]-benzamide (In-4), N-[3-[[[2-iodo-4-[1,2,2,2-tetrafluoro-1-(trifluoromethyl)ethyl]-6-(trifluoromethyl)phenyl]amino]carbonyl]phenyl]-N-methyl-benzamide (In-5), N-[3-[[[2-bromo-4-[1,2,2,2-tetrafluoro-1-(trifluoromethyl)ethyl]-6-(trifluoromethyl)phenyl]amino]carbonyl]-2-fluorophenyl]-4-fluoro-N-methyl-benzamide (In-6), 4-fluoro-N-[2-fluoro-3-[[[2-iodo-4-[1,2,2,2-tetrafluoro-1-(trifluoromethyl)ethyl]-6-(trifluoromethyl)-phenyl]amino]carbonyl]phenyl]-N-methyl-benzamide (In-7), 3-fluoro-N-[2-fluoro-3-[[[2-iodo-4-[1,2,2,2-tetrafluoro-1-(trifluoromethyl)ethyl]-6-(trifluoromethyl)phenyl]amino]carbonyl]phenyl]-N-methyl-benzamide (In-8), 2-chloro-N-[3-[[[2-iodo-4-[1,2,2,2-tetrafluoro-1-(trifluoromethyl)ethyl]-6-(trifluoromethyl)phenyl]amino]carbonyl]phenyl]-3-pyridinecarboxamide (In-9), N-[4,6-dichloro-2-[(diethyl-lambda-4-sulfanylidene)carbamoyl]-phenyl]-2-(3-chloro-2-pyridyl)-5-(trifluoromethyl)-pyrazole-3-carboxamide (In-10), N-[4-chloro-2-[(diethyl-lambda-4-sulfanylidene)carbamoyl]-6-methyl-phenyl]-2-(3-chloro-2-pyridyl)-5-(trifluoromethyl)pyrazole-3-carboxamide (In-11), N-[4-chloro-2-[(di-2-propyl-lambda-4-sulfanylidene)carbamoyl]-6-methyl-phenyl]-2-(3-chloro-2-pyridyl)-5-(trifluoromethyl)pyrazole-3-carboxamide (In-12), N-[4,6-dichloro-2-[(di-2-propyl-lambda-4-sulfanylidene)carbamoyl]-phenyl]-2-(3-chloro-2-pyridyl)-5-(trifluoromethyl)pyrazole-3-carboxamide (In-13), N-[4,6-dibromo-2-[(diethyl-lambda-4-sulfanylidene)carbamoyl]-phenyl]-2-(3-chloro-2-pyridyl)-5-(trifluoromethyl)pyrazole-3-carboxamide (In-14), Clothianidin (In-15), Thiamethoxam (In-16), Acetamiprid (In-17), Dinotefuran (In-18), Imidacloprid (In-19), Thiacloprid (In-20), Flupyradifurone (In-21), Sulfoxaflor (In-22), Methiocarb (In-23), Tefluthrin (In-24), Bifenthrin (In-25), Cypermethrin (In-26), Alphacypermethrin (In-27), Spinosad (In-28), Cyazypyr (In-29), Rynaxapyr (In-30), Thiodicarb (In-31), Triflumezopyrim (Mesoionic) (In-32), Acephate (In-33), Chlorpyriphos (In-34) and Abamectin (In-35), or the N-oxides or the agriculturally acceptable salts of each of the compounds.

In the following, the components (I), (II) and (III) of pesticical mixtures T used in this aspect of the present invention are further detailed and preferences and embodiments are outlined. Any of the embodiments and preferences given for a particular component can also be combined with any of the embodiments and preferences given for one or more further components of the inventive compositions.

The components (II) of pesticical mixtures K and T can be obtained by various routes in analogy to prior art processes known (cf. J. Agric. Food Chem. (2009) 57, 4854-4860; EP 0 275 955 A1; DE 40 03 180 A1; EP 0 113 640 A2; EP 0 126 430 A2). Furthermore, the components (II), their preparation and use in crop protection are described in WO 2013/007767. Owing to the basic character of their nitrogen atoms, compounds K.1-2, K.2-2 and K.3-2 is capable of forming salts or adducts with inorganic or organic acids or with metal ions, in particular salts with inorganic acids or N-oxides.

In each case, the respective N-oxide and the agriculturally acceptable salts of the compounds as further defined below are encompassed. Compounds K.1-2, K.2-2 and K.3-2 comprise chiral centers and they are generally obtained in the form of racemates. The R- and S-enantiomers of the compounds contained as component II in the compositions according to the invention can be separated and isolated in pure form with methods known by the skilled person, e.g. by using chiral HPLC. Suitable for use in the compositions are both the enantiomers and compositions thereof. Furthermore, said components I can be present in different crystal modifications, which may differ in biological activity.

In particular, in each case, a racemic composition of the respective components (II), namely of compound K.1-2, K.2-2 or K.3-2, respectively, is present. Furthermore, any other proportions of the (R)-enantiomer and the (S)-enantiomer of the respective compound K.1-2, K.2-2 or K.3-2, respectively, may be present according to the present invention. For example, the (R)-enantiomer of compound K.1-2 is (R)-2-[4-(4-chlorophenoxy)-2-(trifluoromethyl)phenyl]-1-(1,2,4-triazol-1-yl)propan-2-ol; the S-enantiomer of K.1-2 is (S)-2-[4-(4-chlorophenoxy)-2-(trifluoromethyl)phenyl]-1-(1,2,4-triazol-1-yl)propan-2-ol. This applies to the other compounds accordingly.

According to one specific embodiment, the respective compound K.1-2, K.2-2 or K.3-2, respectively, is provided and used as (R)-enantiomer with an enantiomeric excess (e.e.) of at least 40%, for example, at least 50%, 60%, 70% or 80%, preferably at least 90%, more preferably at least 95%, yet more preferably at least 98% and most preferably at least 99%. According to a further specific embodiment, the respective compound K.1-2, K.2-2 or K.3-2, respectively, is provided and used as (S)-enantiomer with an enantiomeric excess (e.e.) of at least 40%, for example, at least 50%, 60%, 70% or 80%, preferably at least 90%, more preferably at least 95%, yet more preferably at least 98% and most preferably at least 99%. This applies to every composition detailed herein.

According to one embodiment of the invention, component (II) is compound K.1-2.

According to a further embodiment of the invention, component (II) is compound K.2-2.

According to a further embodiment of the invention, component (II) is compound K.3-2.

The pesticides III, described by their common names, their preparation and their biological activity e. g. against harmful fungi, pests or weed is known (cf.: http://www.alanwood.net/pesticides/); these substances are commercially available and known, for example, from the references below:

azoxystrobin, methyl 2-{2-[6-(2-cyano-1-vinylpenta-1,3-dienyloxy)pyrimidin-4-yloxy]phenyl}-3-methoxyacrylate (EP 382 375); trifloxystrobin, methyl (E)-methoxyimino-{(E)-α-[1-(α,α,α-trifluoro-m-tolyl) ethylideneaminooxy]-o-tolyl}acetate (EP 460 575); picoxystrobin, methyl 3-methoxy-2-[2-(6-trifluoromethylpyridin-2-yloxymethyl)phenyl]acrylate (EP 278 595); pyraclostrobin, methyl N-{2-[1-(4-chlorophenyl)-1H-pyrazol-3-yloxymethyl]phenyl}(N-methoxy)carbamate (WO 96/01256); penthiopyrad, (RS)—N-[2-(1,3-dimethylbutyl)-3-thienyl]-1-methyl-3-(trifluoromethyl)-1H-pyrazole-4-carboxamide (JP 10130268); boscalid, 2-chloro-N-(4′-chlorobiphenyl-2-yl)nicotinamide (EP-A 545 099); metalaxyl, methyl N-(methoxyacetyl)-N-(2,6-xylyl)-DL-alaninate (GB 15 00 581); ethaboxam, N-(cyano-2-thienylmethyl)-4-ethyl-2-(ethylamino)-5-thiazolecarboxamide (EP-A 639 574); dimethomorph, 3-(4-chlorophenyl)-3-(3,4-dimethoxyphenyl)-1-morpholin-4-yl-propenone (EP 120 321); cyproconazole, 2-(4-chlorophenyl)-3-cyclopropyl-1-[1,2,4]triazol-1-ylbutan-2-ol (U.S. Pat. No. 4,664,696); difenoconazole, 1-{2-[2-chloro-4-(4-chlorophenoxy)phenyl]-4-methyl-[1,3]dioxolan-2-ylmethyl}-1H-[1,2,4]triazole (GB-A 2 098 607); prothioconazole, 2-[2-(1-chlorocyclopropyl)-3-(2-chlorophenyl)-2-hydroxypropyl]-2,4-dihydro-[1,2,4]triazole-3-thione (WO 96/16048); flutriafol, α-(2-fluorophenyl)-α-(4-fluorophenyl)-1H-1,2,4-triazole-1-ethanol (EP 15 756); thiabendazole, 2-(1,3-thiazol-4-yl)benzimidazole (U.S. Pat. No. 3,017,415); ipconazole, 2-[(4-chlorophenyl)methyl]-5-(1-methylethyl)-1-(1H-1,2,4-triazol-1-ylmethyl)cyclopentanol (EP 267 778); tebuconazole, 1-(4-chlorophenyl)-4,4-dimethyl-3-[1,2,4]triazol-1-ylmethylpentan-3-ol (EP-A 40 345); triadimenol, β-(4-chlorophenoxy)-α-(1,1-dimethylethyl)-1H-1,2,4-triazole-1-ethanol (DE 23 24 010); prochloraz, N-(propyl-[2-(2,4,6-trichlorophenoxy)ethyl])imidazole-1-carboxamide (U.S. Pat. No. 3,991,071); fluquinconazole, 3-(2,4-dichlorophenyl)-6-fluoro-2-[1,2,4]triazol-1-yl-3H-quinazolin-4-one (Proc. Br. Crop Prot. Conf.-Pests Dis., 5-3, 411 (1992)); triticonazole, (5E)-5-[(4-chlorophenyl)methylene]-2,2-dimethyl-1-(1H-1,2,4-triazol-1-ylmethyl)cyclopentanol (FR 26 41 277); fludioxonil, 4-(2,2-difluorobenzo[1,3]dioxol-4-yl)-1H-pyrrole-3-carbonitrile (The Pesticide Manual, publ. The British Crop Protection Council, 10th ed. (1995), p. 482); carboxin, 5,6-dihydro-2-methyl-N-phenyl-1,4-oxathiin-3-carboxamide (U.S. Pat. No. 3,249,499); silthiofam, N-allyl-4,5-dimethyl-2-(trimethylsilyl)thiophene-3-carboxamide [CAS RN 175217-20-6]; ziram, thiram, bis(dimethylthiocarbamoyl) disulfide (DE 642 532); carbendazim, methyl (1H-benzoimidazol-2-yl)carbamate (U.S. Pat. No. 3,657,443); thiophanate-methyl, 1,2-phenylenebis(iminocarbono-thioyl)bis(dimethylcarbamate) (DE-A 19 30 540). Compound In-2 is disclosed in WO 2010/018714, the preparation is described in EP 2322502. Compounds In-10 to In-14 can be prepared as described in WO 2007/006670, WO2013/024009 and WO2013/024010.

According to one embodiment of this inventive aspect, the pesticidal mixtures T are ternary compositions that contain only said component (I) (tioxazafen), component (II) selected from K.1-2, K.2-2 and K.3-2, and component (III) as detailed above as active ingredients.

In Table T1, specific compositions according to this aspect of the invention are individualized. In Table T1, each row corresponds to one embodiment of this aspect of the invention, i.e. one specifically individualized composition with the name of the respective composition given in the first column of the respective row in the table (e.g. T1-3). According to one specific aspect, said compositions are ternary compositions, containing only these three components that are given in the respective row of the table as active compounds. Furthermore, also every combination of the compositions individualized in the tables represent embodiments of the present invention.

TABLE T1
Three-component compositions comprising component I (“I” =
Tioxazafen), one component (II) (“II”, selected
from K.1-2, K.2-2 and K.3-2) and one component (III) (“III”),
in particular ternary compositions containing the respective
components (I), (II) and (III) as only active ingredients.

| composition | I | II | III |
|---|---|---|---|
| T1-1 | tioxazafen | K.1-2 | F-1 |
| T1-2 | tioxazafen | K.1-2 | F-2 |
| T1-3 | tioxazafen | K.1-2 | F-3 |
| T1-4 | tioxazafen | K.1-2 | F-4 |
| T1-5 | tioxazafen | K.1-2 | F-5 |
| T1-6 | tioxazafen | K.1-2 | F-6 |
| T1-7 | tioxazafen | K.1-2 | F-7 |
| T1-8 | tioxazafen | K.1-2 | F-8 |
| T1-9 | tioxazafen | K.1-2 | F-9 |
| T1-10 | tioxazafen | K.1-2 | F-10 |
| T1-11 | tioxazafen | K.1-2 | F-11 |
| T1-12 | tioxazafen | K.1-2 | F-12 |
| T1-13 | tioxazafen | K.1-2 | F-13 |
| T1-14 | tioxazafen | K.1-2 | F-14 |
| T1-15 | tioxazafen | K.1-2 | F-15 |
| T1-16 | tioxazafen | K.1-2 | F-16 |
| T1-17 | tioxazafen | K.1-2 | F-17 |
| T1-18 | tioxazafen | K.1-2 | F-18 |
| T1-19 | tioxazafen | K.1-2 | F-19 |
| T1-20 | tioxazafen | K.1-2 | F-20 |
| T1-21 | tioxazafen | K.1-2 | F-21 |
| T1-22 | tioxazafen | K.1-2 | F-22 |
| T1-23 | tioxazafen | K.1-2 | F-23 |
| T1-24 | tioxazafen | K.1-2 | F-24 |
| T1-25 | tioxazafen | K.1-2 | F-25 |
| T1-26 | tioxazafen | K.1-2 | F-26 |
| T1-27 | tioxazafen | K.1-2 | F-27 |
| T1-28 | tioxazafen | K.1-2 | F-28 |
| T1-29 | tioxazafen | K.1-2 | F-29 |
| T1-30 | tioxazafen | K.1-2 | F-30 |
| T1-31 | tioxazafen | K.1-2 | F-31 |
| T1-32 | tioxazafen | K.1-2 | F-32 |
| T1-33 | tioxazafen | K.1-2 | F-33 |
| T1-34 | tioxazafen | K.1-2 | F-34 |
| T1-35 | tioxazafen | K.1-2 | F-35 |
| T1-36 | tioxazafen | K.1-2 | F-36 |
| T1-37 | tioxazafen | K.1-2 | In-1 |
| T1-38 | tioxazafen | K.1-2 | In-2 |
| T1-39 | tioxazafen | K.1-2 | In-3 |
| T1-40 | tioxazafen | K.1-2 | In-4 |
| T1-41 | tioxazafen | K.1-2 | In-5 |
| T1-42 | tioxazafen | K.1-2 | In-6 |
| T1-43 | tioxazafen | K.1-2 | In-7 |
| T1-44 | tioxazafen | K.1-2 | In-8 |
| T1-45 | tioxazafen | K.1-2 | In-9 |
| T1-46 | tioxazafen | K.1-2 | In-10 |
| T1-47 | tioxazafen | K.1-2 | In-11 |
| T1-48 | tioxazafen | K.1-2 | In-12 |
| T1-49 | tioxazafen | K.1-2 | In-13 |
| T1-50 | tioxazafen | K.1-2 | In-14 |
| T1-51 | tioxazafen | K.1-2 | In-15 |
| T1-52 | tioxazafen | K.1-2 | In-16 |
| T1-53 | tioxazafen | K.1-2 | In-17 |
| T1-54 | tioxazafen | K.1-2 | In-18 |
| T1-55 | tioxazafen | K.1-2 | In-19 |
| T1-56 | tioxazafen | K.1-2 | In-20 |
| T1-57 | tioxazafen | K.1-2 | In-21 |
| T1-58 | tioxazafen | K.1-2 | In-22 |
| T1-59 | tioxazafen | K.1-2 | In-23 |
| T1-60 | tioxazafen | K.1-2 | In-24 |
| T1-61 | tioxazafen | K.1-2 | In-25 |
| T1-62 | tioxazafen | K.1-2 | In-26 |
| T1-63 | tioxazafen | K.1-2 | In-27 |
| T1-64 | tioxazafen | K.1-2 | In-28 |
| T1-65 | tioxazafen | K.1-2 | In-29 |
| T1-66 | tioxazafen | K.1-2 | In-30 |
| T1-67 | tioxazafen | K.1-2 | In-31 |
| T1-68 | tioxazafen | K.1-2 | In-32 |
| T1-69 | tioxazafen | K.1-2 | In-33 |
| T1-70 | tioxazafen | K.1-2 | In-34 |
| T1-71 | tioxazafen | K.1-2 | In-35 |
| T1-72 | tioxazafen | K.2-2 | F-1 |
| T1-73 | tioxazafen | K.2-2 | F-2 |
| T1-74 | tioxazafen | K.2-2 | F-3 |
| T1-75 | tioxazafen | K.2-2 | F-4 |
| T1-76 | tioxazafen | K.2-2 | F-5 |
| T1-77 | tioxazafen | K.2-2 | F-6 |
| T1-78 | tioxazafen | K.2-2 | F-7 |
| T1-79 | tioxazafen | K.2-2 | F-8 |
| T1-80 | tioxazafen | K.2-2 | F-9 |
| T1-81 | tioxazafen | K.2-2 | F-10 |
| T1-82 | tioxazafen | K.2-2 | F-11 |
| T1-83 | tioxazafen | K.2-2 | F-12 |
| T1-84 | tioxazafen | K.2-2 | F-13 |
| T1-85 | tioxazafen | K.2-2 | F-14 |
| T1-86 | tioxazafen | K.2-2 | F-15 |
| T1-87 | tioxazafen | K.2-2 | F-16 |
| T1-88 | tioxazafen | K.2-2 | F-17 |
| T1-89 | tioxazafen | K.2-2 | F-18 |
| T1-90 | tioxazafen | K.2-2 | F-19 |
| T1-91 | tioxazafen | K.2-2 | F-20 |
| T1-92 | tioxazafen | K.2-2 | F-21 |
| T1-93 | tioxazafen | K.2-2 | F-22 |
| T1-94 | tioxazafen | K.2-2 | F-23 |
| T1-95 | tioxazafen | K.2-2 | F-24 |
| T1-96 | tioxazafen | K.2-2 | F-25 |
| T1-97 | tioxazafen | K.2-2 | F-26 |
| T1-98 | tioxazafen | K.2-2 | F-27 |
| T1-99 | tioxazafen | K.2-2 | F-28 |
| T1-100 | tioxazafen | K.2-2 | F-29 |
| T1-101 | tioxazafen | K.2-2 | F-30 |
| T1-102 | tioxazafen | K.2-2 | F-31 |
| T1-103 | tioxazafen | K.2-2 | F-32 |
| T1-104 | tioxazafen | K.2-2 | F-33 |
| T1-105 | tioxazafen | K.2-2 | F-34 |
| T1-106 | tioxazafen | K.2-2 | F-35 |
| T1-107 | tioxazafen | K.2-2 | F-36 |
| T1-108 | tioxazafen | K.2-2 | In-1 |
| T1-109 | tioxazafen | K.2-2 | In-2 |
| T1-110 | tioxazafen | K.2-2 | In-3 |
| T1-111 | tioxazafen | K.2-2 | In-4 |
| T1-112 | tioxazafen | K.2-2 | In-5 |
| T1-113 | tioxazafen | K.2-2 | In-6 |
| T1-114 | tioxazafen | K.2-2 | In-7 |
| T1-115 | tioxazafen | K.2-2 | In-8 |
| T1-116 | tioxazafen | K.2-2 | In-9 |
| T1-117 | tioxazafen | K.2-2 | In-10 |
| T1-118 | tioxazafen | K.2-2 | In-11 |
| T1-119 | tioxazafen | K.2-2 | In-12 |
| T1-120 | tioxazafen | K.2-2 | In-13 |
| T1-121 | tioxazafen | K.2-2 | In-14 |
| T1-122 | tioxazafen | K.2-2 | In-15 |
| T1-123 | tioxazafen | K.2-2 | In-16 |
| T1-124 | tioxazafen | K.2-2 | In-17 |
| T1-125 | tioxazafen | K.2-2 | In-18 |
| T1-126 | tioxazafen | K.2-2 | In-19 |
| T1-127 | tioxazafen | K.2-2 | In-20 |
| T1-128 | tioxazafen | K.2-2 | In-21 |
| T1-129 | tioxazafen | K.2-2 | In-22 |
| T1-130 | tioxazafen | K.2-2 | In-23 |
| T1-131 | tioxazafen | K.2-2 | In-24 |
| T1-132 | tioxazafen | K.2-2 | In-25 |
| T1-133 | tioxazafen | K.2-2 | In-26 |
| T1-134 | tioxazafen | K.2-2 | In-27 |
| T1-135 | tioxazafen | K.2-2 | In-28 |
| T1-136 | tioxazafen | K.2-2 | In-29 |
| T1-137 | tioxazafen | K.2-2 | In-30 |
| T1-138 | tioxazafen | K.2-2 | In-31 |
| T1-139 | tioxazafen | K.2-2 | In-32 |
| T1-140 | tioxazafen | K.2-2 | In-33 |
| T1-141 | tioxazafen | K.2-2 | In-34 |
| T1-142 | tioxazafen | K.2-2 | In-35 |
| T1-143 | tioxazafen | K.3-2 | F-1 |
| T1-144 | tioxazafen | K.3-2 | F-2 |
| T1-145 | tioxazafen | K.3-2 | F-3 |
| T1-146 | tioxazafen | K.3-2 | F-4 |
| T1-147 | tioxazafen | K.3-2 | F-5 |
| T1-148 | tioxazafen | K.3-2 | F-6 |
| T1-149 | tioxazafen | K.3-2 | F-7 |
| T1-150 | tioxazafen | K.3-2 | F-8 |
| T1-151 | tioxazafen | K.3-2 | F-9 |
| T1-152 | tioxazafen | K.3-2 | F-10 |
| T1-153 | tioxazafen | K.3-2 | F-11 |
| T1-154 | tioxazafen | K.3-2 | F-12 |
| T1-155 | tioxazafen | K.3-2 | F-13 |
| T1-156 | tioxazafen | K.3-2 | F-14 |
| T1-157 | tioxazafen | K.3-2 | F-15 |
| T1-158 | tioxazafen | K.3-2 | F-16 |
| T1-159 | tioxazafen | K.3-2 | F-17 |
| T1-160 | tioxazafen | K.3-2 | F-18 |
| T1-161 | tioxazafen | K.3-2 | F-19 |
| T1-162 | tioxazafen | K.3-2 | F-20 |
| T1-163 | tioxazafen | K.3-2 | F-21 |
| T1-164 | tioxazafen | K.3-2 | F-22 |
| T1-165 | tioxazafen | K.3-2 | F-23 |
| T1-166 | tioxazafen | K.3-2 | F-24 |
| T1-167 | tioxazafen | K.3-2 | F-25 |
| T1-168 | tioxazafen | K.3-2 | F-26 |
| T1-169 | tioxazafen | K.3-2 | F-27 |
| T1-170 | tioxazafen | K.3-2 | F-28 |
| T1-171 | tioxazafen | K.3-2 | F-29 |
| T1-172 | tioxazafen | K.3-2 | F-30 |
| T1-173 | tioxazafen | K.3-2 | F-31 |
| T1-174 | tioxazafen | K.3-2 | F-32 |
| T1-175 | tioxazafen | K.3-2 | F-33 |
| T1-176 | tioxazafen | K.3-2 | F-34 |
| T1-177 | tioxazafen | K.3-2 | F-35 |
| T1-178 | tioxazafen | K.3-2 | F-36 |
| T1-179 | tioxazafen | K.3-2 | In-1 |
| T1-180 | tioxazafen | K.3-2 | In-2 |
| T1-181 | tioxazafen | K.3-2 | In-3 |
| T1-182 | tioxazafen | K.3-2 | In-4 |
| T1-183 | tioxazafen | K.3-2 | In-5 |
| T1-184 | tioxazafen | K.3-2 | In-6 |
| T1-185 | tioxazafen | K.3-2 | In-7 |
| T1-186 | tioxazafen | K.3-2 | In-8 |
| T1-187 | tioxazafen | K.3-2 | In-9 |
| T1-188 | tioxazafen | K.3-2 | In-10 |
| T1-189 | tioxazafen | K.3-2 | In-11 |
| T1-190 | tioxazafen | K.3-2 | In-12 |
| T1-191 | tioxazafen | K.3-2 | In-13 |
| T1-192 | tioxazafen | K.3-2 | In-14 |
| T1-193 | tioxazafen | K.3-2 | In-15 |
| T1-194 | tioxazafen | K.3-2 | In-16 |
| T1-195 | tioxazafen | K.3-2 | In-17 |
| T1-196 | tioxazafen | K.3-2 | In-18 |
| T1-197 | tioxazafen | K.3-2 | In-19 |
| T1-198 | tioxazafen | K.3-2 | In-20 |
| T1-199 | tioxazafen | K.3-2 | In-21 |
| T1-200 | tioxazafen | K.3-2 | In-22 |
| T1-201 | tioxazafen | K.3-2 | In-23 |
| T1-202 | tioxazafen | K.3-2 | In-24 |
| T1-203 | tioxazafen | K.3-2 | In-25 |
| T1-204 | tioxazafen | K.3-2 | In-26 |
| T1-205 | tioxazafen | K.3-2 | In-27 |
| T1-206 | tioxazafen | K.3-2 | In-28 |
| T1-207 | tioxazafen | K.3-2 | In-29 |
| T1-208 | tioxazafen | K.3-2 | In-30 |
| T1-209 | tioxazafen | K.3-2 | In-31 |
| T1-210 | tioxazafen | K.3-2 | In-32 |
| T1-211 | tioxazafen | K.3-2 | In-33 |
| T1-212 | tioxazafen | K.3-2 | In-34 |
| T1-213 | tioxazafen | K.3-2 | In-35 |

In these inventive three-component-compositions T1-1 to T1-213, the weight ratio of component (I) to component (II) depends on the properties of the active compounds in question and may particularly be 1000:1 to 1:1000, specifically 500:1 to 1:500. Preferably, it is in the range of from 1:100 to 100:1, preferably in the range of from 1:50 to 50:1 and in particular in the range of from 1:20 to 20:1. It may be preferable for the weight ratio to be in the region of from 1:10 to 10:1, preferably from 1:3 to 3:1, in particular from 1:2 to 2:1. The weight ratio of component (I) to the component (III) may particularly be 1000:1 to 1:1000, specifically 500:1 to 1:500. It is preferably in the range of from 1:100 to 100:1, preferably in the range of from 1:50 to 50:1 and in particular in the range of from 1:20 to 20:1. It may be preferable for the weight ratio to be in the region of from 1:10 to 10:1, preferably from 1:3 to 3:1, in particular from 1:2 to 2:1. The weight ratio of component (II) to component (III) is preferably in the range of from 1:100 to 100:1, frequently in the range of from 1:50 to 50:1, preferably in the range of from 1:20 to 20:1, and in particular in the range of from 1:10 to 10:1. It may be preferable for the weight to be in the range of from 1:3 to 3:1, in particular from 1:2 to 2:1.

In the mixtures and compositions, the compound ratios of the active ingredients are advantageously chosen so as to produce a synergistic effect.

The invention also provides pesticidal compositions, comprising a liquid and/or solid carrier and an inventive composition.

The component(s) (I), component(s) (II), component(s) (III), component(s) (IV) and component(s) (V) of pesticidal mixtures A, B, C, D, E, F, G, H, I, J, I.1, I.2, I.3, J.1, J.2, J.3, J.4, and T are understood to include their stereoisomers, salts, tautomers, racemic mixtures, individual pure enantiomers and diastereomers and their optically active mixtures or N-oxides, or a polymorphic crystalline form, a co-crystal or a solvate of a compound or a stereoisomer, salt, tautomer or N-oxide thereof.

Salts of the compounds of the present invention are preferably agriculturally and veterinarily acceptable salts. They can be formed in a customary method, e.g. by reacting the compound with an acid if the compound of the present invention has a basic functionality or by reacting the compound with a suitable base if the compound of the present invention has an acidic functionality.

In general, suitable “agriculturally useful salts” or “agriculturally acceptable salts” are especially the salts of those cations or the acid addition salts of those acids whose cations and anions, respectively, do not have any adverse effect on the action of the compounds according to the present invention. Suitable cations are in particular the ions of the alkali metals, preferably lithium, sodium and potassium, of the alkaline earth metals, preferably calcium, magnesium and barium, and of the transition metals, preferably manganese, copper, zinc and iron, and also ammonium (NH₄⁺) and substituted ammonium in which one to four of the hydrogen atoms are replaced by C₁-C₄-alkyl, C₁-C₄-hydroxyalkyl, C₁-C₄-alkoxy, C₁-C₄-alkoxy-C₁-C₄-alkyl, hydroxy-C₁-C₄-alkoxy-C₁-C₄-alkyl, phenyl or benzyl. Examples of substituted ammonium ions comprise methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)ethyl-ammonium, bis(2-hydroxyethyl)ammonium, benzyltrimethylammonium and benzyltriethylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogen sulfate, sulfate, dihydrogen phosphate, hydrogen phosphate, phosphate, nitrate, hydrogen carbonate, carbonate, hexafluorosilicate, hexafluorophosphate, benzoate, and the anions of C₁-C₄-alkanoic acids, preferably formate, acetate, propionate and butyrate. They can be formed by reacting the compounds The component(s) (I), component(s) (II), component(s) (III), component(s) (IV) and component(s) (V) of pesticidal mixtures A, B, C, D, E, F, G, H, I, J, I.1, I.2, I.3, J.1, J.2, J.3, J.4, and T with an acid of the corresponding anion, preferably of hydrochloric acid, hydrobromic acid, sulfuric acid, phosphoric acid or nitric acid.

Preferred component(s) (I), component(s) (II), component(s) (III), component(s) (IV) and component(s) (V) of the present invention are component(s) (I), component(s) (II), component(s) (III), component(s) (IV) and component(s) (V) of pesticidal mixtures A, B, C, D, E, F, G, H, I, J, I.1, I.2, I.3, J.1, J.2, J.3, J.4, and T or a stereoisomer, N-oxide or salt thereof, wherein the salt is an agriculturally or veterinarily acceptable salt.

The component(s) (I), component(s) (II), component(s) (III), component(s) (IV) and component(s) (V) of pesticidal mixtures A, B, C, D, E, F, G, H, I, J, I.1, I.2, I.3, J.1, J.2, J.3, J.4, and T may be present in the form of their N-oxides. The term “N-oxide” includes any compound of the present invention which has at least one tertiary nitrogen atom that is oxidized to an N-oxide moiety. N-oxides of compounds of the present invention can in particular be prepared by oxidizing the ring nitrogen atom(s) of the pyridine ring and/or the pyrazole ring with a suitable oxidizing agent, such as peroxo carboxylic acids or other peroxides. The person skilled in the art knows if and in which positions in component(s) (I), component(s) (II), component(s) (III), component(s) (IV) and component(s) (V) may form N-oxides.

The component(s) (I), component(s) (II), component(s) (III), component(s) (IV) and component(s) (V) of the present invention may be amorphous or may exist in one ore more different crystalline states (polymorphs) which may have different macroscopic properties such as stability or show different biological properties such as activities. The present invention includes both amorphous and crystalline compounds of component (I) and component(s) (II), their enantiomers or diastereomers, mixtures of different crystalline states of the respective component (I) and component(s) (II), their enantiomers or diastereomers, as well as amorphous or crystalline salts thereof.

The term “co-crystal” denotes a complex of at least component (I) and component(s) (II) of the present invention or a stereoisomer, salt, tautomer or N-oxide thereof, with one or more other molecules (preferably one molecule type), wherein usually the ratio of the compound according to the invention and the other molecule is a stoichiometric ratio.

The term “solvate” denotes a co-complex of the compounds of the present invention, or a stereoisomer, salt, tautomer or N-oxide thereof, with solvent molecules. The solvent is usually liquid. Examples of solvents are methanol, ethanol, toluol, xylol. A preferred solvent which forms solvates is water, which solvates are referred to as “hydrates”. A solvate or hydrate is usually characterized by the presence of a fixed number of n molecules solvent per m molecules compound according to the invention.

### Pests

The mixtures according to the invention are in particular suitable for efficiently controlling arthropodal pests such as arachnids, myriapedes and insects as well as nematodes. The mixtures according to the invention are especially suitable for efficiently combating the following pests:

insects from the order of the lepidopterans (Lepidoptera), for example Acronicta major, Adoxophyes orana, Aedia leucomelas, Agrotis spp. such as Agrotis fucosa, Agrotis segetum, Agrotis ipsilon; Alabama argillacea, Anticarsia gemmatalis, Anticarsia spp., Argyresthia conjugella, Autographa gamma, Barathra brassicae, Bucculatrix thurberiella, Bupalus piniarius, Cacoecia murinana, Cacoecia podana, Capua reticulana, Carpocapsa pomonella, Cheimatobia brumata, Chilo spp. such as Chilo suppressalis; Choristoneura fumiferana, Choristoneura occidentalis, Cirphis unipuncta, Clysia ambiguella, Cnaphalocerus spp., Cydia pomonella, Dendrolimus pini, Diaphania nitidalis, Diatraea grandiosella, Earias insulana, Elasmopalpus lignosellus, Ephestia cautella, Ephestia kuehniella, Eupoecilia ambiguella, Euproctis chrysorrhoea, Euxoa spp., Evetria bouliana, Feltia spp. such as Feltia subterranean; Galleria mellonella, Grapholitha funebrana, Grapholitha molesta, Helicoverpa spp. such as Helicoverpa armigera, Helicoverpa zea; Heliothis spp. such as Heliothis armigera, Heliothis virescens, Heliothis zea; Hellula undalis, Hibernia defoliaria, Hofmannophila pseudospretella, Homona magnanima, Hyphantria cunea, Hyponomeuta padella, Hyponomeuta malinellus, Keiferia lycopersicella, Lambdina fiscellaria, Laphygma spp. such as Laphygma exigua; Leucoptera coffeella, Leucoptera scitella, Lithocolletis blancardella, Lithophane antennata, Lobesia botrana, Loxagrotis albicosta, Loxostege sticticalis, Lymantria spp. such as Lymantria dispar, Lymantria monacha; Lyonetia clerkella, Malacosoma neustria, Mamestra spp. such as Mamestra brassicae; Mocis repanda, Mythimna separata, Orgyia pseudotsugata, Oria spp., Ostrinia spp. such as Ostrinia nubilalis; Oulema oryzae, Panolis flammea, Pectinophora spp. such as Pectinophora gossypiella; Peridroma saucia, Phalera bucephala, Phthorimaea spp. such as Phthorimaea operculella; Phyllocnistis citrella, Pieris spp. such as Pieris brassicae, Pieris rapae; Plathypena scabra, Plutella maculipennis, Plutella xylostella, Prodenia spp., Pseudaletia spp., Pseudoplusia indudens, Pyrausta nubilalis, Rhyacionia frustrana, Scrobipalpula absoluta, Sitotroga cerealella, Sparganothis pilleriana, Spodoptera spp. such as Spodoptera frugiperda, Spodoptera littoralis, Spodoptera litura; Thaumatopoea pityocampa, Thermesia gemmatalis, Tinea pellionella, Tineola bisselliella, Tortrix viridana, Trichoplusia spp. such as Trichoplusia ni; Tuta absoluta, and Zeiraphera canadensis,

beetles (Coleoptera), for example Acanthoscehdes obtectus, Adoretus spp., Agelastica alni, Agrilus sinuatus, Agriotes spp. such as Agriotes fuscicollis, Agriotes lineatus, Agriotes obscurus; Amphimallus solstitialis, Anisandrus dispar, Anobium punctatum, Anomala rufocuprea, Anoplophora spp. such as Anoplophora glabripennis; Anthonomus spp. such as Anthonomus grandis, Anthonomus pomorum; Anthrenus spp., Aphthona euphoridae, Apogonia spp., Athous haemorrhoidalis, Atomaria spp. such as Atomaria linearis; Attagenus spp., Aulacophora femoralis, Blastophagus piniperda, Blitophaga undata, Bruchidius obtectus, Bruchus spp. such as Bruchus lentis, Bruchus pisorum, Bruchus rufimanus; Byctiscus betulae, Callosobruchus chinensis, Cassida nebulosa, Cerotoma trifurcata, Cetonia aurata, Ceuthorhynchus spp. such as Ceuthorrhynchus assimilis, Ceuthorrhynchus napi; Chaetocnema tibialis, Cleonus mendicus, Conoderus spp. such as Conoderus vespertinus; Cosmopolites spp., Costelytra zealandica, Crioceris asparagi, Cryptorhynchus lapathi, Ctenicera ssp. such as Ctenicera destructor; Curculio spp., Dectes texanus, Dermestes spp., Diabrotica spp. such as Diabrotica 12-punctata Diabrotica speciosa, Diabrotica longicomis, Diabrotica semipunctata, Diabrotica virgifera; Epilachna spp. such as Epilachna varivestis, Epilachna vigintioctomaculata; Epitrix spp. such as Epitrix hirtipennis; Eutinobothrus brasiliensis, Faustinus cubae, Gibbium psylloides, Heteronychus arator, Hylamorpha elegans, Hylobius abietis, Hylotrupes bajulus, Hypera brunneipennis, Hypera postica, Hypothenemus spp., Ips typographus, Lachnosterna consanguinea, Lema bilineata, Lema melanopus, Leptinotarsa spp. such as Leptinotarsa decemlineata; Limonius califomicus, Lissorhoptrus oryzophilus, Lissorhoptrus oryzophilus, Lixus spp., Lyctus spp. such as Lyctus bruneus; Melanotus communis, Meligethes spp. such as Meligethes aeneus; Melolontha hippocastani, Melolontha melolontha, Migdolus spp., Monochamus spp. such as Monochamus altematus; Naupactus xanthographus, Niptus hololeucus, Oryctes rhinoceros, Oryzaephilus surinamensis, Otiorrhynchus sulcatus, Otiorrhynchus ovatus, Otiorrhynchus sulcatus, Oulema oryzae, Oxycetonia jucunda, Phaedon cochleariae, Phyllobius pyri, Phyllopertha horticola, Phyllophaga spp., Phyllotreta spp. such as Phyllotreta chrysocephala, Phyllotreta nemorum, Phyllotreta striolata; Phyllophaga spp., Phyllopertha horticola, Popiffia japonica, Premnotrypes spp., Psylliodes chrysocephala, Ptinus spp., Rhizobius ventralis, Rhizopertha dominica, Sitona lineatus, Sitophilus spp. such as Sitophilus granaria, Sitophilus zeamais; Sphenophorus spp. such as Sphenophorus levis; Sternechus spp. such as Sternechus subsignatus; Symphyletes spp., Tenebrio molitor, Tribolium spp. such as Tribolium castaneum; Trogoderma spp., Tychius spp., Xylotrechus spp., and Zabrus spp. such as Zabrus tenebrioides,

flies, mosquitoes (Diptera), e.g. Aedes spp. such as Aedes aegypti, Aedes albopictus, Aedes vexans; Anastrepha ludens, Anopheles spp. such as Anopheles albimanus, Anopheles crucians, Anopheles freeborni, Anopheles gambiae, Anopheles leucosphyrus, Anopheles maculipennis, Anopheles minimus, Anopheles quadrimaculatus, Anopheles sinensis; Bibio hortulanus, Calliphora erythrocephala, Calliphora vicina, Cerafitis capitata, Ceratitis capitata, Chrysomyia spp. such as Chrysomya bezziana, Chrysomya hominivorax, Chrysomya macellaria; Chrysops atlanticus, Chrysops discalis, Chrysops silacea, Cochliomyia spp. such as Cochliomyia hominivorax; Contarinia spp. such as Contarinia sorghicola; Cordylobia anthropophaga, Culex spp. such as Culex nigripalpus, Culex pipiens, Culex quinquefasciatus, Culex tarsalis, Culex tritaeniorhynchus; Culicoides furens, Culiseta inornata, Culiseta melanura, Cuterebra spp., Dacus cucurbitae, Dacus oleae, Dasineura brassicae, Delia spp. such as Delia antique, Delia coarctata, Delia platura, Delia radicum; Dermatobia hominis, Drosophila spp., Fannia spp. such as Fannia canicularis; Gastraphilus spp. such as Gasterophilus intestinalis; Geomyza Tripunctata, Glossina fuscipes, Glossina morsitans, Glossina palpalis, Glossina tachinoides, Haematobia irritans, Haplodiplosis equestris, Hippelates spp., Hylemyia spp. such as Hylemyia platura; Hypoderma spp. such as Hypoderma lineata; Hyppobosca spp., Leptoconops torrens, Liriomyza spp. such as Liriomyza sativae, Liriomyza trifolii; Lucilia spp. such as Lucilia caprina, Lucilia cuprina, Lucilia sericata; Lycoria pectoralis, Mansonia titillanus, Mayetiola spp. such as Mayetiola destructor; Musca spp. such as Musca autumnalis, Musca domestica; Muscina stabulans, Oestrus spp. such as Oestrus ovis; Opomyza forum, Oscinella spp. such as Oscinella frit; Pegomya hysocyami, Phlebotomus argentipes, Phorbia spp. such as Phorbia antiqua, Phorbia brassicae, Phorbia coarctata; Prosimulium mixtum, Psila rosae, Psorophora columbiae, Psorophora discolor, Rhagoletis cerasi, Rhagoletis pomonella, Sarcophaga spp. such as Sarcophaga haemorrhoidalis; Simulium vittatum, Stomoxys spp. such as Stomoxys calcitrans; Tabanus spp. such as Tabanus atratus, Tabanus bovinus, Tabanus lineola, Tabanus similis; Tannia spp., Tipula oleracea, Tipula paludosa, and Wohlfahrtia spp.,

thrips (Thysanoptera), e.g. Baliothrips biformis, Dichromothrips corbetti, Dichromothrips ssp., Enneothrips flavens, Frankliniella spp. such as Frankliniella fusca, Frankliniella occidentalis, Frankliniella tritici; Heliothrips spp., Hercinothrips femoralis, Kakothrips spp., Rhipiphorothrips cruentatus, Scirtothrips spp. such as Scirtothrips citri; Taeniothrips cardamoni, Thrips spp. such as Thrips oryzae, Thrips palmi, Thrips tabaci;

termites (Isoptera), e.g. Calotermes flavicollis, Coptotermes formosanus, Heterotermes aureus, Heterotermes longiceps, Heterotermes tenuis, Leucotermes flavipes, Odontotermes spp., Reticulitermes spp. such as Reticulitermes speratus, Reticulitermes flavipes, Reticulitermes grassei, Reticulitermes lucifugus, Reticulitermes santonensis, Reticulitermes virginicus; Termes natalensis,

cockroaches (Blattaria—Blattodea), e.g. Acheta domesticus, Blatta orientalis, Blattella asahinae, Blattella germanica, Gryllotalpa spp., Leucophaea maderae, Locusta spp., Melanoplus spp., Periplaneta americana, Periplaneta australasiae, Periplaneta brunnea, Periplaneta fuligginosa, Periplaneta japonica,

bugs, aphids, leafhoppers, whiteflies, scale insects, cicadas (Hemiptera), e.g. Acrosternum spp. such as Acrosternum hilare; Acyrthosipon spp. such as Acyrthosiphon onobrychis, Acyrthosiphon pisum; Adelges laricis, Aeneolamia spp., Agonoscena spp., Aleurodes spp., Aleurolobus barodensis, Aleurothrixus spp., Amrasca spp., Anasa tristis, Antestiopsis spp., Anuraphis cardui, Aonidiella spp., Aphanostigma piri, Aphidula nasturtii, Aphis spp. such as Aphis fabae, Aphis forbesi, Aphis gossypii, Aphis grossulariae, Aphis pomi, Aphis sambuci, Aphis schneideri, Aphis spiraecola; Arboridia apicalis, Arilus critatus, Aspidiella spp., Aspidiotus spp., Atanus spp., Aulacorthum solani, Bemisia spp. such as Bemisia argentifolii, Bemisia tabaci; Blissus spp. such as Blissus leucopterus; Brachycaudus cardui, Brachycaudus helichrysi, Brachycaudus persicae, Brachycaudus prunicola, Brachycolus spp., Brevicoryne brassicae, Calligypona marginata, Calocoris spp., Campylomma livida, Capitophorus horni, Carneocephala fulgida, Cavelerius spp., Ceraplastes spp., Ceratovacuna lanigera, Cercopidae, Cerosipha gossypii, Chaetosiphon fragaefolii, Chionaspis tegalensis, Chlorita Chromaphis juglandicola, Chrysomphalus ficus, Cicadulina mbila, Cimex spp. such as Cimex hemipterus, Cimex lectularius; Coccomytilus haffi, Coccus spp., Creontiades dilutus, Cryptomyzus ribis, Cryptomyzus ribis, Cyrtopeltis notatus, Dalbulus spp., Dasynus piperis, Dialeurades spp., Diaphorina spp., Diaspis spp., Dichelops furcatus, Diconocoris hewetti, Doralis spp., Dreyfusia nordmannianae, Dreyfusia piceae, Drosicha spp., Dysaphis spp. such as Dysaphis plantaginea, Dysaphis pyri, Dysaphis radicola; Dysaulacorthum pseudosolani, Dysdercus spp. such as Dysdercus cingulatus, Dysdercus intermedius; Dysmicoccus spp., Empoasca spp. such as Empoasca fabae, Empoasca solana; Eriosoma spp., Erythroneura spp., Eurygaster spp. such as Eurygaster integriceps; Euscelis bilobatus, Euschistus spp. such as Euschistuos heros, Euschistus impictiventris, Euschistus servus; Geococcus coffeae, Halyomorpha spp. such as Halyomorpha halys; Heliopeltis spp., Homalodisca coagulata, Horcias nobilellus, Hyalopterus pruni, Hyperomyzus lactucae, Icerya spp., Idiocerus spp., Idioscopus spp., Laodelphax striatefius, Lecanium spp., Lepidosaphes spp., Leptocorisa spp., Leptoglossus phyllopus, Lipaphis erysimi, Lygus spp. such as Lygus hesperus, Lygus lineolaris, Lygus pratensis; Macropes excavatus, Macrosiphum spp. such as Macrosiphum rosae, Macrosiphum avenae, Macrosiphum euphorbiae; Mahanarva fimbriolata, Megacopta cribraria, Megoura viciae, Melanaphis pyrarius, Melanaphis sacchari, Metcafiella spp., Metopolophium dirhodum, Miridae spp., Monellia costalis, Moneffiopsis pecanis, Myzus spp. such as Myzus ascalonicus, Myzus cerasi, Myzus persicae, Myzus varians; Nasonovia ribis-nigri, Nephotettix spp. such as Nephotettix malayanus, Nephotettix nigropictus, Nephotettix parvus, Nephotettix virescens; Nezara spp. such as Nezara viridula; Nilaparvata lugens, Oebalus spp., Oncometopia spp., Orthezia praelonga, Parabemisia myricae, Paratrioza spp., Parlatoria spp., Pemphigus spp. such as Pemphigus bursarius; Pentomidae, Peregrinus maidis, Perkinsiella saccharicida, Phenacoccus spp., Phloeomyzus passerinii, Phorodon humuli, Phylloxera spp., Piesma quadrata, Piezodorus spp. such as Piezodorus guildinii, Pinnaspis aspidistrae, Planococcus spp., Protopulvinaria pyriformis, Psallus seriatus, Pseudacysta persea, Pseudaulacaspis pentagona, Pseudococcus spp. such as Pseudococcus comstocki; Psylla spp. such as Psylla mali, Psylla pin; Pteromalus spp., Pyrilla spp., Quadraspidiotus spp., Quesada gigas, Rastrococcus spp., Reduvius senilis, Rhodnius spp., Rhopalomyzus ascalonicus, Rhopalosiphum spp. such as Rhopalosiphum pseudobrassicas, Rhopalosiphum insertum, Rhopalosiphum maidis, Rhopalosiphum padi; Sagatodes spp., Sahlbergella singularis, Saissetia spp., Sappaphis mala, Sappaphis mali, Scaphoides titanus, Schizaphis graminum, Schizoneura lanuginosa, Scotinophora spp., Selenaspidus articulatus, Sitobion avenae, Sogata spp., Sogatella furcifera, Solubea insularis, Stephanitis nashi, Stictocephala festina, Tenalaphara malayensis, Thyanta spp. such as Thyanta perditor; Tibraca spp., Tinocallis caryaefoliae, Tomaspis spp., Toxoptera spp. such as Toxoptera aurantii; Trialeurodes spp. such as Trialeurodes vaporariorum; Triatoma spp., Trioza spp., Typhlocyba spp., Unaspis spp. such as Unaspis yanonensis; and Viteus vitifolii,

ants, bees, wasps, sawflies (Hymenoptera), e.g. Athalia rosae, Atta capiguara, Atta cephalotes, Atta cephalotes, Atta laevigata, Atta robusta, Atta sexdens, Atta texana, Bombus spp., Camponotus floridanus, Crematogaster spp., Dasymutilla occidentalis, Diprion spp., Dolichovespula maculata, Hoplocampa spp. such as Hoplocampa minuta, Hoplocampa testudinea; Lasius spp. such as Lasius niger, Linepithema humile, Monomorium pharaonis, Paravespula germanica, Paravespula pennsylvanica, Paravespula vulgaris, Pheidole megacephala, Pogonomyrmex barbatus, Pogonomyrmex califomicus, Polistes rubiginosa, Solenopsis geminata, Solenopsis invicta, Solenopsis richteri, Solenopsis xyloni, Vespa spp. such as Vespa crabro, and Vespula squamosa,

crickets, grasshoppers, locusts (Orthoptera), e.g. Acheta domestica, Calliptamus italicus, Chortoicetes terminifera, Dociostaurus maroccanus, Gryllotalpa africana, Gryllotalpa gryllotalpa, Hieroglyphus daganensis, Kraussaria angulifera, Locusta migratoria, Locustana pardalina, Melanoplus bivittatus, Melanoplus femurrubrum, Melanoplus mexicanus, Melanoplus sanguinipes, Melanoplus spretus, Nomadacris septemfasciata, Oedaleus senegalensis, Schistocerca americana, Schistocerca gregaria, Tachycines asynamorus, and Zonozerus variegatus,

arachnids (Arachnida), such as acari, e.g. of the families Argasidae, Ixodidae and Sarcoptidae, such as Amblyomma spp. (e.g. Amblyomma americanum, Amblyomma variegatum, Amblyomma maculatum), Argas spp. (e.g. Argas persicus), Boophilus spp. (e.g. Boophilus annulatus, Boophilus decoloratus, Boophilus microplus), Dermacentor silvarum, Dermacentor andersoni, Dermacentor variabilis, Hyalomma spp. (e.g. Hyalomma truncatum), Ixodes spp. (e.g. Ixodes ricinus, Ixodes rubicundus, Ixodes scapularis, Ixodes holocyclus, Ixodes pacificus), Ornithodorus spp. (e.g. Ornithodorus moubata, Ornithodorus hermsi, Ornithodorus turicata), Ornithonyssus bacoti, Otobius megnini, Dermanyssus gallinae, Psoroptes spp. (e.g. Psoroptes ovis), Rhipicephalus spp. (e.g. Rhipicephalus sanguineus, Rhipicephalus appendiculatus, Rhipicephalus evertsi), Rhizoglyphus spp., Sarcoptes spp. (e.g. Sarcoptes scabiei), and Eriophyidae spp. such as Acaria sheldoni, Aculops spp. (e.g. Aculops pelekass) Aculus spp. (e.g. Aculus schlechtendali), Epitrimerus pyri, Phyllocoptruta oleivora and Eriophyes spp. (e.g. Eriophyes sheldoni); Tarsonemidae spp. such as Hemitarsonemus spp., Phytonemus pallidus and Polyphagotarsonemus latus, Stenotarsonemus spp.; Tenuipalpidae spp. such as Brevipalpus spp. (e.g. Brevipalpus phoenicis); Tetranychidae spp. such as Eotetranychus spp., Eutetranychus spp., Oligonychus spp., Tetranychus cinnabarinus, Tetranychus kanzawai, Tetranychus pacificus, Tetranychus telarius and Tetranychus urticae; Bryobia praetiosa, Panonychus spp. (e.g. Panonychus ulmi, Panonychus citri), Metatetranychus spp. and Oligonychus spp. (e.g. Oligonychus pratensis), Vasates lycopersici; Araneida, e.g. Latrodectus mactans, and Loxosceles reclusa. And Acarus siro, Chorioptes spp., Scorpio maurus

fleas (Siphonaptera), e.g. Ceratophyllus spp., Ctenocephalides felis, Ctenocephalides canis, Xenopsylla cheopis, Pulex irritans, Tunga penetrans, and Nosopsyllus fasciatus,

silverfish, firebrat (Thysanura), e.g. Lepisma saccharina and Thermobia domestica,

centipedes (Chilopoda), e.g. Geophilus spp., Scutigera spp. such as Scutigera coleoptrata;

millipedes (Diplopoda), e.g. Blaniulus guttulatus, Narceus spp.,

Earwigs (Dermaptera), e.g. forficula auricularia,

lice (Phthiraptera), e.g. Damalinia spp., Pediculus spp. such as Pediculus humanus capitis, Pediculus humanus corporis; Pthirus pubis, Haematopinus spp. such as Haematopinus eurysternus, Haematopinus suis; Linognathus spp. such as Linognathus vituli; Bovicola bovis, Menopon gallinae, Menacanthus stramineus and Solenopotes capillatus, Trichodectes spp.,

springtails (Collembola), e.g. Onychiurus ssp. such as Onychiurus armatus,

They are also suitable for controlling nematodes: plant parasitic nematodes such as root knot nematodes, Meloidogyne hapla, Meloidogyne incognita, Meloidogyne javanica, and other Meloidogyne species; cyst-forming nematodes, Globodera rostochiensis and other Globodera species; Heterodera avenee, Heterodera glycines, Heterodera schachtii, Heterodera trifolii, and other Heterodera species; Seed gall nematodes, Anguina species; Stem and foliar nematodes, Aphelenchoides species such as Aphelenchoides besseyi; Sting nematodes, Belonolaimus longicaudatus and other Belonolaimus species; Pine nematodes, Bursaphelenchus lignicolus Mamiya et Kiyohara, Bursaphelenchus xylophilus and other Bursaphelenchus species; Ring nematodes, Criconema species, Criconemella species, Criconemoides species, Mesocriconema species; Stem and bulb nematodes, Ditylenchus destructor, Ditylenchus dipsaci and other Ditylenchus species; Awl nematodes, Dolichodorus species; Spiral nematodes, Heliocotylenchus multicinctus and other Helicotylenchus species; Sheath and sheathoid nematodes, Hemicycliophora species and Hemicriconemoides species; Hirshmanniella species; Lance nematodes, Hoploaimus species; false rootknot nematodes, Nacobbus species; Needle nematodes, Longidorus elongatus and other Longidorus species; Lesion nematodes, Pratylenchus brachyurus, Pratylenchus neglectus, Pratylenchus penetrans, Pratylenchus curvitatus, Pratylenchus goodeyi and other Pratylenchus species; Burrowing nematodes, Radopholus similis and other Radopholus species; Reniform nematodes, Rotylenchus robustus, Rotylenchus reniformis and other Rotylenchus species; Scutellonema species; Stubby root nematodes, Trichodorus primitivus and other Trichodorus species, Paratrichodorus species; Stunt nematodes, Tylenchorhynchus claytoni, Tylenchorhynchus dubius and other Tylenchorhynchus species; Citrus nematodes, Tylenchulus species such as Tylenchulus semipenetrans; Dagger nematodes, Xiphinema species; and other plant parasitic nematode species.

Examples of further pest species which may be controlled by pesticidal mixtures of the invention include: from the class of the Bivalve, for example, Dreissena spp.; from the class of the Gastropoda, for example, Arion spp., Biomphalaria spp., Bulinus spp., Deroceras spp., Galbe spp., Lymnaea spp., Oncomelania spp., Succinea spp.; from the class of the helminths, for example, Ancylostoma duodenale, Ancylostoma ceylanicum, Acylostoma braziliensis, Ancylostoma spp., Ascaris lumbricoides, Ascaris spp., Brugia malayi, Brugia timori, Bunostomum spp., Chabertia spp., Clonorchis spp., Cooperia spp., Dicrocoelium spp., Dictyocaulus filaria, Diphyllobothrium latum, Dracunculus medinensis, Echinococcus granulosus, Echinococcus multilocularis, Enterobius vermicularis, Faciola spp., Haemonchus spp. such as Haemonchus contortus; Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercora lis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichiura, Wuchereria bancrofti; from the order of the Isopoda, for example, Armadillidium vulgare, Oniscus asellus, Porcellio scaber; from the order of the Symphyla, for example, Scutigerella immaculate.

Further examples of pest species which may be controlled by pesticidal mixtures of the invention include: Anisoplia austriaca, Apamea spp., Austroasca viridigrisea, Baliothrips biformis, Caenorhabditis elegans, Cephus spp., Ceutorhynchus napi, Chaetocnema aridula, Chilo auricilius, Chilo indicus, Chilo polychrysus, Chortiocetes terminifera, Cnaphalocroci medinalis, Cnaphalocrosis spp., Colias eurytheme, Collops spp., Cornitermes cumulans, Creontiades spp., Cyclocephala spp., Dalbulus maidis, Deraceras reticulatum, Diatrea saccharalis, Dichelops furcatus, Dicladispa armigera, Diloboderus spp. such as Diloboderus abderus; Edessa spp., Epinotia spp., Formicidae, Geocoris spp., Globitermes sulfureus, Gryllotalpidae, Halotydeus destructor, Hipnodes bicolor, Hydrellia philippina, Julus spp., Laodelphax spp., Leptocorsia acuta, Leptocorsia oratorius, Lyogenys fuscus, Luciffia spp., Lyogenys fuscus, Mahanarva spp., Maladera matrida, Marasmia spp., Mastotermes spp., Mealybugs, Megascelis ssp, Metamasius hemipterus, Microtheca spp., Mocis latipes, Murgantia spp., Mythemina separata, Neocapritermes opacus, Neocapritermes parvus, Neomegalotomus spp., Neotermes spp., Nymphula depunctalis, Oebalus pugnax, Orseolia spp. such as Orseolia oryzae; Oxycaraenus hyalinipennis, Plusia spp., Pomacea canaliculata, Procornitermes ssp, Procornitermes triacifer, Psylloides spp., Rachiplusia spp., Rhodopholus spp., Scaptocoris castanea, Scaptocoris spp., Scirpophaga spp. such as Scirpophaga incertulas, Scirpophaga innotata; Scotinophara spp. such as Scotinophara coarctata; Sesamia spp. such as Sesamia inferens, Sogaella frucifera, Solenapsis geminata, Spissistilus spp., Stalk borer, Stenchaetothrips biformis, Steneotarsonemus spinki, Sylepta derogata, Telehin licus, Trichostrongylus spp.

The pesticidal mixtures of the present invention are particularly useful for controlling insects, preferably sucking or piercing insects such as insects from the genera Thysanoptera, Diptera and Hemiptera, and chewing-biting pests such as insects from the genera of Lepidoptera and Coleoptera, in particular the following species: Thysanoptera: Frankliniella fusca, Frankliniella occidentalis, Frankliniella tritici, Scirtothrips citri, Thrips oryzae, Thrips palmi and Thrips tabaci, Diptera, e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Ceratitis capitata, Chrysomya bezziana, Chrysomya hominivorax, Chrysomya macellaria, Chrysops discalis, Chrysops silacea, Chrysops atlanticus, Cochliomyia hominivorax, Contarinia sorghicola Cordylobia anthropophaga, Culicoides furens, Culex pipiens, Culex nigripalpus, Culex quinquefasciatus, Culex tarsalis, Culiseta inornata, Culiseta melanura, Dacus cucurbitae, Dacus oleae, Dasineura brassicae, Delia antique, Delia coarctata, Delia platura, Delia radicum, Dermatobia hominis, Fannia canicularis, Geomyza Tripunctata, Gasterophilus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia caprina, Lucilia cuprina, Lucilia sericata, Lycoria pectoralis, Mansonia titillanus, Mayetiola destructor, Musca autumnalis, Musca domestica, Muscina stabulans, Oestrus ovis, Opomyza forum, Oscinella frit, Pegomya hysocyami, Phorbia antiqua, Phorbia brassicae, Phorbia coarctata, Phlebotomus argentipes, Psorophora columbiae, Psila rosae, Psorophora discolor, Prosimulium mixtum, Rhagoletis cerasi, Rhagoletis pomonella, Sarcophaga haemorrhoidalis, Sarcophaga spp., Simulium vittatum, Stomoxys calcitrans, Tabanus bovinus, Tabanus atratus, Tabanus lineola, and Tabanus similis, Tipula oleracea, and Tipula paludosa;

Hemiptera, in particular aphids: Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mall, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, and Viteus vitifolii.

Lepidoptera, in particular: Agrotis ipsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis.

The pesticidal mixtures of the present invention are particularly useful for controlling insects from the order of Coleoptera, in particular Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcate, Cetonia aurata, Ceuthorrhynchus assimilis, Ceuthorrhynchus napi, Chaetocnema tibialis, Conoderus vespertinus, Crioceris asparagi, Ctenicera ssp., Diabrotica longicornis, Diabrotica semipunctata, Diabrotica 12-punctata Diabrotica speciosa, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius califomicus, Lissorhoptrus oryzophilus, Melanotus communis, Meligethes aeneus, Melolontha hippocastani, Melolontha melolontha, Oulema oryzae, Otiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popiffia japonica, Sitona lineatus and Sitophilus granaria.

The pesticidal mixtures of the present invention are particularly useful for controlling insects of the orders Lepidoptera, Coleoptera, Hemiptera and Thysanoptera.

The pesticidal mixtures of the present invention are especially suitable for efficiently combating pests like insects from the order of the lepidopterans (Lepidoptera), beetles (Coleoptera), flies and mosquitoes (Diptera), thrips (Thysanoptera), termites (Isoptera), bugs, aphids, leafhoppers, whiteflies, scale insects, cicadas (Hemiptera), ants, bees, wasps, sawflies (Hymenoptera), crickets, grasshoppers, locusts (Orthoptera), and also Arachnoidea, such as arachnids (Acarina).

Pesticidal mixture A is preferably applied in an effective amount which has an synergistic insecticidal effect on at least one of the following species: Elasmopalpus lignosellus, Sternechus subsignatus, Diabrotica vergifera, Diabrotica speciosa, Phyllophaga cuyabana, Aracanthus mourei, Heterotermes tenuis, Sphenophorus levis, Migdolus fryanus, Diatraea saccharalis, Phyllophaga sp. Even more preferred, pesticidal mixture A is applied in an effective amount which has an synergistic insecticidal effen on at least one of Heliothis virescens and Myzus persicae.

Pesticidal mixture B is preferably applied in an effective amount which has an synergistic insecticidal effect on at least one of the following species: Elasmopalpus lignosellus, Sternechus subsignatus, Diabrotica vergifera, Diabrotica speciosa, Phyllophaga cuyabana, Aracanthus mourei, Heterotermes tenuis, Sphenophorus levis, Migdolus fryanus, Diatraea saccharalis, Phyllophaga sp.; Spodoptera frugiperda, Helicoverpa sp, Anticarsia gemmatalis. Even more preferred, pesticidal mixture B is applied in an effective amount which has an synergistic insecticidal effen on at least one of Heliothis virescens and Myzus persicae.

Pesticidal mixture C is preferably applied in an effective amount which has an synergistic insecticidal effect on at least one of the following species: Elasmopalpus lignosellus, Sternechus subsignatus, Diabrotica vergifera, Diabrotica speciosa, Phyllophaga cuyabana, Aracanthus mourei, Heterotermes tenuis, Sphenophorus levis, Migdolus fryanus, Diatraea saccharalis, Phyllophaga sp.; Spodoptera frugiperda, Helicoverpa sp, Anticarsia gemmatalis. Even more preferred, pesticidal mixture C is applied in an effective amount which has an synergistic insecticidal effen on at least one of Heliothis virescens and Myzus persicae.

Pesticidal mixture A is preferably applied in an effective amount which has a synergistic nematicidal effect on at least one of the following organisms: Pratylenchus sp., Meloydogine sp., Heterodera sp., Rotylenchulus sp., Paratrichodorus sp., in particular on Meloydogine incognita. or Heterodera glycines or both.

Pesticidal mixture B is preferably applied in an effective amount which has a synergistic nematicidal effect on at least one of the following organisms: Pratylenchus sp., Meloydogine sp., Heterodera sp., Rotylenchulus sp., Paratrichodorus sp., in particular on Meloydogine incognita. or Heterodera glycines or both.

Pesticidal mixture C is preferably applied in an effective amount which has a synergistic nematicidal effect on at least one of the following organisms: Pratylenchus sp., Meloydogine sp., Heterodera sp., Rotylenchulus sp., Paratrichodorus sp., in particular on Meloydogine incognita. or Heterodera glycines or both.

Pesticidal mixture D is preferably applied in an effective amount which has a synergistic nematicidal effect on at least one of the following organisms: Pratylenchus sp., Meloydogine sp., Heterodera sp., Rotylenchulus sp., Paratrichodorus sp., in particular on Meloydogine incognita. or Heterodera glycines or both.

Pesticidal mixture E is preferably applied in an effective amount which has a synergistic nematicidal effect on at least one of the following organisms: Pratylenchus sp., Meloydogine sp., Heterodera sp., Rotylenchulus sp., Paratrichodorus sp., in particular on Meloydogine incognita. or Heterodera glycines or both.

Pesticidal mixture F is preferably applied in an effective amount which has a synergistic nematicidal effect on at least one of the following organisms: Pratylenchus sp., Meloydogine sp., Heterodera sp., Rotylenchulus sp., Paratrichodorus sp., in particular on Meloydogine incognita. or Heterodera glycines or both.

Pesticidal mixture G is preferably applied in an effective amount which has a synergistic nematicidal effect on at least one of the following organisms: Pratylenchus sp., Meloydogine sp., Heterodera sp., Rotylenchulus sp., Paratrichodorus sp., in particular on Meloydogine incognita. or Heterodera glycines or both.

Pesticidal mixture H is preferably applied in an effective amount which has a synergistic nematicidal effect on at least one of the following organisms: Pratylenchus sp., Meloydogine sp., Heterodera sp., Rotylenchulus sp., Paratrichodorus sp., in particular on Meloydogine incognita. or Heterodera glycines or both.

Pesticidal mixture A1 is preferably applied in an effective amount which has a synergistic nematicidal effect on at least one of the following organisms: Pratylenchus sp., Meloydogine sp., Heterodera sp., Rotylenchulus sp., Paratrichodorus sp., in particular on Meloydogine incognita. or Heterodera glycines or both.

Pesticidal mixture A1.1 is preferably applied in an effective amount which has a synergistic nematicidal effect on at least one of the following organisms: Pratylenchus sp., Meloydogine sp., Heterodera sp., Rotylenchulus sp., Paratrichodorus sp., in particular on Meloydogine incognita. or Heterodera glycines or both.

Pesticidal mixture A1.2 is preferably applied in an effective amount which has a synergistic nematicidal effect on at least one of the following organisms: Pratylenchus sp., Meloydogine sp., Heterodera sp., Rotylenchulus sp., Paratrichodorus sp., in particular on Meloydogine incognita. or Heterodera glycines or both.

Pesticidal mixture A2 is preferably applied in an effective amount which has a synergistic nematicidal effect on at least one of the following organisms: Pratylenchus sp., Meloydogine sp., Heterodera sp., Rotylenchulus sp., Paratrichodorus sp., in particular on Meloydogine incognita. or Heterodera glycines or both.

The pesticidal mixtures are particularly suitable for controlling the following plant diseases caused by plant pathogenic fungi:

Albugo spp. (white rust) on ornamentals, vegetables (e.g. A. candida) and sunflowers (e.g. A. tragopogonis); Alternaria spp. (Alternaria leaf spot) on vegetables, rape (A. brassicola or brassicae), sugar beets (A. tenuis), fruits, rice, soybeans, potatoes (e.g. A. solani or A. alternata), tomatoes (e.g. A. solani or A. alternata) and wheat; Aphanomyces spp. on sugar beets and vegetables; Ascochyta spp. on cereals and vegetables, e.g. A. tritici (anthracnose) on wheat and A. hordei on barley; Bipolaris and Drechslera spp. (teleomorph: Cochliobolus spp.) on corn (e.g. D. maydis), cereals (e.g. B. sorokiniana: spot blotch), rice (e.g. B. oryzae) and turfs; Blumeria (formerly Erysiphe) graminis (powdery mildew) on cereals (e.g. on wheat or barley); Botrytis cinerea (teleomorph: Botryotinia fuckeliana: grey mold) on fruits and berries (e.g. strawberries), vegetables (e.g. lettuce, carrots, celery and cabbages), rape, flowers, vines, forestry plants and wheat; Bremia lactucae (downy mildew) on lettuce; Ceratocystis (syn. Ophiostoma) spp. (rot or wilt) on broad-leaved trees and evergreens, e.g. C. ulmi (Dutch elm disease) on elms; Cercospora spp. (Cercospora leaf spots) on corn, rice, sugar beets (e.g. C. beticola), sugar cane, vegetables, coffee, soybeans (e.g. C. sojina or C. kikuchii) and rice; Cladosporium spp. on tomatoes (e.g. C. fulvum: leaf mold) and cereals, e.g. C. herbarum (black ear) on wheat; Claviceps purpurea (ergot) on cereals; Cochliobolus (anamorph: Helminthosporium of Bipolaris) spp. (leaf spots) on corn (C. carbonum), cereals (e.g. C. sativus, anamorph: B. sorokiniana) and rice (e.g. C. miyabeanus, anamorph: H. oryzae); Colletotrichum (teleomorph: Glomerella) spp. (anthracnose) on cotton (e.g. C. gossypii), corn (e.g. C. graminicola), soft fruits, potatoes (e.g. C. coccodes: black dot), beans (e.g. C. lindemuthianum) and soybeans (e.g. C. truncatum or C. gloeosporioides); Corticium spp., e.g. C. sasakii (sheath blight) on rice; Corynespora cassiicola (leaf spots) on soybeans and ornamentals; Cycloconium spp., e.g. C. oleaginum on olive trees; Cylindrocarpon spp. (e. g. fruit tree canker or young vine decline, teleomorph: Nectria or Neonectria spp.) on fruit trees, vines (e.g. C. liriodendri, teleomorph: Neonectria liriodendri: Black Foot Disease) and ornamentals; Dematophora (teleomorph: Rosellinia) necatrix (root and stem rot) on soybeans; Diaporthe spp., e.g. D. phaseolorum (damping off) on soybeans; Drechslera (syn. Helminthosporium, teleomorph: Pyrenophora) spp. on corn, cereals, such as barley (e.g. D. teres, net blotch) and wheat (e.g. D. tritici-repentis: tan spot), rice and turf; Esca (dieback, apoplexy) on vines, caused by Formitiporia (syn. Phellinus) punctata, F. mediterranea, Phaeomoniella chlamydospora (earlier Phaeoacremonium chlamydosporum), Phaeoacremonium aleophilum and/or Botryosphaeria obtusa; Elsinoe spp. on pome fruits (E. pyri), soft fruits (E. veneta: anthracnose) and vines (E. ampelina: anthracnose); Entyloma oryzae (leaf smut) on rice; Epicoccum spp. (black mold) on wheat; Elysiphe spp. (powdery mildew) on sugar beets (E. betae), vegetables (e.g. E. pisi), such as cucurbits (e. g. E. cichoracearum), cabbages, rape (e.g. E. cruciferarum); Eutypa lata (Eutypa canker or dieback, anamorph: Cytosporina lata, syn. Libertella blepharis) on fruit trees, vines and ornamental woods; Exserohilum (syn. Helminthosporium) spp. on corn (e.g. E. turcicum); Fusarium (teleomorph: Gibberella) spp. (wilt, root or stem rot) on various plants, such as F. graminearum or F. culmorum (root rot, scab or head blight) on cereals (e.g. wheat or barley), F. oxysporum on tomatoes, F. solani (f. sp. glycines now syn. F. virguliforme) and F. tucumaniae and F. brasiliense each causing sudden death syndrome on soybeans, and F. verticilliodes on corn; Gaeumannomyces graminis (take-all) on cereals (e.g. wheat or barley) and corn; Gibberella spp. on cereals (e.g. G. zeae) and rice (e.g. G. fujikuroi: Bakanae disease); Glomerella cingulata on vines, pome fruits and other plants and G. gossypi on cotton; Grain-staining complex on rice; Guignardia bidwellii (black rot) on vines; Gymnosporangium spp. on rosaceous plants and junipers, e.g. G. sabinae (rust) on pears; Helminthosporium spp. (syn. Drechslera, teleomorph: Cochliobolus) on corn, cereals and rice; Hemileia spp., e.g. H. vastatrix (coffee leaf rust) on coffee; Isariopsis clavispora (syn. Cladosporium vitis) on vines; Macrophomina phaseolina (syn. phaseoli) (root and stem rot) on soybeans and cotton; Macrodochium (syn. Fusarium) nivale (pink snow mold) on cereals (e.g. wheat or barley); Microsphaera diffusa (powdery mildew) on soybeans; Monilinia spp., e.g. M. laxa, M. fructicola and M. fructigena (bloom and twig blight, brown rot) on stone fruits and other rosaceous plants; Mycosphaerella spp. on cereals, bananas, soft fruits and ground nuts, such as e.g. M. graminicola (anamorph: Septoria tritici, Septoria blotch) on wheat or M. fijiensis (black Sigatoka disease) on bananas; Peronospora spp. (downy mildew) on cabbage (e.g. P. brassicae), rape (e.g. P. parasitica), onions (e.g. P. destructor), tobacco (P. tabacina) and soybeans (e.g. P. manshurica); Phakopsora pachyrhizi and P. meiborniae (soybean rust) on soybeans; Phialophora spp. e.g. on vines (e.g. P. tracheiphila and P. tetraspora) and soybeans (e.g. P. gregata: stem rot); Phoma lingam (root and stem rot) on rape and cabbage and P. betae (root rot, leaf spot and damping-off) on sugar beets; Phomopsis spp. on sunflowers, vines (e.g. P. viticola: can and leaf spot) and soybeans (e.g. stem rot: P. phaseoli, teleomorph: Diaporthe phaseolorum); Physoderma maydis (brown spots) on corn; Phytophthora spp. (wilt, root, leaf, fruit and stem root) on various plants, such as paprika and cucurbits (e.g. P. capsici), soybeans (e.g. P. megasperma, syn. P. sojae), potatoes and tomatoes (e.g. P. infestans late blight) and broad-leaved trees (e.g. P. ramorum: sudden oak death); Plasmodiophora brassicae (club root) on cabbage, rape, radish and other plants; Plasmopara spp., e.g. P. viticola (grapevine downy mildew) on vines and P. halstedii on sunflowers; Podosphaera spp. (powdery mildew) on rosaceous plants, hop, pome and soft fruits, e.g. P. leucotricha on apples; Polymyxa spp., e.g. on cereals, such as barley and wheat (P. graminis) and sugar beets (P. betae) and thereby transmitted viral diseases; Pseudocercosporella herpotrichoides (eyespot, teleomorph: Tapesia yallundae) on cereals, e.g. wheat or barley; Pseudoperonospora (downy mildew) on various plants, e.g. P. cubensis on cucurbits or P. humili on hop; Pseudopezicula tracheiphila (red fire disease or ‘rotbrenner’, anamorph: Phialophora) on vines; Puccinia spp. (rusts) on various plants, e.g. P. triticina (brown or leaf rust), P. striiformis (stripe or yellow rust), P. hordei (dwarf rust), P. graminis (stem or black rust) or P. recondita (brown or leaf rust) on cereals, such as e.g. wheat, barley or rye, and asparagus (e.g. P. asparagi); Pyrenophora (anamorph: Drechslera) tritici-repentis (tan spot) on wheat or P. teres (net blotch) on barley; Pyriculana spp., e.g. P. oryzae (teleomorph: Magnaporthe grisea, rice blast) on rice and P. grisea on turf and cereals; Pythium spp. (damping-off) on turf, rice, corn, wheat, cotton, rape, sunflowers, soybeans, sugar beets, vegetables and various other plants (e.g. P. ultimum or P. aphani-dermatum); Ramularia spp., e.g. R. collo-cygni (Ramularia leaf spots, Physiological leaf spots) on barley and R. beticola on sugar beets; Rhizoctonia spp. on cotton, rice, potatoes, turf, corn, rape, potatoes, sugar beets, vegetables and various other plants, e.g. R. solani (root and stem rot) on soybeans, R. solani (sheath blight) on rice or R. cerealis (Rhizoctonia spring blight) on wheat or barley; Rhizopus stolonifer (black mold, soft rot) on strawberries, carrots, cabbage, vines and tomatoes; Rhynchosporium secalis (scald) on barley, rye and triticale; Sarocladium oryzae and S. attenuatum (sheath rot) on rice; Sclerotinia spp. (stem rot or white mold) on vegetables and field crops, such as rape, sunflowers (e.g. S. sclerotiorum) and soybeans (e.g. S. rolfsii or S. sclerotiorum); Septoria spp. on various plants, e.g. S. glycines (brown spot) on soybeans, S. tritici(Septoria blotch) on wheat and S. (syn. Stagonospora) nodorum (Stagonospora blotch) on cereals; Uncinula (syn. Erysiphe) necator (powdery mildew, anamorph: Oidium tuckeri) on vines; Setospaeria spp. (leaf blight) on corn (e.g. S. turcicum, syn. Helminthosporium turcicum) and turf; Sphacelotheca spp. (smut) on corn, (e.g. S. reiliana: head smut), sorghum and sugar cane; Sphaerotheca fuliginea (powdery mildew) on cucurbits; Spongospora subterranea (powdery scab) on potatoes and thereby transmitted viral diseases; Stagonospora spp. on cereals, e.g. S. nodorum (Stagonospora blotch, teleomorph: Leptosphaeria [syn. Phaeosphaeria] nodorum) on wheat; Synchytrium endobioticum on potatoes (potato wart disease); Taphrina spp., e.g. T. deformans (leaf curl disease) on peaches and T. pruni (plum pocket) on plums; Thielaviopsis spp. (black root rot) on tobacco, pome fruits, vegetables, soybeans and cotton, e.g. T. basicola (syn. Chalara elegans); Tilletia spp. (common bunt or stinking smut) on cereals, such as e.g. T. tritici (syn. T. caries, wheat bunt) and T. controversa (dwarf bunt) on wheat; Typhula incarnata (grey snow mold) on barley or wheat; Urocystis spp., e.g. U. occulta (stem smut) on rye; Uromyces spp. (rust) on vegetables, such as beans (e.g. U. appendiculatus, syn. U. phaseoli) and sugar beets (e.g. U. betae); Ustilago spp. (loose smut) on cereals (e.g. U. nuda and U. avaenae), corn (e.g. U. maydis corn smut) and sugar cane; Venturia spp. (scab) on apples (e. g. V. inaequalis) and pears; and Verticillium spp. (wilt) on various plants, such as fruits and ornamentals, vines, soft fruits, vegetables and field crops, e.g. V. dahliae on strawberries, rape, potatoes and tomatoes.

Pesticidal mixture D is preferably applied in an effective amount which has an synergistic fungicidal effect on at least one of the following species: Rhizoctonia sp., Colletotrichum sp., Fusarium sp., Cercospora sp., Phomopsis sp.; Diplodia sp.; Pythium sp., Phytophthora sp.

Pesticidal mixture E has an synergistic fungicidal effect on at least one of the following species: Rhizoctonia sp., Colletotrichum sp., Fusarium sp., Cercospora sp., Phomopsis sp.; Diplodia sp.; Pythium sp., Phytophthora sp. Even more preferred, pesticidal mixture D is applied in an effective amount which has an synergistic insecticidal effen on Phytophtora infestans.

Pesticidal mixture F is preferably applied in an effective amount which has an synergistic fungicidal effect on at least one of the following species: Rhizoctonia sp., Colletotrichum sp., Fusarium sp., Cercospora sp., Phomopsis sp.; Diplodia sp.; Pythium sp., Phytophthora sp. Even more preferred, pesticidal mixture F is applied in an effective amount which has an synergistic insecticidal effen on Phytophtora infestans.

Pesticidal mixture G is preferably applied in an effective amount which has an synergistic fungicidal effect on at least one of the following species: Rhizoctonia sp., Colletotrichum sp., Fusarium sp., Cercospora sp., Phomopsis sp.; Diplodia sp.; Pythium sp., Phytophthora sp.

Even more preferred, pesticidal mixture G is applied in an effective amount which has an synergistic insecticidal effen on Phytophtora infestans.

Pesticidal mixture H is preferably applied in an effective amount which has an synergistic fungicidal effect on at least one of the following species: Rhizoctonia sp., Colletotrichum sp., Fusarium sp., Cercospora sp., Phomopsis sp.; Diplodia sp.; Pythium sp., Phytophthora sp.

Even more preferred, pesticidal mixture H is applied in an effective amount which has an synergistic insecticidal effen on Phytophtora infestans.

Pesticidal mixture A1 is preferably applied in an effective amount which has an synergistic fungicidal effect on at least one of the following species: Rhizoctonia sp., Colletotrichum sp., Fusarium sp., Cercospora sp., Phomopsis sp.; Diplodia sp.; Pythium sp., Phytophthora sp.

Even more preferred, pesticidal mixture A1 is applied in an effective amount which has an synergistic insecticidal effen on Phytophtora infestans.

Pesticidal mixture A1.1 is preferably applied in an effective amount which has an synergistic fungicidal effect on at least one of the following species: Rhizoctonia sp., Colletotrichum sp., Fusarium sp., Cercospora sp., Phomopsis sp.; Diplodia sp.; Pythium sp., Phytophthora sp.

Even more preferred, pesticidal mixture A1.1 is applied in an effective amount which has an synergistic insecticidal effen on Phytophtora infestans.

Pesticidal mixture A1.2 is preferably applied in an effective amount which has an synergistic fungicidal effect on at least one of the following species: Rhizoctonia sp., Colletotrichum sp., Fusarium sp., Cercospora sp., Phomopsis sp.; Diplodia sp.; Pythium sp., Phytophthora sp.

Even more preferred, pesticidal mixture A1.2 is applied in an effective amount which has an synergistic insecticidal effen on Phytophtora infestans.

Pesticidal mixture A2 is preferably applied in an effective amount which has an synergistic fungicidal effect on at least one of the following species: Rhizoctonia sp., Colletotrichum sp., Fusarium sp., Cercospora sp., Phomopsis sp.; Diplodia sp.; Pythium sp., Phytophthora sp.

Even more preferred, pesticidal mixture A2 is applied in an effective amount which has an synergistic insecticidal effen on Phytophtora infestans.

Pesticidal mixture(s) I.1, I.2 and I.3 are preferably applied in an effective amount which has a synergistic fungicidal effect on at least one of the following organisms: Rhizoctonia sp., Fusarium sp., Colletotrichum sp., Cercospora sp., Phomopsis sp.; Diplodia sp.; Phytophthora sp., Sclerotinia sp., in particular on Rhizoctonia sp, or Fusarium sp, or both. Even more preferred, pesticidal mixture I.1, I.2 and I.3 are applied in an effective amount which has an synergistic insecticidal effen on Phytophtora infestans.

Pesticidal mixture(s) J.1, J.2, J.3 and J.4 are preferably applied in an effective amount which have a synergistic fungicidal effect on at least one of the following organisms: Rhizoctonia sp., Fusarium sp., Colletotrichum sp., Cercospora sp., Phomopsis sp.; Diplodia sp.; Phytophthora sp., Sclerotinia sp., in particular on Rhizoctonia sp, or Fusarium sp, or both. Even more preferred, pesticidal mixture J.1, J.2, J.3 and J.4 are applied in an effective amount which has an synergistic insecticidal effen on Phytophtora infestans.

### Formulations

The mixtures according to the present invention can be converted into the customary formulations, for example solutions, emulsions, suspensions, dusts, powders, pastes and granules. The use form depends on the particular intended purpose; in each case, it should ensure a fine and even distribution of the compounds of the mixtures according to the invention. Therefore the invention also relates to agrochemical compositions comprising an auxiliary and a mixture according to the invention, i.e. a mixture of at least one compound I of formula I and of at least one compound II according to the present invention. The auxiliary is preferably selected from the group consisting of surfactants, anti-freezing agents, binders, and pigments, and is particularly preferably a surfactant or a binder. An agrochemical composition comprises a pesticidally effective amount of a pesticidal mixture. The term “effective amount” denotes an amount of the composition or of the mixture, which is sufficient for controlling harmful pests on cultivated plants or in the protection of materials and which does not result in a substantial damage to the treated plants. Such an amount can vary in a broad range and is dependent on various factors, such as the animal pests species to be con-trolled, the treated cultivated plant or material, the climatic conditions and the specific mixture used.

The mixtures according to the present invention can be converted into customary types of agrochemical compositions, e. g. solutions, emulsions, suspensions, dusts, powders, pastes, granules, pressings, capsules, and mixtures thereof. Examples for composition types are suspensions (e.g. SC, OD, FS), emulsifiable concentrates (e.g. EC), emulsions (e.g. EW, EO, ES, ME), capsules (e.g. CS, ZC), pastes, pastilles, wettable powders or dusts (e.g. WP, SP, WS, DP, DS), pressings (e.g. BR, TB, DT), granules (e.g. WG, SG, GR, FG, GG, MG), insecticidal articles (e.g. LN), as well as gel formulations for the treatment of plant propagation materials such as seeds (e.g. GF). These and further compositions types are defined in the “Catalogue of pesticide formulation types and international coding system”, Technical Monograph No. 2, 6th Ed. May 2008, CropLife International.

The compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005. Examples for suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g. silicates, silica gels, talc, kaolins, lime-stone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkyl¬naphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 51 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkyl-polyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compound I or II or the mixture according to the invention on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidones, polyvinylacetates, polyvinyl alcohols, polyacrylates, biological or synthetic waxes, and cellulose ethers.

Examples for composition types and their preparation are:

i) Water-soluble concentrates (SL, LS)

10-60 wt % of a component (I) or (II) or a mixture according to the invention and 5-15 wt % wetting agent (e.g. alcohol alkoxylates) are dissolved in water and/or in a water-soluble solvent (e.g. alcohols) up to 100 wt %. The active substance dissolves upon dilution with water.

ii) Dispersible concentrates (DC)

5-25 wt % of a component (I) or (II) or a mixture according to the invention and 1-10 wt % dispersant (e. g. polyvinylpyrrolidone) are dissolved in up to 100 wt % organic solvent (e.g. cyclohexanone). Dilution with water gives a dispersion.

iii) Emulsifiable concentrates (EC)

15-70 wt % of a component (I) or (II) or a mixture according to the invention and 5-10 wt % emulsifiers (e.g. calcium dodecylbenzenesulfonate and castor oil ethoxylate) are dissolved in up to 100 wt % water-insoluble organic solvent (e.g. aromatic hydrocarbon). Dilution with water gives an emulsion.

iv) Emulsions (EW, EO, ES)

5-40 wt % of a component (I) or (II) or a mixture according to the invention and 1-10 wt % emulsifiers (e.g. calcium dodecylbenzenesulfonate and castor oil ethoxylate) are dissolved in 20-40 wt % water-insoluble organic solvent (e.g. aromatic hydrocarbon). This mixture is introduced into up to 100 wt % water by means of an emulsifying machine and made into a homogeneous emulsion. Dilution with water gives an emulsion.

v) Suspensions (SC, OD, FS)

In an agitated ball mill, 20-60 wt % of a component (I) or (II) or a mixture according to the invention are comminuted with addition of 2-10 wt % dispersants and wetting agents (e.g. sodium lignosulfonate and alcohol ethoxylate), 0.1-2 wt % thickener (e.g. xanthan gum) and up to 100 wt % water to give a fine active substance suspension. Dilution with water gives a stable suspension of the active substance. For FS type composition up to 40 wt % binder (e.g. polyvinylalcohol) is added.

vi) Water-dispersible granules and water-soluble granules (WG, SG)

50-80 wt % of a component (I) or (II) or a mixture according to the invention are ground finely with addition of up to 100 wt % dispersants and wetting agents (e.g. sodium lignosulfonate and alcohol ethoxylate) and prepared as water-dispersible or water-soluble granules by means of technical appliances (e. g. extrusion, spray tower, fluidized bed). Dilution with water gives a stable dispersion or solution of the active substance.

vii) Water-dispersible powders and water-soluble powders (WP, SP, WS)

50-80 wt % of a component (I) or (II) or a mixture according to the invention are ground in a rotor-stator mill with addition of 1-5 wt % dispersants (e.g. sodium lignosulfonate), 1-3 wt % wetting agents (e.g. alcohol ethoxylate) and up to 100 wt % solid carrier, e.g. silica gel. Dilution with water gives a stable dispersion or solution of the active substance.

viii) Gel (GW, GF)

In an agitated ball mill, 5-25 wt % of a compound I or II or a mixture according to the invention are comminuted with addition of 3-10 wt % dispersants (e.g. sodium lignosulfonate), 1-5 wt % thickener (e.g. carboxymethylcellulose) and up to 100 wt % water to give a fine suspension of the active substance. Dilution with water gives a stable suspension of the active substance.

ix) Microemulsion (ME)

5-20 wt % of a component (I) or (II) or a mixture according to the invention are added to 5-30 wt % organic solvent blend (e.g. fatty acid dimethylamide and cyclohexanone), 10-25 wt % surfactant blend (e.g. alcohol ethoxylate and arylphenol ethoxylate), and water up to 100%. This mixture is stirred for 1 h to produce spontaneously a thermodynamically stable microemulsion.

x) Microcapsules (CS)

An oil phase comprising 5-50 wt % of a component (I) or (II) or a mixture according to the invention, 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of a compound I according to the invention, 0-40 wt % water insoluble organic solvent (e.g. aromatic hydrocarbon), and an isocyanate monomer (e.g. diphenylmethane-4,4′-diisocyanate) are dispersed into an aqueous solution of a protective colloid (e.g. polyvinyl alcohol). The addition of a polyamine (e.g. hexamethylenediamine) results in the formation of a polyurea microcapsules. The monomers amount to 1-10 wt %. The wt % relate to the total CS composition.

xi) Dustable powders (DP, DS)

1-10 wt % of a component (I) or (II) or a mixture according to the invention are ground finely and mixed intimately with up to 100 wt % solid carrier, e.g. finely divided kaolin.

xii) Granules (GR, FG)

0.5-30 wt % of a component (I) or (II) or a mixture according to the invention is ground finely and associated with up to 100 wt % solid carrier (e.g. silicate). Granulation is achieved by extrusion, spray-drying or the fluidized bed.

xiii) Ultra-low volume liquids (UL)

1-50 wt % of a component (I) or (II) or a mixture according to the invention are dissolved in up to 100 wt % organic solvent, e.g. aromatic hydrocarbon.

The compositions types i) to xiii) may optionally comprise further auxiliaries, such as 0.1-1 wt % bactericides, 5-15 wt % anti-freezing agents, 0.1-1 wt % anti-foaming agents, and 0.1-1 wt % colorants.

The agrochemical compositions generally comprise between 0.01 and 95%, preferably between 0.1 and 90%, and in particular between 0.5 and 75%, by weight of active substance. The active substances are employed in a purity of from 90% to 100%, preferably from 95% to 100% (according to NMR spectrum).

Water-soluble concentrates (LS), Suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating compound I or II or a mixture according to the invention and compositions thereof, respectively, on to plant propagation material, especially seeds include dressing, coating, pelleting, dusting, soaking and in-furrow application methods of the propagation material. Preferably, compound I or the compositions thereof, respectively, are applied on to the plant propagation material by a method such that germination is not induced, e. g. by seed dressing, pelleting, coating and dusting.

When employed in plant protection, the amounts of active substances applied are, depending on the kind of effect desired, from 0.001 to 2 kg per ha, preferably from 0.001 to 1 kg per ha, more preferably from 0.005 to 0.9 kg per ha, in particular from 0.005 to 0.5 kg per ha.

In treatment of plant propagation materials such as seeds, e. g. by dusting, coating or drenching seed, amounts of active substance of from 0.1 to 1000 g, preferably from 0.1 to 300 g, more preferably from 0.1 to 100 g and most preferably from 0.25 to 100 g, per 100 kilogram of plant propagation material (preferably seed) are generally required.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizer, or micronutrients, and other pesticides (e.g. herbicides, insecticides, fungicides, growth regulators, safeners, biopesticides) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

According to one embodiment, individual components of the composition according to the invention such as parts of a kit or parts of a binary or ternary mixture may be mixed by the user himself in a spray tank and further auxiliaries may be added, if appropriate.

In a further embodiment, either individual components of the composition according to the invention or partially premixed components, e. g. components comprising compounds I and/or active substances, e.g. from the groups M or F, may be mixed by the user in a spray tank and further auxiliaries and additives may be added, if appropriate.

In a further embodiment, either individual components of the composition according to the invention or partially premixed components, e. g. components comprising compounds I and/or active substances from the group M or F, can be applied jointly (e.g. after tank mix) or consecutively.

In a further embodiment, either individual components of the composition according to the invention or partially premixed components, e. g. components comprising component (I) and/or component (II), and/or active substances from the group M or F, can be applied jointly (e.g. after tank mix) or consecutively.

### Further Active Ingredients

Another aspect of the present invention is when preparing the mixtures, it is preferred to employ the mixture according to the invention or pure active compounds (I) and (II), to which further active compounds, e.g. against harmful fungi or having herbicidal activity, or growth-regulating agents or fertilizers can be added, as described above for compounds (III).

### Applications

Due to their excellent activity, the mixtures according to the invention may be used for controlling invertebrate pests and fungi.

The compounds I and the one or more compound(s) II can be applied simultaneously, that is jointly or separately, or in succession, that is immediately one after another and thereby creating the mixture “in-situ” on the desired location, as e.g. the plant, the sequence, in the case of separate application, generally not having any effect on the result of the control measures. The mixtures according to the invention are effective through both contact and ingestion. The mixtures according to the invention can be applied to any and all developmental stages, such as egg, larva, pupa, and adult. The pests may be controlled by contacting the target pest, its food supply, habitat, breeding ground or its locus with a pesticidally effective amount of the inventive mixtures or of compositions comprising the mixtures.

According to a preferred embodiment, the mixtures according to the invention are used in crop protection, especially for the protection of living plants.

According to another specific embodiment of the invention, the mixtures according to the present invention are employed via soil application. Soil application is especially favorable for use against ants, termites, crickets, or cockroaches.

According to another embodiment of the invention, for use against non crop pests such as ants, termites, wasps, flies, mosquitoes, crickets, locusts, or cockroaches the mixtures according to the present invention are prepared into a bait preparation.

The bait can be a liquid, a solid or a semisolid preparation (e.g. a gel).

The animal pest (also referred to as “invertebrate pest”), i.e. the insects, arachnids and nematodes, the plant, soil or water in which the plant is growing can be contacted with the mixtures according to the invention or composition(s) comprising them by any application method known in the art. As such, “contacting” includes both direct contact (applying the compounds/compositions directly on the animal pest or plant—typically to the foliage, stem or roots of the plant) and indirect contact (applying the compounds/mixtures/compositions to the locus of the animal pest or plant).

The mixtures according to the invention or the pesticidal compositions comprising them may be used to protect growing plants and crops from attack or infestation by animal pests, especially insects, acaridae or arachnids by contacting the plant/crop with a pesticidally effective amount of the mixtures according to the invention. The term “crop” refers both to growing and harvested crops.

The mixtures according to the invention and the compositions comprising them are particularly important in the control of a multitude of insects on various cultivated plants, such as cereal, root crops, oil crops, vegetables, spices, ornamentals, for example seed of durum and other wheat, barley, oats, rye, maize (fodder maize and sugar maize/sweet and field corn), soybeans, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens.

Particularly preferred is the application of the mixtures according to the invention and the compositions comprising them on rice. Particularly preferred is the application of the mixtures according to the invention and the compositions comprising them on soybeans. Particularly preferred is the application of the mixtures according to the invention and the compositions comprising them on corn.

Also preferred is the application of the mixtures according to the invention, especially the mixtures A, B, C, D, E, F, G, H, I, J and T, as individualized herein, e.g. in Table T, on specialty crops like fruits and vegetables. In one embodiment thereof, the application is on fruiting vegetables, and especially on tomato, on pepper or on eggplant.

In another embodiment thereof, the application is on leafy vegetables, and especially on cabbage or on lettuce.

In still another embodiment thereof, the application is on tubers (tuber vegetables), and especially on potato or on onion.

The mixtures according to the invention are employed as such or in form of compositions by treating the insects or the plants, plant propagation materials, such as seeds, soil, surfaces, materials or rooms to be protected from insecticidal attack with an insecticidally effective amount of the active compounds. The application can be carried out both before and after the infection of the plants, plant propagation materials, such as seeds, soil, surfaces, materials or rooms by the insects.

The present invention also includes a method of combating animal pests which comprises contacting the animal pests, their habitat, breeding ground, food supply, cultivated plants, seed, soil, area, material or environment in which the animal pests are growing or may grow, or the materials, plants, seeds, soils, surfaces or spaces to be protected from animal attack or infestation with a pesticidally effective amount of a mixture of at least one active component (I) and at least one active component (II).

Moreover, animal pests may be controlled by contacting the target pest, its food supply, habitat, breeding ground or its locus with a pesticidally effective amount of a mixture according to the invention. As such, the application may be carried out before or after the infection of the locus, growing crops, or harvested crops by the pest.

The mixtures according to the invention can also be applied preventively to places at which occurrence of the pests is expected.

The mixtures according to the invention may be also used to protect growing plants from attack or infestation by pests by contacting the plant with a pesticidally effective amount of mixtures according to the invention. As such, “contacting” includes both direct contact (applying the compounds/compositions directly on the pest and/or plant—typically to the foliage, stem or roots of the plant) and indirect contact (applying the mixtures according to the invention/compositions to the locus of the pest and/or plant).

“Locus” means a habitat, breeding ground, plant, seed, soil, area, material or environment in which a pest or parasite is growing or may grow.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants. Seedlings and young plants, which are to be transplanted after germination or after emergence from soil, may also be included. These plant propagation materials may be treated prophylactically with a plant protection compound either at or before planting or transplanting.

The term “cultivated plants” is to be understood as including plants which have been modified by breeding, mutagenesis or genetic engineering. Genetically modified plants are plants, the genetic material of which has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transitional modification of protein(s) (oligo- or polypeptides) for example by glycosylation or polymer additions such as prenylated, acetylated or farnesylated moieties or PEG moieties (e.g. as disclosed in Biotechnol Prog. 2001 July-August; 17(4):720-8, Protein Eng Des Sel. 2004 January; 17(1):57-66, Nat Protoc. 2007; 2(5): 1225-35, Curr Opin Chem Biol. 2006 October; 10(5):487-91. Epub 2006 Aug. 28, Biomaterials. 2001 March; 22(5):405-17, Bioconjug Chem. 2005 January-February; 16(1):113-21).

The term “cultivated plants” is to be understood also including plants that have been rendered tolerant to applications of specific classes of herbicides, such as hydroxy-phenylpyruvate dioxygenase (HPPD) inhibitors; acetolactate synthase (ALS) inhibitors, such as sulfonyl ureas (see e. g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e. g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073); enolpyruvylshikimate-3-phosphate synthase (EPSPS) inhibitors, such as glyphosate (see e. g. WO 92/00377); glutamine synthetase (GS) inhibitors, such as glufosinate (see e. g. EP-A-0242236, EP-A-242246) or oxynil herbicides (see e. g. U.S. Pat. No. 5,559,024) as a result of conventional methods of breeding or genetic engineering. Several cultivated plants have been rendered tolerant to herbicides by conventional methods of breeding (mutagenesis), for example Clearfield® summer rape (Canola) being tolerant to imidazolinones, e. g. imazamox. Genetic engineering methods have been used to render cultivated plants, such as soybean, cotton, corn, beets and rape, tolerant to herbicides, such as glyphosate and glufosinate, some of which are commercially available under the trade names RoundupReady® (glyphosate) and LibertyLink® (glufosinate).

The term “cultivated plants” is to be understood also including plants that are by the use of recombinant DNA techniques capable to synthesize one or more insecticidal proteins, especially those known from the bacterial genus Bacillus, particularly from Bacillus thuringiensis, such as ä-endotoxins, e. g. CryIA(b), CryIA(c), CryIF, CryIF(a2), CryIIA(b), CryIIIA, CryIIIB(b1) or Cry9c; vegetative insecticidal proteins (VIP), e. g. VIP1, VIP2, VIP3 or VIP3A; insecticidal proteins of bacteria colonizing nematodes, for example Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, for example WO 02/015701). Further examples of such toxins or genetically-modified plants capable of synthesizing such toxins are dis-closed, for example, in EP-A 374 753, WO 93/007278, WO 95/34656, EP-A 427 529, EP-A 451 878, WO 03/018810 and WO 03/052073. The methods for producing such genetically modified plants are generally known to the person skilled in the art and are described, for example, in the publications mentioned above. These insecticidal proteins contained in the genetically modified plants impart to the plants producing these proteins protection from harmful pests from certain taxonomic groups of arthropods, particularly to beetles (Coleoptera), flies (Diptera), and butterflies and moths (Lepidoptera) and to plant parasitic nematodes (Nematoda).

The term “cultivated plants” is to be understood also including plants that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, for example EP-A 0 392 225), plant disease resistance genes (for example potato cultivars, which express resistance genes acting against Phytophthora infestans derived from the mexican wild potato Solanum bulbocastanum) or T4-lyso-zym (e. g. potato cultivars capable of synthesizing these proteins with increased resistance against bacteria such as Erwinia amylvora). The methods for producing such genetically modified plants are generally known to the person skilled in the art and are described, for example, in the publications mentioned above.

The term “cultivated plants” is to be understood also including plants that are by the use of recombinant DNA techniques capable to synthesize one or more proteins to increase the productivity (e. g. bio mass production, grain yield, starch content, oil content or protein content), tolerance to drought, salinity or other growth-limiting environ-mental factors or tolerance to pests and fungal, bacterial or viral pathogens of those plants.

The term “cultivated plants” is to be understood also including plants that contain by the use of recombinant DNA techniques a modified amount of substances of content or new substances of content, specifically to improve human or animal nutrition, for example oil crops that produce health-promoting long-chain omega-3 fatty acids or unsaturated omega-9 fatty acids (e. g. Nexera® rape). The term “cultivated plants” is to be understood also including plants that contain by the use of recombinant DNA techniques a modified amount of substances of content or new substances of content, specifically to improve raw material production, for example potatoes that produce increased amounts of amylopectin (e. g. Amflora® potato).

“Plant health” is defined as a condition of the plant which is determined by several aspects alone or in combination with each other.

One indicator for the condition of the plant is its “yield”. Yield is to be understood as any plant product of economic value that is produced by the plant such as fruits, vegetables, nuts, grains, seeds, wood or even flowers. The plant products may in addition be further utilized and/or processed after harvesting. According to the present invention, “increased yield” of a plant, in particular of an agricultural, horticultural, silvicultural and/or ornamental plant means that the yield of a product of the respective plant is increased by a measurable amount over the yield of the same product of the plant produced under the same conditions, but without the application of the composition of the invention. Increased yield can be characterized, among others, by the following improved properties of the plant and/or its products such as increased weight, increased height, increased biomass such as higher overall fresh weight, higher grain yield, more tillers, larger leaves, increased shoot growth, increased protein content, increased oil content, increased starch content and/or increased pigment content.

Another indicator for the condition of the plant is its “plant vigor”.

According to the present invention, “increased plant vigor” of a plant, in particular of an agricultural, horticultural, silvicultural and/or ornamental plant means that the vigor of a plant is increased by a measurable amount over the vigor of the same plant under the same conditions, but without the application of the composition of the invention.

The plant vigor becomes manifest in several aspects such as improved vitality of the plant, improved plant growth, improved plant development, improved visual appearance, improved plant stand (less plant verse/lodging), better harvestability, improved emergence, enhanced nodulation in particular rhizobial nodulation, bigger size, bigger leaf blade, increased plant weight, increased plant height, increased tiller number, increased shoot growth, increased root growth (extensive root system), increased yield when grown on poor soils or unfavorable climate, enhanced photosynthetic activity, enhanced pigment content (for example chlorophyll content), earlier flowering, shorter flowering period, earlier fruiting, earlier and improved germination, earlier grain maturity, improved self-defence mechanisms, improved stress tolerance and resistance of the plants against biotic and abiotic stress factors such as bacteria, viruses, heat stress, cold stress, drought stress, UV stress and/or salt stress, less non-productive tillers, less dead basal leaves, less input needed (such as fertilizers, water or pesticides), greener leaves (“greening effect”), less premature stress-induced ripening and less fruit abscission, complete maturation under shortened vegetation periods, longer and better grain-filling, less seeds needed, easier harvesting (for example by induction of leaf defoliation), faster and more uniform ripening, induction of young fruit abscission (“fruit thinning”), improved storability, longer shelf-life, easier and more cost effective storage conditions, longer panicles, delay of senescence, stronger and/or more productive tillers, better extractability of ingredients, improved quality of seeds (for being seeded in the following seasons for seed production) and/or reduced production of ethylene and/or the inhibition of its reception by the plant.

The improvement of the plant vigor according to the present invention particularly means that the improvement of any one or several or all of the above mentioned plant characteristics are improved independently of the pesticidal action of the composition or active ingredients.

Another indicator for the condition of the plant is the “quality” of a plant and/or its products. According to the present invention, “enhanced quality” means that certain crop characteristics such as the content or composition of certain ingredients are increased or improved by a measurable or noticeable amount over the same factor of the plant produced under the same conditions, but without the application of the composition of the present invention.

The quality of a product of the respective plant becomes manifest in several aspects such as improved nutrient content, improved protein content, improved content of fatty acids, improved metabolite content, improved carotenoid content, improved sugar content, improved amount of essential amino acids, improved nutrient composition, improved protein composition, improved composition of fatty acids, improved metabolite composition, improved carotenoid composition, improved sugar composition, improved amino acids composition, improved or optimal fruit color, improved texture of fruits, improved leaf color, higher storage capacity and/or higher processability of the harvested products.

The above identified indicators for the health condition of a plant may be interdependent and may result from each other. For example, an increased resistance to biotic and/or abiotic stress may lead to a better plant vigor, e.g. to better and bigger crops, and thus to an increased yield. Inversely, a more developed root system may result in an increased resistance to biotic and/or abiotic stress. However, these interdependencies and interactions are neither all known nor fully understood and therefore the different indicators are described separately.

It has to be emphasized that the above mentioned effects of the composition according to the invention, i.e. enhanced health of the plant, are also present when the plant is not under biotic stress for example when the plant is not under fungal- or pest pressure. It is evident that a plant suffering from fungal or insecticidal attack produces a smaller biomass and a smaller crop yield as compared to a plant which has been subjected to curative or preventive treatment against the pathogenic fungus or pest and which can grow without the damage caused by the biotic stress factor. However, the method according to the invention leads to an enhanced plant health even in the absence of any biotic stress and in particular of any phytopathogenic fungi or pest. This means that the positive effects of the composition of the invention cannot be explained just by the pesticidal activities of the compounds of components (I) and (II), but are based on further activity profiles. But of course, plants under biotic stress can be treated, too, according to the methods of the present invention.

In general, “pesticidally effective amount” means the amount of active ingredients or mixture according to the invention needed to achieve an observable effect on growth, including the effects of necrosis, death, retardation, prevention, and removal, destruction, or otherwise diminishing the occurrence and activity of the target organism. The pesticidally effective amount can vary for the various mixtures/compositions used in the invention. A pesticidally effective amount of the compositions will also vary according to the prevailing conditions such as desired pesticidal effect and duration, weather, target species, locus, mode of application, and the like. In the case of foliar treatment, the quantity of active ingredient ranges from 0.0001 to 500 g per 100 m², preferably from 0.001 to 20 g per 100 m², or from 1 to 100 g per hectare, preferably from 10 to 50 g per hectare, or from 12 to 50 g per hectare, or from 10 to 30 g per hectare, or from 20 to 40 g per hectare, or from 10 to 20 g per hectare, or from 20 to 30 g per hectare, or from 30 to 40 g per hectare, or from 40 to 50 g per hectare.

In treatment of plant propagation materials such as seeds, e. g. by dusting, coating or drenching seed, amounts of active substance of from 0.1 to 1000 g, preferably from 0.1 to 300 g, more preferably from 0.1 to 100 g and most preferably from 0.25 to 100 g, per 100 kilogram of plant propagation material (preferably seed) are generally required.

In the case of soil treatment, the quantity of active ingredient ranges from 0.0001 to 500 g per 100 m², preferably from 0.001 to 20 g per 100 m².

Customary application rates in the protection of materials are, for example, from 0.01 g to 1000 g of active compounds per m² treated material, desirably from 0.1 g to 50 g per m².

Insecticidal compositions for use in the impregnation of materials typically contain from 0.001 to 95 weight %, preferably from 0.1 to 45 weight %, and more preferably from 1 to 25 weight % of at least one repellent and/or insecticide.

The mixtures according to the invention are effective through both contact (via soil, glass, wall, bed net, carpet, plant parts or animal parts), and ingestion (bait, or plant part).

The mixtures according to the invention may also be applied against non-crop insect pests, such as ants, termites, wasps, flies, mosquitoes, crickets, or cockroaches. For use against said non-crop pests, the mixtures according to the invention are preferably used in a bait composition.

The bait can be a liquid, a solid or a semisolid preparation (e.g. a gel). Solid baits can be formed into various shapes and forms suitable to the respective application e.g. granules, blocks, sticks, disks. Liquid baits can be filled into various devices to ensure proper application, e.g.

open containers, spray devices, droplet sources, or evaporation sources. Gels can be based on aqueous or oily matrices and can be formulated to particular necessities in terms of stickyness, moisture retention or aging characteristics.

The bait employed in the composition is a product, which is sufficiently attractive to incite insects such as ants, termites, wasps, flies, mosquitoes, crickets etc. or cockroaches to eat it. The attractiveness can be manipulated by using feeding stimulants or sex pheromones. Food stimulants are chosen, for example, but not exclusively, from animal and/or plant proteins (meat-, fish- or blood meal, insect parts, egg yolk), from fats and oils of animal and/or plant origin, or mono-, oligo- or polyorganosaccharides, especially from sucrose, lactose, fructose, dextrose, glucose, starch, pectin or even molasses or honey. Fresh or decaying parts of fruits, crops, plants, animals, insects or specific parts thereof can also serve as a feeding stimulant. Sex pheromones are known to be more insect specific. Specific pheromones are described in the literature and are known to those skilled in the art.

For use in bait compositions, the typical content of active ingredients is from 0.001 weight % to 15 weight %, desirably from 0.001 weight % to 5% weight % of active compounds.

Formulations of compounds of formula I or compounds II or mixtures according to the invention as aerosols (e.g in spray cans), oil sprays or pump sprays are highly suitable for the non-professional user for controlling pests such as flies, fleas, ticks, mosquitoes or cockroaches. Aerosol recipes are preferably composed of the active compound(s), solvents such as lower alcohols (e.g. methanol, ethanol, propanol, butanol), ketones (e.g. acetone, methyl ethyl ketone), paraffin hydrocarbons (e.g. kerosenes) having boiling ranges of approximately 51 to 251° C., dimethylformamide, N-methylpyrrolidone, dimethyl sulfoxide, aromatic hydrocarbons such as toluene, xylene, water, furthermore auxiliaries such as emulsifiers such as sorbitol monooleate, oleyl ethoxylate having 3-7 mol of ethylene oxide, fatty alcohol ethoxylate, perfume oils such as ethereal oils, esters of medium fatty acids with lower alcohols, aromatic carbonyl compounds, if appropriate stabilizers such as sodium benzoate, amphoteric surfactants, lower epoxides, triethyl orthoformate and, if required, propellants such as propane, butane, nitrogen, compressed air, dimethyl ether, carbon dioxide, nitrous oxide, or mixtures of these gases.

The oil spray formulations differ from the aerosol recipes in that no propellants are used.

For use in spray compositions, the content of active ingredient is from 0.001 to 80 weights %, preferably from 0.01 to 50 weight % and most preferably from 0.01 to 15 weight %.

The mixtures according to the invention respective their compositions can also be used in mosquito and fumigating coils, smoke cartridges, vaporizer plates or long-term vaporizers and also in moth papers, moth pads or other heat-independent vaporizer systems.

Methods to control infectious diseases transmitted by insects (e.g. malaria, dengue and yellow fever, lymphatic filariasis, and leishmaniasis) with mixtures according to the invention and their respective compositions also comprise treating surfaces of huts and houses, air spraying and impregnation of curtains, tents, clothing items, bed nets, tsetse-fly trap or the like. Insecticidal compositions for application to fibers, fabric, knitgoods, nonwovens, netting material or foils and tarpaulins preferably comprise a mixture including the insecticide, optionally a repellent and at least one binder. Suitable repellents for example are N,N-Diethyl-meta-toluamide (DEET), N,N-diethylphenylacetamide (DEPA), 1-(3-cyclohexan-1-yl-carbonyl)-2-methylpiperine, (2-hydroxymethylcyclohexyl) acetic acid lactone, 2-ethyl-1,3-hexandiol, indalone, Methylneodecanamide (MNDA), a pyrethroid not used for insect control such as {(+/−)-3-allyl-2-methyl-4-oxocyclopent-2-(+)-enyl-(+)-trans-chrysantemate (Esbiothrin), a repellent derived from or identical with plant extracts like limonene, eugenol, (+)-Eucamalol (1), (−)-1-epi-eucamalol or crude plant extracts from plants like Eucalyptus maculata, Vitex rotundifolia, Cymbopogan martinii, Cymbopogan citratus (lemon grass), Cymopogan nartdus (citronella). Suitable binders are selected for example from polymers and copolymers of vinyl esters of aliphatic acids (such as such as vinyl acetate and vinyl versatate), acrylic and methacrylic esters of alcohols, such as butyl acrylate, 2-ethylhexylacrylate, and methyl acrylate, mono- and di-ethylenically unsaturated hydrocarbons, such as styrene, and aliphatic diens, such as butadiene.

The impregnation of curtains and bednets is done in general by dipping the textile material into emulsions or dispersions of the insecticide or spraying them onto the nets.

The pesticidal mixtures according to the invention and their compositions can be used for protecting wooden materials such as trees, board fences, sleepers, etc. and buildings such as houses, outhouses, factories, but also construction materials, furniture, leathers, fibers, vinyl articles, electric wires and cables etc. from ants and/or termites, and for controlling ants and termites from doing harm to crops or human being (e.g. when the pests invade into houses and public facilities). The mixtures according to the invention are applied not only to the surrounding soil surface or into the under-floor soil in order to protect wooden materials but it can also be applied to lumbered articles such as surfaces of the under-floor concrete, alcove posts, beams, plywoods, furniture, etc., wooden articles such as particle boards, half boards, etc. and vinyl articles such as coated electric wires, vinyl sheets, heat insulating material such as styrene foams, etc. In case of application against ants doing harm to crops or human beings, the ant controller of the present invention is applied to the crops or the surrounding soil, or is directly applied to the nest of ants or the like.

### Seed Treatment

The pesticide mixtures according to the invention are also suitable for the treatment of seeds in order to protect the seed from insect pest, in particular from soil-living insect pests and the resulting plant's roots and shoots against soil pests and foliar insects.

The mixtures according to the invention are particularly useful for the protection of the seed from soil pests and the resulting plant's roots and shoots against soil pests and foliar insects. The protection of the resulting plant's roots and shoots is preferred. More preferred is the protection of resulting plant's shoots from piercing and sucking insects, wherein the protection from aphids is most preferred.

The present invention therefore comprises a method for the protection of seeds from insects, in particular from soil insects and of the seedlings' roots and shoots from insects, in particular from soil and foliar insects, said method comprising contacting the seeds before sowing and/or after pregermination with mixtures according to the invention. Particularly preferred is a method, wherein the plant's roots and shoots are protected, more preferably a method, wherein the plants shoots are protected from piercing and sucking insects, most preferably a method, wherein the plants shoots are protected from aphids. Also preferred is a method, wherein the plant's roots and shoots are protected from chewing and biting insects, most preferably a method, wherein the plants shoots and roots are protected from Lepidoptera and/or Coleoptera, most preferably wherein the plant shoots and roots are protected from rice leaf beetle.

The term seed embraces seeds and plant propagules of all kinds including but not limited to true seeds, seed pieces, suckers, corms, bulbs, fruit, tubers, grains, cuttings, ratoon, cut shoots and the like and means in a preferred embodiment true seeds. For sugar cane the preferred embodiments is ratoon.

The term seed treatment comprises all suitable seed treatment techniques known in the art, such as seed dressing, seed coating, seed dusting, seed soaking and seed pelleting.

The present invention also comprises seeds coated with or containing the active mixtures according to the invention.

The term “coated with and/or containing” generally signifies that the active ingredient is for the most part on the surface of the propagation product at the time of application, although a greater or lesser part of the ingredient may penetrate into the propagation product, depending on the method of application. When the said propagation product is (re)planted, it may absorb the active ingredient.

Suitable seed is seed of cereals, root crops, oil crops, vegetables, spices, ornamentals, for example seed of durum and other wheat, barley, oats, rye, maize (fodder maize and sugar maize/sweet and field corn), soybeans, sugar cane, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens.

Particularly preferred is the application of the mixtures according to the invention and the compositions comprising them on corn, soybean and sugar cane.

In addition, the active mixtures according to the invention may also be used for the treatment of seeds from plants, which tolerate the action of herbicides or fungicides or insecticides owing to breeding, including genetic engineering methods.

For example, the active mixtures according to the invention can be employed in treatment of seeds from plants, which are resistant to herbicides from the group consisting of the sulfonylureas, imidazolinones, glufosinate-ammonium or glyphosate-isopropylammonium and analogous active substances (see for example, EP-A 242 236, EP-A 242 246) (WO 92/00377) (EP-A 257 993, U.S. Pat. No. 5,013,659) or in transgenic crop plants, for example cotton, with the capability of producing Bacillus thuringiensis toxins (Bt toxins) which make the plants resistant to certain pests (EP-A 142 924, EP-A 193 259).

Furthermore, the active mixtures according to the invention can be used also for the treatment of seeds from plants, which have modified characteristics in comparison with existing plants consist, which can be generated for example by traditional breeding methods and/or the generation of mutants, or by recombinant procedures). For example, a number of cases have been described of recombinant modifications of crop plants for the purpose of modifying the starch synthesized in the plants (e.g. WO 92/11376, WO 92/14827, WO 91/19806) or of transgenic crop plants having a modified fatty acid composition (WO 91/13972).

The seed treatment application of the active compounds is carried out by spraying or by dusting the seeds before sowing of the plants and before emergence of the plants.

Compositions which are especially useful for seed treatment are e.g.:

A Soluble concentrates (SL, LS)

D Emulsions (EW, EO, ES)

E Suspensions (SC, OD, FS)

F Water-dispersible granules and water-soluble granules (WG, SG)

G Water-dispersible powders and water-soluble powders (WP, SP, WS)

H Gel-Formulations (GF)

I Dustable powders (DP, DS)

Conventional seed treatment formulations include for example flowable concentrates FS, solutions LS, powders for dry treatment DS, water dispersible powders for slurry treatment WS, water-soluble powders SS and emulsion ES and EC and gel formulation GF. These formulations can be applied to the seed diluted or undiluted. Application to the seeds is carried out before sowing, either directly on the seeds or after having pregerminated the latter.

In a preferred embodiment a FS formulation is used for seed treatment. Typically, a FS formulation may comprise 1-800 g/l of active ingredient, 1-200 g/l Surfactant, 0 to 200 g/l antifreezing agent, 0 to 400 g/l of binder, 0 to 200 g/l of a pigment and up to 1 liter of a solvent, preferably water.

Especially preferred FS formulations of compounds of formula I, compounds II or the mixtures according to the invention, for seed treatment usually comprise from 0.1 to 80% by weight (1 to 800 g/l) of the active ingredient, from 0.1 to 20% by weight (1 to 200 g/l) of at least one surfactant, e.g. 0.05 to 5% by weight of a wetter and from 0.5 to 15% by weight of a dispersing agent, up to 20% by weight, e.g. from 5 to 20% of an anti-freeze agent, from 0 to 15% by weight, e.g. 1 to 15% by weight of a pigment and/or a dye, from 0 to 40% by weight, e.g. 1 to 40% by weight of a binder (sticker/adhesion agent), optionally up to 5% by weight, e.g. from 0.1 to 5% by weight of a thickener, optionally from 0.1 to 2% of an anti-foam agent, and optionally a preservative such as a biocide, antioxidant or the like, e.g. in an amount from 0.01 to 1% by weight and a filler/vehicle up to 100% by weight.

Seed Treatment formulations may additionally also comprise binders and optionally colorants. Binders can be added to improve the adhesion of the active materials on the seeds after treatment. Suitable binders are homo- and copolymers from alkylene oxides like ethylene oxide or propylene oxide, polyvinylacetate, polyvinylalcohols, polyvinylpyrrolidones, and copolymers thereof, ethylene-vinyl acetate copolymers, acrylic homo- and copolymers, polyethyleneamines, polyethyleneamides and polyethyleneimines, polysaccharides like celluloses, tylose and starch, polyolefin homo- and copolymers like olefin/maleic anhydride copolymers, polyurethanes, polyesters, polystyrene homo and copolymers

Optionally, also colorants can be included in the formulation. Suitable colorants or dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108. Examples of a gelling agent is carrageen (Satiagel®)

In the treatment of seed, the application rates of the mixtures of the invention are generally from 0.1 g to 10 kg per 100 kg of seed, preferably from 1 g to 5 kg per 100 kg of seed, more preferably from 1 g to 1000 g per 100 kg of seed and in particular from 1 g to 200 g per 100 kg of seed.

Preferred application rates are: For pesticidal mixture(s) A, B, C, F, G, H, I and J: component (I) from 1 g to 500 g per 100 kg of seeds and component (II) from 1 g to 500 g per 100 kg of seeds.

For pesticidal mixture(s) D and E: component (I) from 1 g to 500 g per 100 kg of seeds, component (II) from 1 g to 100 g per 100 kg of seeds. For pesticidal mixture(s) A1, A1.1 and A1.2: component (I) from 1 g to 500 g per 100 kg of seeds, component (II) from 1 g to 500 g per 100 kg of seeds, component (III) from 1 g to 100 g per 100 kg seeds. For pesticidal mixture A2: component (I) from 1 g to 500 g per 100 kg of seeds, component (II) from 1 g to 500 g per 100 kg of seeds, component (III) from 1 g to 100 g per 100 kg seeds, component (IV) from 1 g to 500 g per 100 kg seeds

The invention therefore also relates to seed comprising a mixtures of the invention, as defined herein. The amount of the mixtures of the invention will in general vary from 0.1 g to 10 kg per 100 kg of seed, preferably from 1 g to 5 kg per 100 kg of seed, in particular from 1 g to 1000 g per 100 kg of seed. For specific crops such as lettuce the rate can be higher.

### EXAMPLES

Synergism can be described as an interaction where the combined effect of two or more compounds is greater than the sum of the individual effects of each of the compounds. The presence of a synergistic effect in terms of percent control, between two mixing partners (X and Y) can be calculated using the Colby equation (Colby, S. R., 1967, Calculating Synergistic and Antagonistic Responses in Herbicide Combinations, Weeds, 15, 21-22):

$$E = X + Y - \frac{XY}{100}$$

When the observed combined control effect is greater than the expected combined control effect (E), then the combined effect is synergistic.

The following tests demonstrate the control efficacy of compounds, mixtures or compositions of this invention on specific pests. However, the pest control protection afforded by the compounds, mixtures or compositions is not limited to these species. In certain instances, combinations of a compound of this invention with other invertebrate pest control compounds or agents are found to exhibit synergistic effects against certain important invertebrate pests. The analysis of synergism or antagonism between the mixtures or compositions was determined using Colby's equation.

### Example 1

For evaluating control of green peach aphid (Myzus persicae) through systemic means the test unit consisted of 96-well-microtiter plates containing liquid artificial diet under an artificial membrane.

The compounds or mixtures were formulated using a solution containing 75% water and 25% DMSO. Different concentrations of formulated compounds or mixtures were pipetted into the aphid diet, using a custom built pipetter, at two replications.

For experimental mixtures in these tests identical volumes of both mixing partners at the desired concentrations respectively, were mixed together.

After application, 5 to 8 adult aphids were placed on the artificial membrane inside the microtiter plate wells. The aphids were then allowed to suck on the treated aphid diet and incubated at 23±1° C., 50±5% RH for 3 days. Aphid mortality and fecundity was then visually assessed. For the mixture tested the results are listed in Table 1.

TABLE 1

| Green Peach Aphid | ppm | Average Control % |
|---|---|---|
| Tioxazafen + Fipronil | 80 + 0 | 0 |
| Tioxazafen + Fipronil | 0 + 10 | 50 |
| Tioxazafen + Fipronil | 80 + 2 | 100* |

*synergistic control effect according to Colby's equation

### Example 2

For evaluating control of tobacco budworm (Heliothis virescens) the test unit consisted of 96-well-microtiter plates containing an insect diet and 15 to 25 H. virescens eggs.

The compounds or mixtures were formulated using a solution containing 75% water and 25% DMSO. Different concentrations of formulated compounds or mixtures were sprayed onto the insect diet at 10 μl, using a custom built micro atomizer, at two replications.

For experimental mixtures in these tests identical volumes of both mixing partners at the desired concentrations respectively, were mixed together.

After application, microtiter plates were incubated at 28±1° C., 80±5% RH for 5 days. Egg and larval mortality was then visually assessed. For the mixture tested the results are listed in Table 2.

TABLE 2

| | | Average |
|---|---|---|
| Tobacco budworm | ppm | (Control %) |
| Tioxazafen + Fipronil | 400 + 0 | 0 |
| Tioxazafen + Fipronil | 0 + 10 | 0 |
| Tioxazafen + Fipronil | 400 + 10 | 50* |

*synergistic control effect according to Colby's equation

### Example 3

The active compounds were formulated separately as a stock solution having a concentration of 10000 ppm in dimethyl sulfoxide.

Activity against the late blight pathogen Phytophthora infestans(Phytin) in the microtiter test.

The stock solutions were mixed according to the ratio, pipetted onto a micro titer plate (MTP) and diluted with water to the stated concentrations. A spore suspension of Phytophtora infestans containing a pea juice-based aqueous nutrient medium or DDC medium was then added. The plates were placed in a water vapor-saturated chamber at a temperature of 18° C. Using an absorption photometer, the MTPs were measured at 405 nm 7 days after the inoculation.

The measured parameters were compared to the growth of the active compound-free control variant (100%) and the fungus-free and active compound-free blank value to determine the relative growth in % of the pathogens in the respective active compounds.

These percentages were converted into efficacies.

The expected efficacies of active compound mixtures were determined using Colby's formula [R. S. Colby, “Calculating synergistic and antagonistic responses of herbicide combinations”, Weeds 15, 20-22 (1967)] and compared with the observed efficacies.

TABLE 3

| | | | | Calculated | |
|---|---|---|---|---|---|
| Active | | | | efficacy | |
| compound/ | Con- | | | according | |
| active | centration | | Observed | to Colby | Synergism |
| mixture | (ppm) | Mixture | efficacy | (%) | (%) |
| Tioxazafen | 4 | — | 7 | | |
| Fluopyram | 1 | — | 10 | | |
| Tioxazafen | 4 | 4:1 | 98 | 16 | 82 |
| Fluopyram | 1 | | | | |

1-15. (canceled)

16. A pesticidal mixture comprising tioxazafen as component (I) and at least one component (II) selected from the group consisting of: fipronil, acetamiprid, tetraniliprole, oxythiapiprolin, ethaboxam, fluopyram, 2-{3-[2-(1-{[3,5-bis(di-fluoromethyl-1H-pyrazol-1-yl]acetyl}piperidin-4-yl)-1,3-thiazol-4-yl]-4,5-dihydro-1,2-oxazol-5-yl}phenyl methanesulfonate and 2-{3-[2-(1-{[3,5-bis(di-fluoro-methyl)-1H-pyrazol-1-yl]acetyl}piperidin-4-yl) 1,3-thiazol-4-yl]-4,5-dihydro-1,2-oxazol-5-yl}-3-chlorophenyl methanesulfonate, fluxapyroxad, sedaxane, penflufen, pyraclostrobin, trifloxystrobin, picoxystrobin and azoxystrobin.

17. A pesticidal mixture A, B, C, D, E, F, G, H, I or J, wherein
the pesticidal mixture A comprises as active components
A1) tioxazafen; and
A2) fipronil;
the pesticidal mixture B comprises as active components
B1) tioxazafen; and
B2) acetamiprid;
the pesticidal mixture C comprises as active components
C1) tioxazafen; and
C2) tetraniliprole;
the pesticidal mixture D comprises as active components
D1) tioxazafen; and
D2) oxathiapiprolin
the pesticidal mixture E comprises as active components
E1) tioxazafen; and
E2) ethaboxam
the pesticidal mixture F comprises as active components
F1) tioxazafen; and
F2) fluopyram;
the pesticidal mixture G comprises as active components
G1) tioxazafen; and
G2) 2-{3-[2-(1-{[3,5-bis(di-fluoromethyl-1H-pyrazol-1-yl]acetyl}piperidin-4-yl)-1,3-thiazol-4-yl]-4,5-dihydro-1,2-oxazol-5-yl}phenyl methanesulfonate
the pesticidal mixture H comprises as active components
H1) tioxazafen; and
H2) 2-{3-[2-(1-{[3,5-bis(di-fluoro-methyl)-1H-pyrazol-1-yl]acetyl}piperidin-4-yl) 1,3-thiazol-4-yl]-4,5-dihydro-1,2-oxazol-5-yl}-3-chlorophenyl methanesulfonate
the pesticidal mixture I comprises as active components
I1) tioxazafen; and
I2) fluxapyroxad or sedaxane or penflufen;
the pesticidal mixture J comprises as active components
J1) tioxazafen; and
J2) pyraclostrobin or trifloxystrobin or picoxystrobin or azoxystrobin.

18. The pesticidal mixture A, B, C, D, E, F, G, H, I and J of claim 17, wherein
the pesticidal mixture A comprises active components A1) and A2) in synergistically effective amounts;
the pesticidal mixture B comprises active components B1) and B2) in synergistically effective amounts;
the pesticidal mixture C comprises active components C1) and C2) in synergistically effective amounts;
the pesticidal mixture D comprises active components D1) and D2) in synergistically effective amounts;
the pesticidal mixture E comprises active components E1) and E2) in synergistically effective amounts;
the pesticidal mixture F comprises active components F1) and F2) in synergistically effective amounts;
the pesticidal mixture G comprises active components G1) and G2) in synergistically effective amounts;
the pesticidal mixture H comprises active components H1) and H2) in synergistically effective amounts;
the pesticidal mixture I comprises active components I1) and I2) in synergistically effective amounts;
the pesticidal mixture J comprises active components J1) and J2) in synergistically effective amounts.

19. The pesticidal mixture of claim 16, wherein the pesticidal mixture A comprises component (I) and component (II) in a weight ratio of from 100:1 to 1:100.

20. A seed treatment composition comprising at least one of the pesticidal mixtures of claim 16, and at least one auxiliary, wherein the auxiliary is selected from the group consisting of surfactants, antifreezing agents, binders, and pigments.

21. The seed treatment composition of claim 20, wherein the composition is in the form of a flowable concentrate FS, a solution LS, a powder for dry treatment DS, a water dispersible powder for slurry treatment WS, a water-soluble powder SS, an emulsion ES or EC, or a gel formulation.

22. A plant propagation material treated with at least one of the pesticidal mixtures of claim 16 in an amount of from 0.01 g to 10000 g per 100 kg of the plant propagation material.

23. A plant propagation material coated with component (I) and component (II) of the pesticidal mixture of claim 16, in an amount of from 0.1 to 10 kg of component (I) per 100 kg of plant propagation material and from 0.1 to 10 kg of component (II) per 100 kg of plant propagation material.

24. A method for controlling invertebrate pests and phytopathogenic harmful fungi on plants, the pest or its food supply, habitat or breeding ground; and/or the fungi or their habitat, with an effective amount of the pesticidal mixture of claim 16.

25. The method of claim 24, wherein the effective amount of the pesticidal mixture is applied to seeds of maize or soybean or ratoon of sugar cane.

26. The method of claim 24, wherein at least one invertebrate pest is selected from the group consisting of: Elasmopalpus lignosellus, Diatraea saccharalis, Sternechus subsignatus, Diabrotica speciosa, Phyllophaga cuyabana, Aracanthus mourei, Sphenophorus levis, Migdolus fryanus and Heterotermes tenuis.

27. The method of claim 24, wherein at least one invertebrate pest is selected from the group consisting of: Pratylenchus sp., Meloydogine sp., Heterodera sp., Rotylenchulus sp., Paratrichodorus sp., Hoplolaimus sp. and Helicotylenchus sp.

28. The method of claim 24, wherein at least one fungi pest is selected from the group consisting of: Rhizoctonia sp., Colletotrichum sp., Fusarium sp., Cercospora sp., Phomopsis sp.; Diplodia sp.; Pythium sp., Penicillium oxalicum, Aspergillus flavus and Phytophthora sp.

29. The method of claim 24, wherein
(1) the plant is soybean, the invertebrate pests are selected from the group consisting of Elasmopalpus lignosellus, Sternechus subsignatus, Diabrotica speciosa, Phyllophaga cuyabana, Agrotis ipsilion, Pratylenchus sp., Meloydogine sp., Heterodera sp., Rotylenchulus sp., Paratrichodorus sp., Hoplolaimus sp. and Helicotylenchus sp., and the pythopathogenic harmful fungi are selected from the group consisting of Rhizoctonia sp., Colletotrichum sp., Fusarium sp., Cercospora sp., Phomopsis sp., Diplodia sp., Pythium sp., Penicillium oxalicum, Aspergillus flavus and Phytophthora sp.,
(2) the plant is corn, the invertebrate pests are selected from the group consisting of Elasmopalpus lignosellus, Diatraea saccharalis, Sternechus subsignatus, Diabrotica speciosa, Phyllophaga cuyabana, Pratylenchus sp., Meloydogine sp., Heterodera sp., Rotylenchulus sp., Paratrichodorus sp., Hoplolaimus sp. and Helicotylenchus sp., and the pythopathogenic harmful fungi are selected from the group consisting of Rhizoctonia sp., Colletotrichum sp., Fusarium sp., Cercospora sp., Phomopsis sp.; Diplodia sp.; Pythium sp., Penicillium oxalicum and Aspergillus flavus; or
(3) the plant is sugar cane and the invertebrate pests are selected from the group consisting of Diatraea saccharalis, Aracanthus mourei, Sphenophorus levis, Migdolus fryanus and Heterotermes tenuis. Pratylenchus sp., Meloydogine sp., Heterodera sp., Rotylenchulus sp., Paratrichodorus sp., Hoplolaimus sp., and Helicotylenchus sp.

30. The seed treatment composition of claim 20, wherein the auxiliary is a surfactant or a binder.

31. The seed treatment composition of claim 21, wherein the composition is in the form of a flowable concentrate.

32. A plant propagation material comprising the seed treatment composition of claim 20 in an amount of from 0.01 g to 10000 g per 100 kg of the plant propagation material.

33. The method of claim 24, wherein the plant is selected from the group consisting of wheat, maize, barley, oat, rye, rice, soybean, cotton, sugarbeet, sugar cane, rapeseed, and potato.

34. A method for controlling invertebrate pests and phytopathogenic harmful fungi on plants, the pest or its food supply, habitat or breeding ground; and/or the fungi or their habitat, with an effective amount of the mixture of claim 19.
